(19) United States
(12) Patent Application Publication
(10) Pub. No.: US 2026/0244457 A1
(43) Pub. Date: Aug. 20, 2026

(54) SYSTEMS AND METHODS FOR EXTENDING FUNCTIONALITY OF A MODULAR SOFTWARE PLATFORM

(71) Applicant: MONDAY.COM LTD, Tel Aviv (IL)

(72) Inventors: Amichay Even CHEN, London (GB); Greg RASHKEVITCH, Tel Aviv (IL); Dor SHAKED, Holon (IL); Moshik EILON, Tel Aviv (IL); Rami Hasib AL-DIN, Jerusalem (IL); Shay ELKANA, Ramat Gan (IL); Edo GARAVANI, Tel Aviv (IL); Vlad MYSTETSKYI, Petah Tikva (IL)

(73) Assignee: MONDAY.COM LTD, Tel Aviv (IL)

(21) Appl. No.: 19/463,703

(22) Filed: Jan. 29, 2026

Related U.S. Application Data
(63) Continuation of application No. PCT/IB2025/063587, filed on Dec. 31, 2025.
(60) Provisional application No. 63/760,932, filed on Feb. 20, 2025.

(51) Int. Cl. G06F 9/445

(52) U.S. Cl. CPC G06F 9/44521

(57) ABSTRACT

Systems, methods, and computer readable medium are provided for designing a modular software platform with extendable functionality. Designing a modular software platform with extendable functionality includes accessing a plurality of building blocks, each defining capabilities and associated with a schema defining connectivity information; maintaining an extension point for hosting a subset of the building blocks, the extension point being associated with an extension point schema defining connectivity information; enabling selection of the extension point for hosting a building block; enabling selection of a building block for hosting by the extension point; and linking the building block to the extension point using the building block and extension point connectivity information to generate connectivity instructions defining how to link the building block with the extension point, deducing whether additional information is needed, and implementing the connectivity instructions.

### PRIORITY CLAIM

This application also claims the benefit of priority of U.S. Provisional Patent Application No. 63/760,932, filed on Feb. 20, 2025, which is incorporated herein by reference in its entirety.

### TECHNICAL FIELD

The present disclosure generally relates to systems, methods, and computer program products for customization of software applications in general, and a modular platform for facilitating software customization in particular.

### BACKGROUND

Customizing and/or extending functionality of software applications may be useful for enhancing productivity, improving user experience, and meeting specific business or personal needs. Off-the-shelf software may not fully align with unique workflows, tasks, or industry requirements. Tailoring such applications may allow adding specialized features and improve integration with other tools and/or systems. Customization may also provide a more intuitive interface, enabling users to focus on objectives and remove overhead and complexity. However, extending the functionality of a software platform may involve cumbersome and complex operations requiring a technical specialist. This may limit the functionalities and/or capabilities that a software platform may offer and may introduce time delays for implementation.

### SUMMARY

Some disclosed embodiments may include systems, methods, and non-transitory computer readable media for extending functionality of a software platform using a modular framework including extension points and building blocks, as described herein.

Some disclosed embodiments may include a computer readable medium containing instructions that when executed by at least one processor cause the at least one processor to perform operations for designing a modular software platform with extendable functionality. The operations include accessing a plurality of building blocks, each building block defining a specific set of capabilities for implementation by the software platform for modifying the functionality thereof, and wherein each building block is associated with a specific building block schema defining specific building block connectivity information; maintaining a first extension point of a plurality of differing extension points available in the software platform, the first extension point being configured to host at least a first subset of the plurality of building blocks, wherein the first extension point is associated with a first extension point schema defining first extension point connectivity information; enabling selection of the first extension point for hosting at least one of the plurality of building blocks; enabling selection of a first building block for hosting by the first extension point; and linking the first building block to the first extension point, wherein linking includes using first building block connectivity information and the first extension point connectivity information to generate connectivity instructions defining how the first building block is to be linked with the first extension point, deducing whether additional information is required for implementing the connectivity instructions, and implementing the connectivity instructions thereby modifying the functionality of the software platform.

Some disclosed embodiments may include a computer readable medium containing instructions that when executed by at least one processor cause the at least one processor to perform operations for altering a software functionality. The operations include maintaining a software platform including a plurality of framework elements, each framework element being associated with a schema including rules defining how a functionality of the framework element is implemented, the schema having a modifiable schema portion and a non-modifiable schema portion; receiving a first signal indicative of a request to link a particular building block with a particular one of the plurality of framework elements for implementation by the software platform for modifying a functionality thereof, the particular building block having a specific set of capabilities; analyzing the modifiable schema portions and the non-modifiable schema portions of the particular building block and the particular framework element to determine compatibility requirements for linking the particular building block with the particular framework element; when rules of the non-modifiable schema portions of the particular building block and the particular framework element indicate inconsistency with the compatibility requirements, preventing linkage of the particular building block with the particular framework element; and when the rules of the non-modifiable schema portions of the particular building block and the particular framework element indicate consistency with the compatibility requirements, determining if modifications to the modifiable schema portions of the particular building block or the particular framework element are required, implementing the modifications to the modifiable schema portions when the modifications are required, and linking the particular building block to the particular framework element.

Some disclosed embodiments may include a computer readable medium containing instructions that when executed by at least one processor cause the at least one processor to perform operations for automated generation of a software application on a software platform. The operations include receiving a request for a desired functionality for implementation by software application on a software platform, wherein the software platform provides a plurality of available framework elements, each available framework element providing at least one available capability. The operations also include processing the request to identify a plurality of desired capabilities for fulfilling the desired functionality. The operations further include generating a mapping between the available capabilities provided by the plurality of available framework elements to the desired capabilities identified for fulfilling the desired functionality. The operations also include using the mapping to select a subset of the available framework elements for including in the software application, wherein each selected framework element included in the subset provides at least one available capability for fulfilling a portion of the desired functionality. The operations further include identifying at least one of the desired capabilities that is unfulfillable by the available framework elements provided by the software platform. The operations also include generating a new framework element capable of providing the at least one of the desired capabilities that is unfulfillable by the available framework elements. The operations further include constructing a manifest specifying the new framework element and the selected framework elements for including in the software application. The operations also include determining connectivity instructions for interconnecting the new framework element with the selected framework elements in compliance with a schema of the software platform, wherein the connectivity instructions define a functional workflow between the new framework element and the selected framework elements. The operations further include including the connectivity instructions in the manifest. The operations also include using the manifest to interconnect the selected framework elements with the new framework element to thereby construct the software application capable of providing the desired functionality.

### BRIEF DESCRIPTION OF THE DRAWINGS

The accompanying drawings, which are incorporated in and constitute a part of this disclosure, illustrate various disclosed embodiments. In the drawings:

FIG. 1 illustrates an exemplary schematic diagram of a computing device, consistent with some disclosed embodiments.

FIG. 2 illustrates an exemplary schematic diagram of at least one first computing device in communication with at least one second computing device over a communications network, consistent with some disclosed embodiments.

FIG. 3 illustrates an exemplary board implemented on a modular software platform providing extended functionality, consistent with some disclosed embodiments.

FIG. 4 illustrates the exemplary board of FIG. 3 after hosting of a first building block on a first extension point of the modular software platform, consistent with some disclosed embodiments.

FIG. 5 illustrates the exemplary board of FIG. 4 after hosting of a second building block on a second extension point of the modular software platform, consistent with some disclosed embodiments.

FIG. 6 is a flowchart of an example process for designing a modular software platform with extendable functionality, consistent with embodiments of the present disclosure.

FIG. 7 illustrates an exemplary modifiable software platform with alterable functionality, consistent with some disclosed embodiments.

FIG. 8 illustrates exemplary schema associated with the modifiable software platform of FIG. 7, consistent with some disclosed embodiments.

FIG. 9 illustrates the exemplary modifiable software platform of FIG. 7 following alteration of a functionality, consistent with some disclosed embodiments.

FIG. 10 illustrates the exemplary schema of FIG. 8 following alteration of the functionality the exemplary modifiable software platform shown in FIG. 9, consistent with some disclosed embodiments.

FIG. 11 is a flowchart of an example process for altering a functionality of a software platform, consistent with embodiments of the present disclosure.

FIG. 12 illustrates an exemplary user-interface for automated generation of a software application on a software platform, consistent with some disclosed embodiments.

FIG. 13, illustrating an exemplary mapping between available capabilities to desired capabilities, consistent with some disclosed embodiments of the present disclosure.

FIG. 14 illustrates an exemplary manifest for interconnecting the selected framework elements with the new framework element to construct a software application, consistent with some disclosed embodiments of the present disclosure.

FIG. 15 illustrates an exemplary software application generated automatically on software platform, consistent with some disclosed embodiments of the present disclosure.

FIG. 16 is a flowchart of example process for automated generation of a software application on a software platform, consistent with some disclosed embodiments of the present disclosure.

FIG. 17 is an exemplary screen shot of a user interface for adding an AI capability to a framework element, consistent with embodiments of the present disclosure.

### DETAILED DESCRIPTION

The following detailed description includes references to the accompanying drawings. Wherever possible, the same reference numbers are used in the drawings and the description to refer to the same or similar parts. While several illustrative embodiments are described herein, modifications, adaptations, and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Various terms used in the specification and claims may be defined or summarized differently when discussed in connection with differing disclosed embodiments. It is to be understood that the definitions, summaries, and explanations of terminology in each instance apply to all instances, even when not repeated, unless the transitive definition, explanation, or summary would result in inoperability of an embodiment. It is also to be understood that once a term is defined herein, in the absence of an inherent inconsistency, that definition applies to all other uses of the term herein. Moreover, the exemplary embodiments of the figures and their description are not to be considered definitions of claim terms, but rather are non-limiting examples used to illustrate specific embodiments.

Throughout, this disclosure mentions “embodiments” and “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

This disclosure employs open-ended permissive language, indicating for example, that some embodiments “may” employ, involve, or include specific features. The use of the term “may,” and other open-ended terminology, is intended to indicate that although not every embodiment may employ the specific disclosed feature, at least one embodiment employs the specific disclosed feature.

Some embodiments may involve a computing device. A computing device as used herein may include any type of device capable of executing instructions using at least one processor. Such a computing device may include a smartphone, a tablet, a smartwatch, a personal digital assistant, a desktop computer, a laptop computer, an IoT device, a dedicated terminal, a wearable computing device, a client device, a server, and/or any other electronic device that enables computation. A computing device may include at least one processor, at least one memory, a transceiver, and an input/output unit, all interconnected via one more buses.

The at least one processor may include any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all, or part of a central processing unit (CPU), graphics processing unit (GPU), digital signal processor (DSP), field-programmable gate array (FPGA), server, virtual server, or other circuits suitable for executing instructions or performing logic operations. In some embodiments, the at least one processor may include a remote processing unit (e.g., a “cloud computing” resource) accessible via a communications network.

The at least one memory may include a Random Access Memory (RAM), a Read-Only Memory (ROM), a hard disk, an optical disk, a magnetic medium, a flash memory, other permanent, fixed, or volatile memory, or any other mechanism capable of storing instructions. Such a memory may be pre-loaded with instructions for execution by at least one processor. In some embodiments, the at least one memory may include a remote storage (e.g., “cloud” storage) accessible via a communications network.

In some embodiments, a computing device may include a communications device capable of exchanging data using a wired and/or wireless communications network. Such a communications network may include one or more of a digital communications network, an analog communication network, and/or any other communications network configured to convey data. Some examples of communications networks may include the Internet, a private data network, a virtual private network using a public network, a Wi-Fi network, a LAN, or WAN network, and/or any combination thereof. In some embodiments, a network may include one or more physical links used to exchange data, such as Ethernet, coaxial cables, twisted pair cables, fiber optics, or any other suitable physical medium for exchanging data. A network may also include a public switched telephone network (“PSTN”) and/or a wireless cellular network. A network may be a secured network or unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between separate entities.

Differing embodiments of this disclosure may involve systems, methods, and/or computer readable media containing instructions. A system refers to at least two interconnected or interrelated components or parts that work together to achieve a common objective, function, or subfunction. A method refers to at least two steps, actions, or techniques to be followed in order to complete a task or a sub-task, to reach an objective, or to arrive at a next step. Computer-readable media containing instructions refers to any storage mechanism that contains program code instructions, for example to be executed by a computer processor. Examples of computer-readable media are further described elsewhere in this disclosure. Instructions may be written in any type of computer programming language, such as an interpretive language (e.g., scripting languages such as HTML and JavaScript), a procedural or functional language (e.g., C or Pascal that may be compiled for converting to executable code), an object-oriented programming language (e.g., Java or Python), a logical programming language (e.g., Prolog or Answer Set Programming), and/or any other programming language. Instructions executed by at least one processor may include implementing one or more program code instructions in hardware, in software (including in one or more signal processing and/or application specific integrated circuits), in firmware, or in any combination thereof, as described earlier. Causing a processor to perform operations may involve causing the processor to calculate, execute, or otherwise implement one or more arithmetic, mathematic, logic, reasoning, or inference steps.

In some embodiments, one or more neural networks may be configured to analyze inputs and generate corresponding outputs. Some non-limiting examples of such neural networks may include shallow artificial neural networks, deep artificial neural networks, feedback artificial neural networks, feed-forward artificial neural networks, autoencoder artificial neural networks, probabilistic artificial neural networks, time-delay artificial neural networks, convolutional artificial neural networks, recurrent artificial neural networks, long/short term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

Some disclosed embodiments involve applying AI functionality to perform one or more procedures disclosed herein. AI functionality may refer to any kind of capability or feature exhibited by an artificial intelligence system. It involves the ability of AI systems to perform tasks that usually require human intelligence. Examples of those tasks may include comprehension of natural language, recognition of patterns or structures in a data set, or the generation of predictions/forecasts. AI functionality incorporates different techniques and technologies such as Natural Language Processing (NLP), Natural Language Generation (NLG), Machine Learning (ML), Neural Network (NN), Deep Learning (DL), Large Language Model (LLM), or Computer Vision. AI functionalities empower applications to analyze, interpret, and generate data, automate processes, optimize performance, and offer intelligent solutions for intricate problems.

Different categories of AI functionality exist, and the exact definitions of these categories remain an open question as categories of Artificial intelligence are not mutually exclusive. AI systems may possess multiple functionalities simultaneously, and their capabilities may span across different areas of AI. For instance, an AI system may have both generative AI functionality to produce new content, such as text or images, and analytical AI functionality to analyze existing data, detect patterns, make decisions, or identify anomalies. These functionalities may be intertwined within a single AI system, allowing it to generate new content while also performing analysis on that content or other data. The field of AI is highly interconnected, and advancements in one area may influence and enhance capabilities in other areas. As AI technologies continue to evolve, the lines between different functionalities may become even more blurred, leading to increasingly integrated and versatile AI systems that combine various capabilities. Therefore, when discussing AI functionalities, it is important to recognize their potential overlap and interplay, as AI systems may exhibit a wide range of capabilities that are not limited to a single category or functionality.

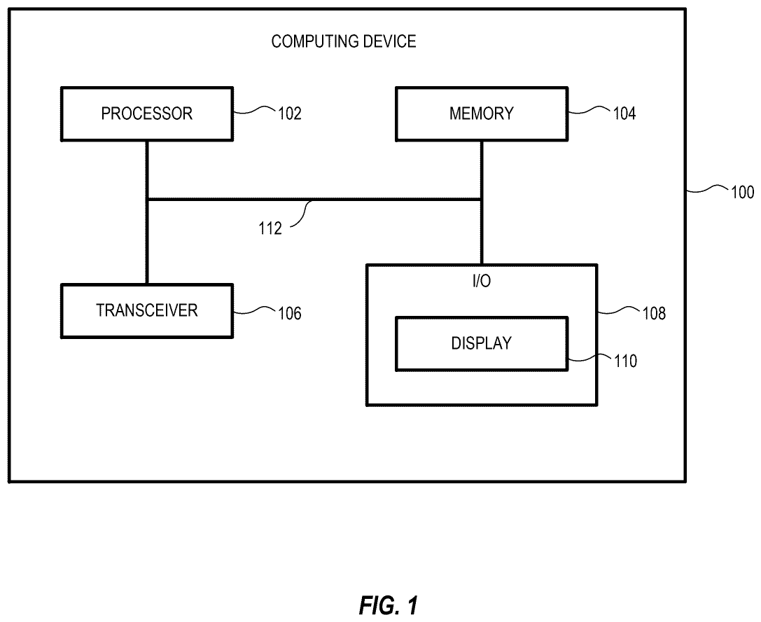

AI assistants may be powered by AI agents, also referred to as AI engines or AI core technology, i.e., components responsible for understanding user inputs, generating appropriate responses, and performing tasks on behalf of the user. An AI agent utilizes artificial intelligence technologies, such as NLP, ML, decision-making algorithms or any of the above-listed AI technologies, to interpret user queries, process information, and provide relevant and context-aware assistance. AI agents within AI assistants may incorporate various components, including perception to understanding user inputs (e.g., speech recognition or text parsing), reasoning and decision-making to generate appropriate responses, and action to execute tasks or interact with external systems. It may also involve learning capabilities to improve performance over time through user interactions and feedback. The AI agent acts as the intelligent core of the AI assistant, enabling it to understand user intent, provide accurate and helpful responses, and perform tasks or services on behalf of the user. It drives the conversational and interactive capabilities of the AI assistant, making it capable of simulating human-like interactions and assisting users with their requests. Non-limiting examples of AI assistants include Apple Siri™, Amazon Alexa™, Microsoft Cortana™, IBM Watson™, OpenAI ChatGPT-4™ and Bard™ Google's Assistant. The specific name or brand of the AI agent behind an AI assistant may vary depending on the developer or company that created it, some may not be publicly disclosed, like Siri™'s AI agent for example, while others are known, like Google's AI agent that powers Bard™, called Language Model for Dialogue Application (LaMDA). Communication and data exchange between a SaaS platform and an AI agent may be performed in various ways. For example, with reference to FIG. 1, an AI communication module may be included in the SaaS platform 100 to establish a connection between the SaaS platform and one or more AI agents.

AI agents may specialize in different types of operations or data processing based on their training, the AI technologies employed and their design. Accordingly, AI agents may be programmed and trained to specialize in specific domains, tasks, or industries. For example, different AI agents may specialize in the generation of different types of content such as text, images, and/or code. In another example, different AI agents may be labelled by a specific type of data used in their training set, for example, a first AI agent may be specialized and trained in code generation, a second AI agent may be specialized in predicting compatibility between different software modules, and a third AI agent may specialize in automatically generating a software product based on a requirement specification. Despite the existence of these specialized AI agents, more general and versatile AI agents may handle different types of operations or data. These agents possess broader capabilities and may perform a variety of tasks across different domains. For example, an AI agent may be able to generate both text and visual presentations. It could be trained and programmed to understand natural language and then generate written content. Additionally, it could utilize its visual processing capabilities to create visual presentations or even generate images based on a given input.

Disclosed embodiments may include and/or access a data structure or data. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database, or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, servers that may be owned or operated by the same or different entities. Thus, the term “data structure” as used herein in the singular is inclusive of plural data structures.

Structured data may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. As used herein, the term “data structure” may include a data pool or may be included in a data pool. A data pool may include a data structure, a data set, a database, a data lake, a data pool, or any other form of information storage whether distributed or undistributed and whether structured or unstructured. It is further to be understood that the term “data structure” as used herein in the singular is inclusive of plural data structures. A data structure may also include any hardware, software, firmware, or combination thereof for storing and facilitating the retrieval of information.

By way of a non-limiting example, reference is made to FIG. 1 illustrating an exemplary schematic diagram of a computing device 100, consistent with some disclosed embodiments. Computing device 100 may include at least one processor 102, at least one memory 104 (e.g., a non-transitory computer readable medium), a transceiver 106, and an input/output (I/O) unit 108. At least one processor 102, at least one memory 104, transceiver 106, and input/output unit 108 may be interconnected via a bus 112. In some embodiments, input/output unit 108 may include a display 110. Display 110 may include one or more touch sensitive surfaces, permitting computing device 100 to receive inputs from a user, and present outputs to a user. Computing device 100 may be configured to perform one or more of the operations disclosed herein.

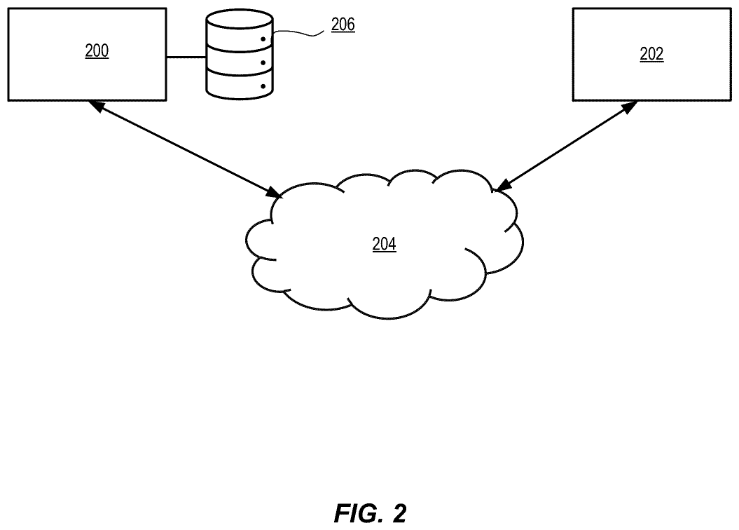

By way of another non-limiting example, reference is made to FIG. 2 illustrating an exemplary schematic diagram of at least one first computing device 200 in communication with at least one second computing device 202 over a communications network 204, consistent with some disclosed embodiments. First and second computing devices 200 and 202 may correspond to different instances of computing device 100 and may exchange data via network 204. In some embodiments, at least some of the data exchanged via network 204 may be stored in a data store 206 (e.g., a data structure). In some embodiments, at least one first computing device 200 may be at least one server device and at least one second computing device 202 may be at least one client device. In some embodiments, at least one first computing device 200 may provide a cloud service in conjunction with data storage 206. Computing devices 200 and 202 may be configured to perform one or more of the operations disclosed herein, e.g., in a distributed manner via network 204.

A SaaS platform refers to a cloud-based software delivery model where service providers may host software applications and make them accessible to users over the Internet. Instead of installing, managing, and maintaining the software locally, users access and utilize it through a web browser or thin client interface. SaaS platforms offer a wide range of applications and services to meet various business needs such as customer relationship management (CRM), human resources management (HRM), project management, accounting, marketing automation, and more. In most scenarios, these platforms operate on a subscription basis, with customers paying recurring fees for software access and usage. SaaS platforms may offer a high level of customization, allowing businesses to tailor the software to their specific needs. These applications may be seamlessly integrated with other business applications, particularly those offered by the same software provider. This integration enables smooth data flow and collaboration between different software systems, enhancing overall productivity and efficiency. Some examples of SaaS platforms include Monday.com™ for project management, Salesforce™ for CRM, Slack™ for team collaboration, Dropbox™ for file hosting and sharing, Microsoft 365™ for productivity tools, Google Workspace™ apps for productivity and collaboration tools, Zendesk™ for customer support, HubSpot™ for marketing, and Shopify™ for e-commerce. SaaS may include a plurality of SaaS Platform elements which may correspond to key components of the platform that work together to deliver software applications and services over the Internet. Examples of such elements may include application software, infrastructure, and/or user interface. For example, a platform may offer project management capabilities to its users via dashboards, tables, text documents, a workflow manager or diverse applications offered on a marketplace, all of which constitute building blocks and therefore elements of the platform. Applications offered on the marketplace may be provided by developers external to the SaaS platform, accordingly they may utilize a user interface different from a generic user interface provided by the SaaS platform. In addition, each SaaS platform element may include a plurality of SaaS platform sub-elements which may refer to smaller components or features that are part of a larger element within a SaaS platform. These sub-elements may be designed to perform specific tasks or provide specialized functionality. The collaboration of multiple sub-elements aims to create a comprehensive and integrated SaaS solution. Examples of SaaS platform sub-element may include a widget associated with a dashboard, a column or a cell associated with a table, or a workflow block associated with a workflow manager.

Systems, methods, and computer readable medium are disclosed for a modular software generating platform. The modular platform may provide a plurality of differing extension points and differing building blocks in a no-code environment. Each building block may be associated with a differing set of capabilities, and each extension point may host one or more building blocks. The no-code environment may thus permit developers and/or users to develop customized software applications by assembling differing combinations of building blocks and extension points without having to manually write code.

In some embodiments, the no-code environment includes a design-time configuration mode (e.g., a studio, builder, or administrative ‘build mode’) used to assemble and validate a software product prior to deployment or end-user use. In such embodiments, at least one processor may validate proposed linkages as the product is assembled and may prevent finalization of configurations that violate constraints. In other embodiments, at least one processor may perform similar validation at deployment time and/or runtime.

A building block, as used herein, refers to a reusable piece of software. Building blocks may be modular units for composing customized software applications, allowing developers to arrange different functionalities to create a cohesive and/or tailored user experience. A building block may include a set of generic executable instructions associated with one or more procedures, features, capabilities, and/or functionalities that may be used, called, and/or executed in a plurality of differing contexts and/or use cases on a software platform. A building block may thus include code that is agnostic to a particular use case, context, and/or implementation and may be added to a software application as a modular component. Inclusion of a building block to a software application may permit the addition of features and/or functionalities in a structured, secure, and/or consistent manner that avoid violations of one or more rules. Building blocks may be added to enhance functionalities of an existing software application in a flexible and/or modular manner, and/or may be combined to generate a customized (e.g., new) software application. A building block may connect a generic piece code to a plurality of differing extension points on a software platform, permitting a developer and/or user to apply each building block in a plurality of differing contexts and/or use cases. For instance, a building block may connect to a board header or a left navigation pane, causing the building block to provide a “native” user experience. For a give context, a building block may access information indicating to which element (e.g., a board or document) the building block is linked, permitting the building block to perform actions relevant to the associated element (i.e., a linked building block may have “context awareness”). A platform supporting building blocks may handle security and/or authentication automatically, sparing developers from having to develop authentication flows. In other words, a building block may provide seamless integration with a software platform (e.g., “plug-and-play”). For example building blocks may be combined to produce a customized Customer Relationship Management (CRM) tool.

A building block may include a server-side building blocks (e.g., for integrations). A server-side building block may be event-driven, for example, using a webhook. In response to an event occurring on the software platform (e.g., a status change), at least one processor associated with the software platform may transmit contextual data (e.g., a JSON payload) to a server endpoint associated with the building block (e.g., a developer-controlled endpoint) and/or to a client device. The server endpoint and/or client device may execute logic associated with the building block to perform an action, generate output data, and/or cause an update to the software platform.

A building block may include a client-side building block (e.g., views and/or widgets). A client-side building block may run as an insulated (e.g., sandboxed) web application (e.g., inside an <iframe>) within a user interface of a software platform. A client-side building block may communicate with a server hosting a software platform to fetch data via an Application Programming Interface (API) to render a custom user interface.

Some non-limiting examples of building blocks may include boards (e.g., including tables and/or columns), visualizations and/or views, integrations, automations, recipes, widgets, ribbons, dashboards, and/or any other type of encapsulated functionality. For instance, a board building block may provide a workspace for managing a workflow, a column building block may add data fields to a board, a view building block may permit visualization of a board according to a particular format and/or organization, a widget building block may provide an interface for triggering an action, and a ribbon building block may integrate a command bar presenting a plurality of features as a series of tabs. Some specific examples of building blocks may include a “Send Email” button, a bold button, an alarm clock widget, and a calendar widget. Each of these building blocks may be added and/or customized to enhance an existing software application, and/or included in a new software application.

A board building block may provide a capability for adding and/or modifying a board (e.g., a table) containing items defining objects or entities that may be managed in a software platform (task, project, client, deal, etc.). The terms “board” and “table” may be considered synonymous. In some embodiments, a board may contain information beyond what is displayed in a table. For example, a board may further contain cell comments, hidden rows and columns, formulas, data validation rules, filters, specific formatting, audits logs, version history, cross-referencing with different boards, external linking with data sources, permissions of access or a combination thereof. Boards may include sub-boards that may have a separate structure from a board. Sub-boards may be tables with sub-items that may be related to the items of a board. Columns intersecting with rows of items may together define cells in which data associated with each item may be maintained. Each column may have a heading or label defining one or more associated data types and may further include metadata (e.g., definitions, validation rules, ranges, hyperlinks, macros, and the like). When used herein in combination with a column, a row may be presented horizontally and a column vertically. However, in the broader generic sense as used herein, the term “row” may refer to one or more of a horizontal and/or a vertical presentation. A table or table structure as used herein, refers to data presented in horizontal and vertical rows, (e.g., horizontal rows and vertical columns) defining cells in which data is presented. A table structure may refer to any structure for presenting data in an organized manner, as previously discussed. such as cells presented in horizontal rows and vertical columns, vertical rows and horizontal columns, a tree data structure, a web chart, or any other structured representation, as explained throughout this disclosure. A cell may refer to a unit of information contained in the table structure defined by the structure of the table. For example, a cell may be defined as an intersection between a horizontal row with a vertical column in a table structure having rows and columns. A cell may also be defined as an intersection between a horizontal and a vertical row, or as an intersection between a horizontal and a vertical column. As a further example, a cell may be defined as a node on a web chart or a node on a tree data structure. As would be appreciated by a skilled artisan, however, the disclosed embodiments are not limited to any specific structure but rather may be practiced in conjunction with any desired organizational arrangement. In addition, table structure may include any type of information, depending on intended use. As an example, when used in conjunction with a project/task management application, the table structure may include any information associated with one or more tasks, such as one or more status values, projects, time-frames/deadlines, countries, persons, teams, progress statuses, a combination thereof, or any other information related to a task. In some cases, a hierarchy may be established between different items/cells in the same row. For example, a unique identifier (UID) may be assigned to an item and the other cell of the same row may then be associated with the item or the assigned UID.

While a table view may be one way to present and manage the data contained on a board, a table or board's data may be presented in different ways. For example, in some embodiments, dashboards may be utilized to present or summarize data derived from one or more boards. A dashboard may be a non-table form of presenting data, using, for example, static or dynamic graphical representations. A dashboard may also include multiple non-table forms of presenting data. As discussed later in greater detail, such representations may include various forms of graphs or graphics (which may also be referred to more generically as “widgets”). In some instances, dashboards may also include table structure. Software links may interconnect one or more boards with one or more dashboards thereby enabling the dashboards to reflect data presented on the boards. This may allow, for example, data from multiple boards to be displayed and/or managed from a common location. These widgets may provide visualizations that allow a user to update data derived from one or more boards.

Boards (or data associated with boards) may be stored in a local memory on a user device and/or in a local network repository. Boards may also be stored in a remote repository and may be accessed through a network. In some instances, permissions may be set to limit board access to the board's “owner” while in other embodiments a user's board may be accessed by other users through any of the networks described in this disclosure. In alternative scenarios, permission may not only be provided at the board level, but also at a more granular level such as rows, columns, and even individual cells, allowing for fine-grained control over who may access, view, edit, or interact with the data included in the board, particularly useful when dealing with collaborative boards. When one user makes a change in a board, that change may be updated to the board stored in a memory or repository and may be pushed to the other user devices that access that same board. These changes may be made to cells, items, columns, boards, dashboard views, logical rules, or any other data associated with the boards. Similarly, when cells are tied together or are mirrored across multiple boards, a change in one board may cause a cascading change in the tied or mirrored boards or dashboards of the same or other owners.

Boards and widgets may be part of a platform that may enable users to interact with information in real-time in collaborative work systems involving electronic collaborative word-processing documents. Electronic collaborative word processing documents (and other variations of the term) as used herein are not limited to only digital files for word processing but may include any other processing document such as presentation slides, tables, databases, graphics, sound files, video files or any other digital document or file. Electronic collaborative word processing documents may include any digital file that may provide for input, editing, formatting, display, and/or output of text, graphics, widgets, objects, tables, links, animations, dynamically updated elements, or any other data object that may be used in conjunction with the digital file. Any information stored on or displayed from an electronic collaborative word processing document may be organized into data blocks. A data block may include any organizational unit of information in a digital file, such as a single text character, word, sentence, paragraph, page, graphic, or any combination thereof. Data blocks may include static or dynamic information and may be linked to other sources of data for dynamic updates. Data blocks may be automatically organized by the system or may be manually selected by a user according to preference. In one embodiment, a user may select a segment of any information in an electronic word-processing document and assign it as a particular data block for input, editing, formatting, or any other further configuration.

A visualization building block may include a capability for graphical representation of data, allowing users to see and/or analyze information in different formats such as charts, graphs, and board views (e.g., Kanban, Calendar, Gantt, etc.). Visualizations may facilitate in identifying trends, managing workloads, and gaining insights by transforming raw data into readily interpretable graphical representations. An integration building block may provide a capability for connecting external tools (e.g., messaging, collaboration, and/or email applications) to one or more boards to automate workflows and/or maintain synchronization of data across differing platforms. An integration building block may include a “plug-and-play” connection permitting to use a software platform (e.g., Monday.com®) as a central hub, eliminating the need to manually move data between applications. An automation building block may provide a capability for generating logic-based workflows for automatic triggering of actions based on one or more events, such as a status change or due date, without requiring manual writing of code. For example, an automation building block may facilitate in assigning tasks to team members, sending notifications, updating columns, creating new items, and/or handling any other repetitive tasks. An automation may be association with one or more triggers, optional conditions, and one or more corresponding actions. A recipe building block may provide a capability for introducing a pre-defined automation rule including a trigger and a corresponding action (e.g., “When X happens, do Y”). A recipe building block may automate a workflow by generating a sequence of “ingredients”, corresponding to logical units each dedicated to performing a specific task. A recipe building block may thus facilitate in reducing manual work and connect different processes across different applications and/or boards. A widget building block may provide a capability for inclusion of customizable tools (widgets) that may be added to a dashboard to visualize data, display information, and/or streamline workflows from multiple boards in a single view. Widgets may provide quick access to information, such as project progress, calendars, summaries, and/or integration with external applications. A ribbon building block may provide a capability for including a graphical user interface (GUI) element in a software application for replacing one or more toolbars and/or menu bars with a tabbed command bar at the top of a window. A ribbon may organize one or more features of an application into tabs, each grouping related commands presented as buttons, icons, and/or menus. A dashboard building block may provide a capability for including a customizable, visual overview that may pull data from multiple boards into a central location using one or more widgets. A dashboard may facilitate tracking progress of projects and/or analyzing of data, and/or may display one or more charts, timelines, and/or reports in readily interpretable graphical representations.

Capabilities, as used herein, refers to features, functions, and/or operations that may be performed by a building block. Capabilities may indicate what a building block is able to do, including types of tasks that may be executed, services that may be provided, types of data that may be exchanged, and/or methods for interacting with users and/or additional hardware and/or software components. Capabilities may describe a behavior of a particular execution of a building block in a particular context (i.e., the same building block may provide different capabilities in different contexts). Some example of capabilities may include data processing and/or formatting, user authentication, workflow management, visualization, integration with external systems, and/or automation of specific actions. Some additional examples of capabilities may include user interface customization, synchronous and/or asynchronous execution, data learning and analytics, inclusion of data layers, reporting options, and/or lifecycle and/or work flow tracking. In some embodiments, a capability may be associated with a user interface permitting selection of settings to customize how the capability may be implemented in a particular use case and/or context.

Capabilities may fall along a spectrum, from leveraging existing platform functionalities to generating new functionalities. A software platform may provide a set of “native capabilities” that developers may use, such as archiving, deleting, and/or duplicating items. Developers may be provided with a set of pre-built native capabilities with associated rules for implementation. Some building blocks may define custom or new capabilities, not included in the native capabilities of the software platform, for example, to synchronize data with another software platform, generate a report, and/or display a customized multidimensional view, and/or any other type of customized capabilities. A building block may provide platform capabilities. When building an entire product, capabilities may changing a visual theme, including colors, layout, and organization of elements. A building block may provide an extensibility capability. A building block developed by a first developer may be extended by a second developer. Such a building block may include a core set of functions and an open “playground” allowing other developers to add additional features to the core functions (e.g., using a code-less environment).

For example, a data permission capability may permit a building block to access and/or manipulate data. Such a capability may be defined via API scopes in a configuration for an application (e.g., requesting boards: read to view board data or updates: write to post updates). This capability may grant permission to a building block to securely interact with user data within a software platform. A feature extension capability may extend the functionalities of an existing building block. A developer may generate a new block that inherits the core functionality of a standard feature on a software platform, with modifications, such as a custom name, icon, and/or added buttons. This may permit development of specialized versions of core features without having to develop the specialized versions from scratch. Some building blocks may be included as part of a package of a software platform, and some building blocks may be developed independent of the software platform (e.g., similar to apps).

A schema refers to a blueprint, structure, and/or architecture for a software component (e.g., building block, an extension point, and/or any other type of software component). A schema may include one or more declarative, machine-readable definitions for rendering, configuring, and/or managing a software component. For instance, a schema may include attributes, parameters, relationships, rules, and/or additional information indicating how the software component may connect, interact, and/or integrate with additional hardware and/or software components. Differing software components may have differing schema. A schema may specify for a particular software component, types of data that may be accepted, operations that may be supported, and/or rules and/or protocols associated with integrating the particular software component into a software platform. A schema may provide a blueprint for ensuring seamless incorporation of a software component within a software platform, in a manner permitting effective communication with other system components. A schema may define a structure for a software component, and may specify a software component block type (e.g., a board view and/or dashboard widget), with core properties, such as a name and description. A schema may specify a configuration for the software component by listing settings and/or input fields that need to be configured for the software component to execute. For example, a schema of an integration building block may include an API key and/or a dropdown menu to select a specific board. A schema may enable extensibility. A schema may define a “core” set of unchangeable functionalities and a “playground” where other developers may add modifications. A schema may ensures compatibility. A schema may ensure compatibility between a building block (e.g., a type of software component) and a hosting extension point, and that rules and/or requirements are upheld for the specific extension point.

By way of example, an Integration Recipe Schema may define a structure for a trigger and action sentence (e.g., “When a status changes to status, action”). Such a schema may specify input fields through which a user may interact, such as dropdowns for selecting a status column, and/or text fields for custom messages. Such a schema may allow the software platform to dynamically generate a setup interface for the recipe. A Workspace Template Schema may be a high-level schema that defines an entire work environment. A developer may base a new product on a pre-built workspace. The Workspace Template Schema may provide a comprehensive blueprint for defining the boards, dashboards, groups, items, and columns that may be automatically generated for the user upon installation.

A building block schema may define how a building block interacts, connects, and/or relates to other building blocks. A building block schema may include rules governing relationships between different building blocks. Such rules may govern how different building blocks may be combined, permit building blocks to inherit capabilities from other building blocks, contain other building blocks, and/or require other building blocks to be present. A building block schema may define feature extension (e.g., inheritance for a building block), permitting a child block to inherit core capabilities and/or resources of an existing block (a “parent”). The child building block may include an extension point for hosting and/or containing other building blocks. The specialized capabilities added to the “child” building block may have dependencies on other building blocks, requiring the other building blocks to be present for implementing the child building block. This may allow a developer to produce a highly specialized version of a feature that reuses a core functionality of a parent building block without having to develop it from scratch. A building block schema may define hosting capabilities, permitting a block to contain other blocks. A developer may use hosting capabilities to compose differing user interfaces by combining differing building blocks. A building block schema may define dependencies (e.g., prerequisites) requiring a first building block to be present and/or available for implementing a second building block, for example, if a capability of the second building block depends on a capability of the first building block.

In some embodiments, a schema may include a protected portion (i.e., a non-modifiable portion) defining core rules, invariants, and/or constraints, and an extensible portion (i.e., a modifiable portion) defining attributes, interfaces, and/or configuration regions that may be altered by hosted and/or extending building blocks. At least one processor associated with the software platform may validate proposed linkages and requested schema impacts to ensure that modifications are confined to the extensible portion while preserving the protected portion.

An extension point refers to an area and/or region on the software platform that is accessible and/or attainable for hosting a building block. An extension point may operate as a socket, slot, and/or adapter capable of accepting a plurality of differing building blocks, each having a different set of capabilities. An extension point may include a region of a software platform where capabilities of a building block may be implemented. A building block may be hosted on a plurality of differing extension points. Each extension point may expose capabilities of a building block differently, permitting customization of the capabilities for differing use cases, contexts, and/or applications. In other words, a particular building block may behave differently when connected to differing extension points. Thus, the same building block may be reused for different application by hosting the building block using different extension points. An extension point may define a particular use-case and/or context for a building block connected thereto and may define types of data that may be needed and/or permitted for the particular use-case and/or context. Some building blocks may be incompatible with some extension points and may be prohibited from being hosted by those extension points. Some examples of extension points may include a board, a favorites bar, a bookmark, and/or any other location on a software platform where functionality may be added. Some building blocks may include one or more extension points, permitting hosting of additional building blocks via previously linked building blocks. An extension point may govern placement of building blocks. An extension point may operate as a designated target for adding building blocks to a software application, to ensure structured and/or predictable integration. Updates to a particular building block may propagate to multiple versions of the particular building block that may be hosted on different extension points. Building blocks and extension points may be developed by different developers.

An extension point schema refers to a blueprint for the “slot” itself. It specifies what types of blocks it can host and what contextual data it will provide to them. An extension point schema may include one or more attributes, parameters, relationships, rules, and/or additional information indicating which building blocks may be hosted by a particular extension point, what type of data may be received and what data may be outputted by the extension point (e.g., an input/output interface), and/or what contextual data may be provided differing building blocks hosted thereon. An extension point schema may provide a blueprint for ensuring seamless incorporation of a building block within a software application and/or platform, in a manner permitting effective communication with other system components.

Extension points may enable customized features to be integrated into a software platform as native features. For example, instead of placement in a menu list, a customized feature may be placed directly within a workspace. An extension point may provide context to a building block hosted thereon. For example, a building block placed in an item menu extension point may have access to information indicating which item in the menu is affected by the building block. By way of another example, a board header may include an area at the top of a specific board containing buttons for selection (e.g., an “Integrate” and/or an “Automate” button). A board header may operate as an extension point permitting a developer to add one or more customized buttons directly into the board header to improve access to board-level actions. When hosted on a board header extension point, a building block may access information identifying the particular board to provide context.

By way of example, sending an email may be a functionality of an email building block. However, emails may be alternately sent using user-entered or AI-generated addresses, depending on the extension point on which the email building block is hosted. By way of another example, a “+” building block for adding a column to a board may be implemented differently depending on the hosting extension point. A “+” building block hosted on a “Life Builder” extension point may be a smaller scale, simpler, and/or automated version of a “+” building block hosted on a “Work Flow” extension point. By way of an additional example, a navigation bar in a workspace may be an extension point. A developer may integrate a building block into the navigation bar to seamlessly enhance the platform's functionality, ensuring that the added features appear and operate as if they are native to the software environment.

In some embodiments, an extension point may correspond to a user-interface surface such as a navigation pane, toolbar/ribbon, context menu, header region, side panel, item detail view, dashboard widget region, homepage region, and/or an administrative configuration interface. A constructed software product and/or building block may be hosted at any such extension point to provide a native-feeling experience within the platform.

In some embodiments, a constructed software product (and/or a building block hosted via an extension point), may be deployed for access outside a primary platform user interface, for example by publishing the software product at a dedicated network address (URL), embedding the software product within an external webpage, and/or providing access via an API, while enforcing access control (e.g., authentication, authorization, tenant scoping, and/or tokens).

In some disclosed embodiments, different types of linking relations define how building blocks may interact with extension points within a modular software platform. These linking relations may determine whether a building block modifies an existing extension point, is hosted by another extension point, and/or depends on other building blocks for implementation, thereby ensuring a structured and adaptable framework configuration.

In some implementations, a building block may extend an extension point by defining how specific properties of the extension point may be altered and/or merged. This type of linkage may enable a building block to modify functional characteristics of an extension point, allowing for schema-based property inheritance, property overrides, or dynamic schema mutation. For example, an appFeatureBlock may define an extension point, while an appFeaturePackagedBlock may extend it by modifying its functional schema. In this configuration, the extension point may be responsible for integrating modifications, ensuring that only predefined properties may be altered and that schema integrity is maintained. The extension linkage may allow for modular modification, where the resulting framework element may function as a newly defined entity, composed of the original extension point and the extending building block.

In some embodiments, a definition of a schema for a particular extension point may explicitly define which building blocks may be hosted by the particular extension point, e.g., to ensure compatibility. For example, an appFeatureObject extension point may define that it can host an appFeatureObjectHeaderAction building block, which results in a header button UI component. Similarly, an appFeatureColumn extension point may host an appFeatureDialog, allowing the column to trigger a modal dialog upon user interaction, such as an on-click or hover event. The hosting linkage mechanism may enable developers to modify system behavior by introducing building blocks that modify how an extension point functions, without altering the extension point itself.

Some embodiments may include dependency linkages between building blocks and/or extension points. A dependency linkage may enforce structural constraints on the composition of building blocks within a software platform. A dependency linkage may occur when a first building block requires inclusion of a second building block before linking the first building block to an extension point. Such a dependency linkage may ensure that core functionalities are in place before dependent functionalities are introduced. For example, a reporting module building block may depend on a data aggregation building block to function properly. If the dependency is unmet, at least one processor may prevent the linkage, prompt a user to add the missing component, and/or suggest an alternative configuration that satisfies the dependency requirements. In some implementations, schema validation mechanisms may dynamically enforce such constraints, ensuring that the modular architecture remains structurally sound and functionally coherent.

A modular software platform may enable developers to combine extensions, hosting, and/or dependency linkages to achieve flexible software composition. For example, a Status column extension point of type appFeatureColumn may be extended by a custom UI component that modifies its behavior, while simultaneously hosting a linked dialog component that provides a custom user interface for selection. By leveraging these linkage mechanisms, developers may build software functionality that dynamically adapts to user needs, while maintaining the structural integrity of the modular architecture.

To ensure compatibility and maintain framework consistency, linkage constraints may be dynamically verified, for example by:
Checking connectivity constraints to determine whether a building block is permitted to link to a given extension point.
Verifying modification permissions to ensure that an extending building block may modify only predefined attributes.
Enforcing dependency resolution to prevent incomplete or broken configurations.

By utilizing these structured linkage mechanisms, a modular software platform may allow for efficient software extension and/or dynamic customization, enabling scalable, modular development without the need for extensive manual configuration.

In some disclosed embodiments, a modular software platform may include at least one AI agent for facilitating automated generation of a software product. The at least one AI agent may receive a requirement specification defining a functionality to be achieved by a SaaS platform and may analyze a plurality of available building blocks and associated building block schemas to determine available capabilities within the software platform. The at least one AI agent may interpret the functional requirement, identify whether the required capabilities exist within the current set of building blocks, and assess schema-defined connectivity information to determine whether selected building blocks may be assembled to fulfill the requirement.

The at least one AI agent may receive the requirement specification through various input methods. In some embodiments, a user may provide free-text input describing the desired functionality in natural language, which the AI agent parses and interprets to determine the required components. Alternatively, the at least one AI agent may process graphical input, such as a diagram representing the system architecture, where connections between elements define relationships between building blocks. In another embodiment, at least one processor may enable a diagram mode, where a user may construct a high-level functional flow diagram using placeholders for building blocks and/or extension points. The at least one AI agent may translate such a diagram into an operational backend and/or client (e.g., frontend) implementation by mapping the placeholders to available building blocks and extension points.

Upon analyzing the available components, the at least one AI agent may generate a manifest specifying the required building blocks and corresponding connectivity instructions based on the received requirement and the SaaS platform schema, wherein the manifest defines the required interconnections among the selected building blocks. The manifest may be structured as a JSON file, encapsulating a structured representation of the required components, their dependencies, and the necessary connectivity instructions.

Following the generation of the manifest, the at least one AI agent may automatically construct the software product by linking the selected building blocks in accordance with the generated manifest. This may involve systematically applying connectivity instructions, and ensuring that each building block and extension point linkage conforms to predefined compatibility constraints. If discrepancies are identified, the at least one AI agent may suggest schema refinements and/or modifications to facilitate proper integration.

In some embodiments, at least one processor may store a manifest and/or configuration describing a constructed software product as a template that may be duplicated, versioned, transferred between accounts/tenants, and/or used to provision a plurality of instances. In some embodiments, at least one processor may publish one or more templates and/or constructed software products to a repository and/or marketplace with metadata indicating required permissions, compatible framework elements, and/or version information.

In some embodiments, the at least one AI agent may generate new building blocks when no suitable pre-existing component is determined to fulfill a required functionality. In such cases, the at least one AI agent may analyze the framework structure, determine the necessary functional attributes, and define a new building block with an associated schema that seamlessly integrates into the modular software platform. The at least one AI agent may borrow properties from existing building blocks, adapt input/output requirements, and/or define connectivity instructions that allow the new building block to operate within the software platform without breaking schema constraints.

This automation process may provide seamless extension of platform functionality, ensuring that user-defined requirements are efficiently translated into structured software configurations that align with the predefined modular framework. By leveraging AI-based manifest generation and automated construction, disclosed embodiments may provide an efficient mechanism for integrating, extending, and evolving software capabilities without requiring manual configuration or extensive development overhead.

Some disclosed embodiments involve designing a modular software platform with extendable functionality. Designing refers to planning, arranging, defining, and/or adapting. In the present context, designing may refer to the process of architecting, specifying, and/or organizing a software platform into discrete, interoperable modules that collectively perform one or more functions. A software platform refers to an environment, foundation, and/or ecosystem for building, running, and/or managing software applications. A software platform may provide one or more core functionalities and/or services allowing users to create and/or run software applications (e.g., apps). Such functionalities may include an operating system, a suite of Application Programming Interfaces (APIs), authentication and/or security protocols, and/or any other type of functionality. In some embodiments, a software platform may include a SaaS platform, as described elsewhere herein. A modular software platform refers to an adaptable and/or modifiable software platform. A modular software platform may include a plurality of available software components (e.g., logical units encapsulating one or more specific capabilities) that may be assembled in differing combinations to extend, modify, and/or customize existing software applications and/or to develop new software applications in a scalable manner.

Designing a modular software platform may include defining, adopting, and/or declaring one or more functionalities, establishing rules for connecting and/or interacting with other software and/or hardware components, and/or ensuring that security and consistency are maintained across the software platform. In some embodiments, designing may include partitioning the software system into functionally independent components, each encapsulating a specific set of operations, such that modifications to one module do not materially affect the behavior of other modules. This modularity may facilitate scalability, parallel development, and error isolation. In some embodiments, designing may involve the definition of interfaces between modules, including, for example, the specification of data formats, communication protocols, and execution triggers. These interfaces may enable modules to interact in a predictable and standardized manner, supporting plug-and-play functionality and future extensibility. In yet another embodiment, designing may include the translation of logical workflows into executable instructions, wherein a graphical workflow builder or similar tool may automatically convert user-defined logical connections into technology-specific scripts for execution by the platform's runtime environment. Designing may further encompass the selection and configuration of reusable components, adherence to platform rules, and the application of design principles such as high cohesion and low coupling. It may also include the use of automated tools or compilers that generate module-specific code based on metadata or user actions. In some embodiments, designing may be performed by a processor executing instructions stored on a non-transitory computer-readable medium, wherein the instructions cause the processor to perform operations such as, for example, module instantiation, interface binding, and dependency resolution. Unless otherwise specified, designing does not require manual coding or physical implementation but may include automated or semi-automated processes that result in a deployable modular architecture.

Some disclosed embodiments involve accessing a plurality of building blocks, each building block defining a specific set of capabilities for implementation by the software platform for modifying the functionality thereof. Accessing refers to retrieving, involving, or interacting with a resource (e.g., data, services, functionality, etc.). Accessing may refer to a capability for interacting with and/or making use of the resource. Accessing a plurality of building blocks (as described elsewhere herein) may include establishing a connection with a data structure storing information associated with a plurality of building blocks in accordance with one or more rules and/or permissions, reading and/or writing information associated with the plurality of building blocks. Defining refers to specifying, declaring, and/or outlining. Defining, as used herein, may include one or more executable instructions, declarations, parameter settings, filters, rules, and/or any other type of specification for a building block. A specific set of capabilities may include particular and/or selected capabilities (as described elsewhere herein). A specific set of capabilities may exclude some of a plurality of available capabilities.

Implementation, in the current context, refers to a software platform being operational within a target environment. It may refer to installing, configuring, integrating, and/or activating the software platform, or components of the platform, so that it performs its intended functions for end users or systems. It may involve involves deploying executable code, setting up databases, configuring APIs, and/or ensuring compatibility with existing infrastructure. For implementation by a software platform refers to operationalization, execution, and/or application by the software platform. Implementation of capabilities by a software platform may include execution of one or more instructions, application of one or more settings, parameters, rules, and/or filters, accessing one or more resources, and/or performance of any other operation to effectuate and/or realize one or more capabilities of a building block. When implementing capabilities of a building block, a software platform may ensure that the building block functions as intended and interacts with additional components and/or users in accordance with one or more rules, permissions, and/or settings in a consistent manner across the software platform.

Modifying functionality of a software platform refers to changing, adapting, and/or enhancing existing features, behaviors, and/or capabilities of the platform. Such modification may include adding, removing, updating, and/or restricting functionalities, integration of additional services, altering an interaction of a software platform with users and/or additional software and/or hardware components, and/or any other type of modification. For example, a first building block may link a data structure to import data into an existing board, a second building block may customize a bold button (e.g., by increasing the font size in addition to increasing the thickness of the text), and a third building block may integrate a text messaging app into a board. In general, it may refer to the deliberate alteration, enhancement, or reconfiguration of a software platform to meet evolving user needs, technical requirements, or business goals. This process may involve changes to the underlying codebase, adjustments to configuration parameters, or the integration of new modules or services. Modifying functionality may be proactive—such as adding new features or optimizing performance—or reactive, such as correcting bugs or adapting to external constraints like hardware changes or regulatory updates.

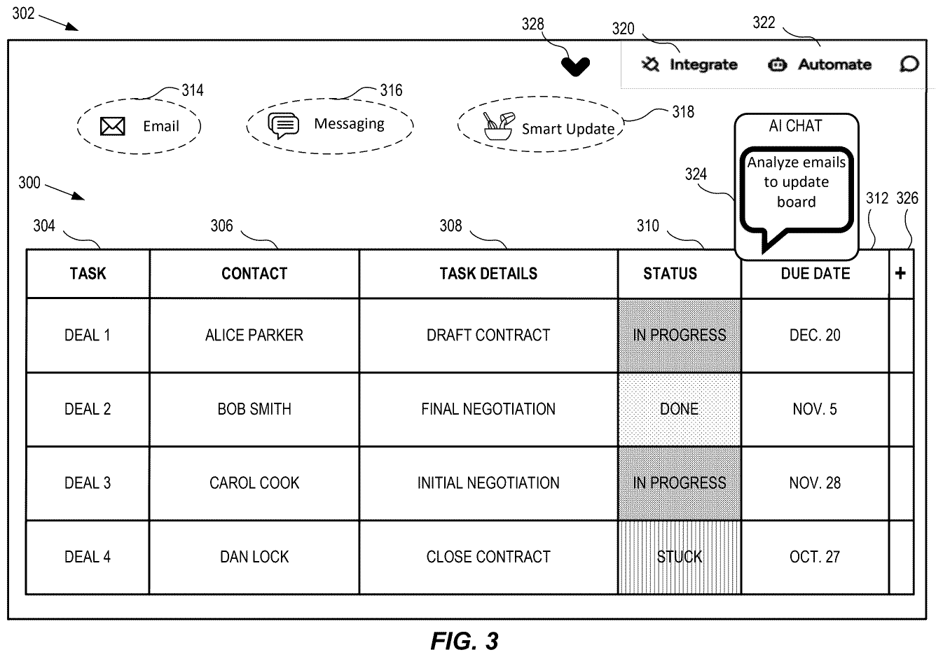

By way of a non-limiting example, reference is made to FIG. 3 which illustrates an exemplary board 300 implemented on a modular software platform 302 providing extended functionality, consistent with some disclosed embodiments. Modular software platform 302 may include a cloud-based operating system for managing projects (e.g., Monday.com®). Board 300 may facilitate a particular user in tracking a plurality of projects, and may include a Task column 304, a Contact column 306, a Task Details column 308, a Status column 310, and a Due Date column 312. At least one processor (e.g., processor 102 in FIG. 1) may present board 300 on a display (e.g., display 110 in FIG. 1) of a client device connected to a server via a network (e.g., device 202 connected to device 200 via network 204 in FIG. 2). In some embodiments, at least one processor may retrieve data from data store 206 via network 204 and present at least some of the retrieved data in board 300. At least one processor may permit access to a plurality of building blocks 314, 316, and 318, to extend one or more functionalities of board 300. Building blocks 314, 316, and 318 may each define a specific set of capabilities for implementation by software platform 302 for modifying the functionality thereof. For example, Email building block 314 may enable linking of emails to board 300, Messaging building block 316 may enable linking of messages to board 300, and Smart Update building block 318 may enlist one or more recipes (as described elsewhere herein) to analyze one or more emails and/or messages linked via Email building block 314 and/or Messaging building block 316 and automatically update board 300 based on the analysis.

In some disclosed embodiments, each building block is associated with a specific building block schema defining specific building block connectivity information. A building block schema may be understood as described elsewhere herein. Building block connectivity information refers to instructions, rules, and/or definitions for integrating a building block with additional software and/or hardware components. Building block connectivity information may include a method, a protocol, and/or point of interaction for a building block with additional software and/or hardware components, and/or a user via a user interface. Building block connectivity information may indicate how data is to be exchanged, where data may be sent to, where data may be received from, and/or what types of operations may be supported by a building block in a standardized manner. Building block connectivity information may thus permit integration of a building block in a plurality of differing contexts and/or use cases in a manner that is compatible, consistent, and/or reliable with other components of a software platform. In some embodiments, building block connectivity information may include a memory address indicating where to send requests targeting the building block, and/or where to load content for use by the building block. In some embodiments, the memory address may be a static memory address that remains fixed in system memory for repeated executions. In some embodiments, the memory address may include a public address associated with a hosting location for the building block on the software platform. In some embodiments, building block connectivity information may define how a building block may interact with other building blocks, such as by permitting a building block to inherit features from and/or contain one or more additional building block, and/or by requiring inclusion and/or integration of additional building blocks with a particular building block.

By way of a non-limiting example, in FIG. 3, each of building blocks 314, 316, and 318 may be associated with a specific building block schema defining specific building block connectivity information. For example, a schema associated with Email building block 314 may include a first Application Programming Interface (API) permitting access to an email client associated with the particular user, a schema associated with the Messaging building block 316 may include a second API permitting access to a messaging client associated with the particular user, and a schema associated with Smart Update building block 318 may permit access to the email client and/or the messaging client, and may additionally permit modifications to board 300.

Some disclosed embodiments involve maintaining a first extension point of a plurality of differing extension points available in a software platform. Maintaining refers to providing, presenting, displaying, enabling, and/or managing. It may refer to an ongoing process of ensuring that a resource remains functional, secure, efficient, and aligned with evolving user needs and technological environments. In the present context, it may include preserving the integrity of the extension point's schema, validating its inputs and outputs, and ensuring that any customizations or plugins interacting with it continue to function as intended across updates, deployments, and/or system changes. Maintaining an extension point may include ensuring that at least one extension point is active, selectable, and/or capable of hosting one or more building blocks. An extension point may be understood as described elsewhere herein. Available, as used herein, refers to accessible, and/or capable of being selected, applied, implemented, and/or utilized. It may refer to the state of readiness (e.g., active), accessibility, and/or operational viability of an extension point for use, integration, or invocation by other components, services, or users within the platform.

A plurality of differing extension points refers to at least two extension points distinguishable from each other. For example, a first extension point may be a navigation panel, and a second extension point may be a board header. A plurality of differing extension points may provide differing contexts and/or use cases for the same building block, such that hosting a particular building block on a first extension point provides a first set of capabilities and hosting the same particular building block on a second extension point provides a second set of capabilities. In general, a plurality of differing extension points may refer to a collection of distinct extension points within a software platform that enable external modules, plugins, and/or custom code to interact with the platform in varied and specialized ways. These extension points may be designed to support extensibility—allowing the platform to evolve, adapt, and accommodate new functionality without altering its core architecture.

By way of a non-limiting example, in FIG. 3, at least one processor (e.g., processor 102 in FIG. 1) may maintain an Integrate extension point 320 for connecting one or more external applications to board 300, and an Automation extension point 322 for automatic triggering of actions in response to one or more events.

In some disclosed embodiments, the first extension point is anchored to a particular location in an architecture of the software platform. Anchored refers to connected, linked, bound, and/or secured. Anchoring an extension point to a particular location in an architecture of a platform may restrict a context for executing code associated with the extension point, and/or limit what type of data may be exchanged via the extension point. An architecture of a software platform refers to a blueprint, schema, and/or layout of the software platform. An architecture may define locations for differing software components, and/or relationships between the differing software components. For example, a particular location in the architecture may correspond to (i) a presentation/UI layer component, (ii) an application/service-layer module (e.g., a workflow or automation service), (iii) a data-access layer component, (iv) an API gateway or integration layer, and/or (v) an event-driven component such as a message bus topic, event stream, or webhook handler. An architecture may define permissible flows of data, logic, and/or execution between differing components. An architecture may permit modifications to some regions of the platform and deny modifications for other regions of the platform. Similarly, an architecture may require user authorization to implement certain modifications to a platform. A particular location on an architecture refers to a specific area within a blueprint, map, and/or layout of a software platform. It may refer to a defined, identifiable (e.g., logical and/or virtual) point or region within a software platform where a specific function, component, or interaction is situated. Such a location may determine where in the system a component may interact with other components, how a component may fit into a data flow, and/or what resources and/or interfaces may be accessible. Anchoring an extension point to a particular location may ensure that building blocks connected to the anchored extension point may integrate with the software platform in a predicable and/or consistent manner. In general, the first extension point is anchored to a particular location in an architecture of the software platform may indicate that the first extension point is not arbitrarily placed or dynamically assigned, but is instead deliberately and consistently situated at a specific layer, module, or node within the platform's architecture. This anchoring may ensure that the extension point is predictably accessible, functionally scoped, and logically integrated with the surrounding components of the system.

In some disclosed embodiments, the first extension point is anchored to a particular location on a graphical user interface associated with the software platform. A user interface refers to a tool, software element, and/or hardware element enabling users (e.g., humans) to interact with a computer or software. In one example, the user interface may enable the reception and transmission of information to and from an electronic device or software component. A user interface may include any combination of visual, audio, touch-based, and/or any other sense-based interface. A graphical user interface (GUI) refers to a visualized system for enabling users to interact with an electronic device or software component. A GUI may substitute graphical elements instead of text-based commands and may include components such as windows, icons, buttons, and/or menus representing functions and/or actions. A user may interact with graphical elements using one or more input devices, such as an electronic mouse, a touchscreen, a stylus and/or keyboard. Anchoring an extension point to a particular location on a GUI may cause the extension point to appear at a particular location within a display frame for the software platform. This may facilitate in finding and/or using the extension point on the software platform. For example, a particular location on a GUI may include a board header region, a left navigation pane, a toolbar, a context menu, an item/detail panel, a column header region, or a cell-level control, such that building blocks hosted via the extension point appear and operate within a region defined by and/or associated with the particular location.

In some disclosed embodiments, the first extension point is unexposed to a user interface. Unexposed to a user interface refers to unconnected and/or disassociated with a user interface. An extension point unexposed to a user interface may be invisible to a user and may lack access to an interactive system for receiving and sending information from/to the user. Extension points unexposed to a user interface may not be presented in a GUI for direct user interaction, but may be invoked by one or more software processes. For example, such an extension point may be anchored to a backend integration interface of the software platform, such as an API endpoint, event subscription, message-queue topic, or webhook handler, such that the extension point is invokable by software processes (e.g., a server-side process or an AI agent) without being presented in the user interface. In some embodiments, the extension point is invoked in response to an event (e.g., a status change) and causes execution of a linked server-side building block. In such embodiments, linking the building block to the extension point may be performed via an authorized API request and may include validating one or more credentials, access tokens, and/or permission scopes prior to implementing connectivity instructions.

By way of a non-limiting example, Integrate extension point 320 and Automation extension point 322 may be anchored to a root portion of an architecture of software platform 302, causing Integrate extension point 320 and Automation extension point 322 to be automatically included in any newly initialized board on software platform 302. In some embodiments, Integrate extension point 320 and extension point 322 may be anchored to a particular location on a Graphical User Interface (GUI) of software platform 302, for instance on the upper right corner. In some embodiments, at least one processor (e.g., processor 102 in FIG. 1) may maintain an extension point that is unexposed to a user interface. For example, such an extension point may include a server-side extension point for connecting a server-side building block, as described elsewhere herein.

In some disclosed embodiments, the first extension point is configured to host at least a first subset of the plurality of building blocks. To host refers to providing the environment, resources, or infrastructure for something to run or be stored. Hosting refer to incorporating, attaching, linking, and/or connecting. Hosting may permit exchanges of data between a hosted component and other components of a platform, access to resources (e.g., APIs, databases, software engines), integration of pre-built security, and/or authentication procedures, and/or any other function for providing seamless integration between a hosted component and a software platform. An extension point may provide a defined location where specific building blocks may be connected to a software platform. The defined location may be associated with specific functionalities of the software platform and/or with a specific location on a user interface presented to a user. When an extension point hosts a building block, the extension point may enable at least some capabilities of the hosted building block to be realized and/or implemented in a software platform. Hosting a building block by an extension point may permit a software developer and/or a lay user (e.g., a non-software developer using a no-code environment) to customize a behavior of a software application and/or platform by adding new features and/or linking modular building blocks together. Hosting may resolve interfaces and/or connectivity schemas of a building block and an extension point, ensuring that the connected components communicate effectively and integrate seamlessly with other components of the software platform. Hosting of building blocks by extension points may permit flexible adaptation of a software application and/or platform by adding, removing, and/or updating hosted building blocks at designated extension points, without the need for rewriting of code and/or implementation of architectural changes to the software platform. A subset of building blocks refers to a portion of a total number of available building blocks. A subset of building blocks may include some building blocks and may exclude other building blocks. For example, a board header extension point may be limited to hosting building blocks associated with extending the functionality of the board, and may be unable to host building blocks unrelated to the board.

In some disclosed embodiments, the first extension point is associated with a first extension point schema defining first extension point connectivity information. An extension point schema refers to a blueprint, structure, and/or architecture for an extension point. Differing extension points may have differing extension point schema (as described elsewhere herein). Extension point connectivity information refers to data, specifications, rules, and/or instruction enabling an extension point to host a building block. Extension point connectivity information may include instructions, rules, and/or definitions for connecting a building block to a software platform via a particular extension point. Extension point connectivity information may include data types that may be exchanged with a particular extension point, rules, filters, parameters, contextual data for providing to a building block during runtime, and/or any other information needed by an extension point to host a building block. Some examples of extension point connectivity information may include an identifier for a particular board, and/or a menu item for providing context to a building block hosted thereon during runtime, a list of data types and/or parameters that may be exchanged with an extension point, and/or one or more rules and/or filters excluding some building blocks from being hosted by a particular extension point.

By way of a non-limiting example, in FIG. 3, Integrate extension point 320 may host Email building block 314, and Messaging building block 316 of plurality of building blocks 314, 316, and 318. Integrate extension point 320 may be associated with an Integrate schema defining connectivity information for Integrate extension point 320. Such connectivity information may include, for example, types of objects for extending a functionality thereof (e.g., boards, items, columns, rows), types of building blocks that may be connected to Integrate extension point 320, one or more fields, properties, and/or arguments for exchanging data with Integrate extension point 320, and/or for use as query terms to query a data structure, one or more recipes for automated integration of one or more external data structures, and/or any other type of information for connecting one of building blocks 314 and/or 316 to Integrate extension point 320.

Some disclosed embodiments involve enabling selection of the first extension point for hosting at least one of the plurality of building blocks. Enabling selection refers to providing a capability to choose and/or pick from a plurality of options. Enabling selection may include displaying a graphic element for a software component on a user interface, activating the graphic element for selection by an input device (e.g., an electronic mouse, stylus, keyboard, and/or touch-sensitive screen), and/or visually indicating a selected graphic element from a non-selected graphic element. At least one processor may execute code in a background to make a display element presented in a user interface selectable. Such code may include one or more scripts for handling inputs and/or setting of a “selectable” property. Consequently, a user may select the display element by clicking, tapping, and/or using keyboard navigation to trigger the selection state. In some embodiments, at least one processor may indicate a selected object visually. A user interface may present a plurality of candidate extension points that may be selected by clicking using an electronic mouse and/or stylus, typing using a keyboard, touching using a touch sensitive screen, and/or using any other type of user input. In some embodiments, the software platform may disable one or more extension points for selection, for example to comply with one or more rules and/or permissions. For example, some extension points may require authorization before being selected, and some extension points may be disabled for compatibility with current capabilities of the software platform.

Some disclosed embodiments involve enabling selection of a first building block for hosting by the first extension point. Enabling selection of a building block may be understood as described above for enabling selection of an extension point. For example, a user interface may present a plurality of candidate building blocks that may be selected by clicking using an electronic mouse and/or stylus, typing using a keyboard, touching using a touch sensitive screen, and/or using any other type of user input. In some embodiments, the software platform may disable one or more building for selection, for example to comply with one or more rules and/or permissions. For example, some building blocks may require authorization before being selected, and some building blocks may be disabled for compatibility with existing capabilities of the software platform (e.g., building blocks currently linked to the software application).

In some disclosed embodiments, the first extension point is exposed to a user interface configured to enable connection of the first building block to the first extension point. Exposed to a user interface refers to connected, linked, and/or associated with a user interface. For example, such an exposure may enable the first extension point to be accessed via the user interface. An extension point exposed to a user interface may be graphically presented on the user interface, and may permit a user to interact with the extension point using an input device. The extension point may be selectable via the user interface using an input device, and may respond to one or more user inputs, for example by altering one or more display characteristics, transmitting and/or pulling data, and/or executing code. A user interface enabling connection of a building block to an extension point refers to facilitating linkage of the building block to a software platform via the extension point. A user interface may include an interactive environment for displaying a plurality of available and/or selectable building blocks and/or extension points, and may be responsive to drag-and-drop operations using an input device (e.g., an electronic mouse, stylus, keyboard, and/or using touch-sensitive screen). This may permit a user to select and drag one or more building blocks into one or more extension points, thereby connecting those building blocks to the respective extension points to thereby modify the software platform in a modular, code-free manner. In some embodiments, a user interface may present one or more selectable settings, rules and/or filters permitting a user to customize how one or more building blocks may connect to one or more extension points. In some embodiments, the user interface may visually indicate which building blocks may be connected to which extension points.

In some disclosed embodiments, the user interface includes a no-code environment for enabling receiving of the selection of the building block. A no-code environment refers to a development platform, framework, service, or software and/or hardware ecosystem permitting users to create software applications without writing and/or programming computer instructions. A no-code environment may include a front end having a visual user interface permitting graphic commands, such as drag-and-drop actions, pre-configured logic, voice-enabled actions, and/or configurable workflows, enabling faster development and reducing a need for programming expertise. No-code tools may integrate with databases, Application Programming Interfaces (APIs), and/or third-party services to support complex functionality. A no-code environment may include a back end for enabling automated generation of connectivity instructions to link a particular building block to a particular extension point. A no-code environment may enable a user lacking expertise in writing programming code (e.g., a non-developer) to modify and/or generate a software application using an intuitive user interface, e.g., by connecting a selected building block to a selected extension point using drag-and-drop operations.

By way of a non-limiting example, at least one processor (e.g., processor 102 in FIG. 1) may enable selection of Integrate extension point 320 for hosting at least one of Email building block 314 and/or Messaging building block 316. Similarly, at least one processor may enable selection of Email building block 314 and/or Messaging building block 316. In some embodiments, Integrate extension point 320 may be exposed to a user interface enabling connection of Email building block 314 and/or Messaging building block 316. For example, at least one processor may present Integrate extension point 320, Email building block 314, and/or Messaging building block 316 as selectable buttons and/or tabs on a graphical user interface presented on display 110, permitting a user to drag-and-drop one of Email building block 314 and/or Messaging building block 316 onto Integrate extension point 320 using an electronic mouse and/or touch-sensitive screen. In response to dragging and dropping Email building block 314 onto Integrate extension point 320, at least one processor may execute and/or interpret the connectivity instructions (described above) causing Integrate extension point 320 to host Email building block 314, thereby enabling implementation of the capabilities of Email building block 314. In some embodiments, the user interface may include a no-code environment for receiving the selection of Email building block 314. The particular user may drag-and-drop Email building block 314 onto Integrate extension point 320 to extend the functionality of board 300 with the capabilities of Email building block 314 without requiring manual writing of code.

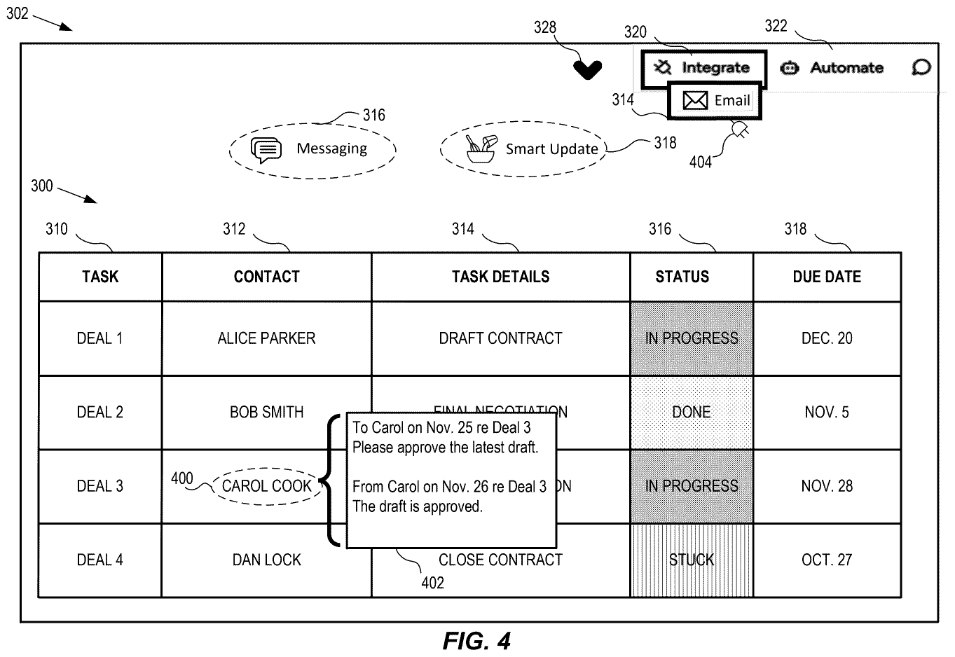

By way of a non-limiting example, reference is made to FIG. 4 which illustrates board 300 after hosting of Email building block 314 on Integrate extension point 320 of the modular software platform, consistent with some disclosed embodiments. The particular user may use an electronic mouse and/or a touch sensitive screen to click and/or touch Email building block 314 onto Integrate extension point 320 to thereby select Email building block 314 for hosting by Integrate extension point 320.

Some disclosed embodiments involve linking the first building block to the first extension point. Linking refers to combining, integrating, and/or incorporating. Linking may integrate a plurality of software components by incorporating one or more libraries, exchanging and/or sharing data, compiling and/or interpreting source code, and/or establishing one or more communication channels. Linking a building block to an extension point may permit the building block to be executable in a particular context associated with the extension point, and send and/or receive data to/from additional components of a software application. Linking a building block to an extension point may include interpreting one or more software instructions associated with the building block and/or extension point, retrieving and/or sending data, setting one or more parameters, applying one or more rules, and/or performing any other operation for integrating the building block in the context of the extension point within a software application. Linking a building block to a software application via a particular extension point may permit the building block to access information associated with a particular context for an execution of the building block within the software platform.

Some disclosed embodiments involve using first building block connectivity information and the first extension point connectivity information to generate connectivity instructions defining how the first building block is to be linked with the first extension point. To generate refers to produce, and/or output. It may include generating data, code, configurations, interfaces, workflows, or other platform elements by executing instructions on a processor or through automated system operations. Connectivity instructions refers to executable code for integrating and/or implementing a building block added to an extension point. Connectivity instructions may include scripts, APIs, parameter settings, and/or code, that when applied, may integrate a building block at an extension point in a seamless manner, such that the capabilities of the building block feel fully native to the platform, and deliver a smooth and unified user experience.

Automated generation of connectivity instructions may permit integration of a building block within a software platform without requiring a software developer to write executable code. Execution of connectivity instructions by a software platform may permit a building block to access contextual data required to implement the capabilities of the building block within the context of the extension point hosting the building block. The connectivity instructions may implement the configuration choices and/or user preferences in a runtime environment of a software platform. Defining how a building block is to be linked with an extension point refers to specifying and/or declaring how a building block may be integrated and/or incorporated in a software platform when connected to the extension point. Defining how a building block may be linked with an extension point may include declarations of data types that may be exchanged between the particular building block, the particular extension point, and/or additional components (e.g., additional building blocks and/or extension points), actions that may be taken (e.g., in response to one or more events), rules and/or filters (e.g., to ensure consistent and/or predicable execution). Defining how a building block may be linked with an extension point may additionally include applications of settings and/or parameters for customizing an implementation of the particular building block in accordance with user-defined preferences. Defining how a building block may be linked with an extension point may additionally include retrieval of data associated with a particular context for executing the particular building linked to the extension point, and/or any other information associated with integrating the particular building block to the software platform via the particular extension point. In some embodiments, defining how a building block may be linked with an extension point may include determining a data set and/or data structure for importing to the building block, e.g., in associated with a board, table, and/or chart.

Some disclosed embodiments involve deducing whether additional information is required for implementing the connectivity instructions. Deducing refers to determining, concluding, extrapolating, assessing, and/or reasoning. In some embodiments, deducing may include simulating in an insulated environment (e.g., a sandbox). In some embodiments, deducing may include recruitment of an AI agent. For implementing connectivity instructions refers to fulfilling, effectuating, and/or executing the connectivity instructions. Whether additional information is required refers to whether further data is needed. As an example, at least one processor may deduce if additional parameters, settings, rules, filters, permissions, and/or instructions are necessary for implementing the connectivity instructions in a predictable manner consistent with additional components (e.g., additional building blocks) included in the software platform. As another example, at least one processor may deduce if a data set and/or data structure is required to be accessed to implement the capabilities of the building block. At least one processor may perform one or more checks, probes, tests, and/or simulations to determine if the connectivity instructions, based on the connectivity information of the first building block and the first extension point, are sufficient for hosting the first building block by the first extension point. If the at least one processor determines that additional information is required, the at least one processor may prompt the particular user for the additional information, determine the additional information using one or more logical and/or reasoning operations, and/or retrieve the additional information from one or more resources, such as an API, a data structure, local and/or remote storage, one or more additional building blocks and/or extension points, and/or any other resource. For example, at least one processor may request a credential from the particular user to access a data structure needed to implement the capabilities of the first building block. In some embodiments, an AI agent may determine if additional information is required, and/or may facilitate in acquiring the additional information using one or more logical and/or reasoning operations to ensure that the first building block linked to the first extension point results in a consistent and/or predictable implementation. For example, at least one processor may validate the connectivity instructions against the building block schema and/or the extension point schema. Such validation may include verifying that required fields and schema-required parameters are present, that parameter types and allowed values satisfy schema constraints, and that any required credentials and/or authorization scopes for external resources are available and sufficient.

Implementing the connectivity instructions thereby modifying the functionality of the software platform. Implementing connectivity instructions refers to fulfilling, effectuating, and/or executing the connectivity instructions. It may refer to the execution of one or more technical operations that establish, manage, or facilitate communication between components, systems, resources, and/or services within a software platform or between the platform and external entities. These instructions may be embedded in code, triggered by user actions, and/or automatically executed by a processor, and they may serve to enable data exchange, service invocation, or resource access across networked environments. For example, at least one processor may alter and/or format data types exchanged between the first building block and the first extension point for compatibility, retrieve data from a data structure and/or a board for use by the building block while hosted by the first extension point, limit and/or modify some capabilities of the first building block for compatibility with the first extension point and/or additional building blocks, and/or perform any other operation for linking the first building block to the first extension point. Modifying the functionality of the software platform refers to changing, adapting, and/or customizing the capabilities and/or features of the software platform. It may refer to the act of altering, enhancing, restricting, or reconfiguring the operational behavior of at least some portions of a software system to achieve a different or improved outcome. This modification may be initiated by a user, developer, administrator, or automated process, and may affect how the platform performs tasks, interacts with users, integrates with other systems, or manages resources. Implementing the connectivity instructions to link the first building block to the first extension point may incorporate capabilities associated with the first building block into the software platform, thereby modifying the capabilities (e.g., the functionality) of the platform.

In some embodiments, implementing the connectivity instructions thereby modifying the functionality of the software platform may mean that that the software platform executes a set of instructions—referred to as connectivity instructions—that establish or manage communication between components, services, or external systems. As a result of executing these instructions, the platform's functionality may be modified. This modification may include enabling new features, activating integrations, altering data flows, or changing how modules interact. In some such embodiments, the act of implementing connectivity is not passive; it actively transforms the platform's operational capabilities.

By way of a non-limiting example, in FIG. 4, at least one processor (e.g., processor 102 in FIG. 1) may link Email building block 314 to Integrate extension point 320. The particular user may use an electronic mouse and/or a touch sensitive screen to move and place Email building block 314 over Integrate extension point 320. This may trigger at least one processor to use the connectivity information for Email building block 314 and the connectivity information for Integrate extension point 320 to generate connectivity instructions defining how Email building block 314 may be linked with Integrate extension point 320. For example, the connectivity information for Email building block 314 may include an identifier and/or email address for the particular user, and/or an API for accessing the email client of the particular user permitting access to the email account of the particular user, and the connectivity information for Integrate extension point 320 may include a board identifier for board 300 and/or a recipe automating integration of emails into board 300, permitting linking of emails from the account of the particular user to board 300. The connectivity information for Integrate extension point 320 may additionally include identifiers for contacts included on board 300, permitting linking of emails from the particular user's account to particular cells of board based on the contact identifier. For instance, scrolling and/or hovering over the associated contact name in board 300 may cause a presentation of associated emails in a pop-up window. At least one processor may deduce whether additional information is required for implementing the connectivity instructions, e.g., a credential for accessing the email client, and/or one or more filters for retrieving the emails.

At least one processor may prompt the particular user for the credential, and may determine to apply a context filter (e.g., only present emails associated with tasks included in board 300) and a date filter (e.g., only present emails from the last 30 days) to the emails. At least one processor may use the additional information to implement the connectivity instructions to modify the functionality of software platform 302. Thus, in response to hovering over a specific contact 400 in board 300, implementation of the connectivity instructions associated with linking Email building block 314 to Integrate extension point 320 may cause presentation of a pop-up window 402 displaying emails exchanged with specific contact 400 in the last 30 days in association with Deal 3.

In some disclosed embodiments, the connectivity instructions resolve the first building block connectivity information with the first extension point connectivity information. To resolve refers to reconcile, accommodate, adjust, coordinate, and/or conform. Resolving may include adding and/or removing parameters, modifying and/or converting data types, calling and/or revoking one or more functions and/or APIs, and/or adding, removing, and/or changing one or more settings. At least one processor may identify one or more inconsistencies and/or conflicts between the first building block connectivity information and the first extension point connectivity information. Such inconsistencies may be associated with a type of data exchanged between the first building block and the first extension point and/or additional building blocks, an event triggering implementation of a capability of the first building block, capabilities of additional building blocks linked to additional extension points on the software platform, and/or any other type of inconstancy. At least one processor may determine the connectivity instructions in a manner to resolve such inconsistencies and/or conflicts to enable a predictable and/or consistent (e.g., error free) implementation of the capabilities of the first building block in the context of the linkage to the first extension point.

In some disclosed embodiments, resolving the first building block connectivity information with the first extension point connectivity information defines input-output types enabling communication between the first building block and the first extension point. Input-output types refers to data parameters that may be exchanged between the first building block and the first extension point. Input-output types may define a format, structure, and/or nature of data that is received (inputted) and/or produced (outputted) between the first building block and the first extension point. For example, input-output types may include text strings, numerical values, objects, files, function calls, memory addresses, addresses for APIs, tables, arrays, linked lists, queues, and/or additional data structures. Defining input-output types may include stating and/or declaring the types of data that may be transferred between the first building block and the software platform via the first extension point to enable consistent and/or reliable (e.g., error-free) implementation of the capabilities of the first building block while hosted by the first extension point. Resolving the connectivity information of the first building block and the first extension point may define the data types that may be exchanged between the first building block and the first extension point, and/or under what conditions, circumstances, and/or limitations an exchange of data may occur. For example, resolving the connectivity information of the first building block and the first extension point may limit the exchange of some data types between the first building block due to incompatibility with the context and/or use-case associated with the first extension point.

In some disclosed embodiments, resolving the first building block connectivity information with the first extension point connectivity information defines an implementation of the capabilities of the first building block while hosted by the first extension point. While hosted by the first extension point refers to when linked to a software platform via the first extension point. This may refer to a time period during which a building block is actively hosted by an extension point, while data is exchanged between the building block and the extension point, and/or while one or more execution threads flow between the building block and the extension point. To define an implementation of the capabilities of the first building block while hosted by the first extension point refers to defining (as described elsewhere herein) a fulfillment, application, deployment, and/or effectuation of the capabilities of the first building when linked to a software platform via the first extension point. A building block may be hosted by a plurality of differing extension points, each extension point providing a differing context and/or use-case for the capabilities of a particular building block. Thus, the scope, extent, and/or application of the capabilities of the first building block on a software platform may be affected by the extension point on which the first building block is hosted. Resolving the connectivity information of the first building block and the first extension point may define which capabilities of the first building block may be implemented, and/or under what conditions, circumstances, and/or limitations the implementation may occur. For example, resolving the connectivity information of the first building block and the first extension point may limit some capabilities of the first building block due to incompatibility with the context and/or use-case associated with the first extension point.

By way of a non-limiting example, in FIG. 4, application of the connectivity instructions by at least one processor (e.g., processor 102 in FIG. 1) may resolve the connectivity information for Email building block 314 and Integrate extension point 320. For instance, the connectivity instructions may resolve differing numbers of parameters and/or conflicting data types defined for the connectivity information for Email building block 314 and the connectivity information for Integrate extension point 320. In some embodiments, resolving the connectivity information for Email building block 314 and for Integrate extension point 320 may define input-output types enabling communication between Email building block 314 and Integrate extension point 320. For instance, specific contact 400 may be associated in board 300 with a first identifier (e.g., a numerical code) whereas specific contact 400 may be associated in the email client with a second identifier (e.g., an email address). The connectivity instructions may permit conversion between the numerical code and the email address to permit querying the email client using the email address and subsequently presenting emails associated with contact 400 in table 300 based on the numerical code. In some embodiments, resolving the connectivity information of Email building block 314 and Integrate extension point 320 defines an implementation of the capabilities of Email building block 314 while hosted by Integrate extension point 320, for instance to incorporate emails from relevant contacts into board 300.

In some disclosed embodiments, the connectivity instructions are based on the first extension point schema. Basing connectivity instructions on an extension point schema refers to applying the extension point schema to determine the connectivity instructions. For example, an extension point schema for a particular extension point may prohibit exchange of certain data types, limit the types of capabilities that may be implemented by a building block, and/or limit which events may trigger one or more capabilities of a building block. The first extension point schema may enforce such limitations to ensure that implementing the capabilities of the first building block does not introduce inconsistencies and/or conflicts with other capabilities and/or features of the software platform, such as may be associated with additional building blocks connected thereto.

In some disclosed embodiments, differing iterations of the first building block hosted by the first extension point are associated with differing implementations of the capabilities and differing versions of the building block schema of the first building block. Differing iterations of a building block hosted by an extension point refers to separate executions of the building block while hosted by the extension point. It may refer to multiple distinct versions or configurations of a modular functional unit (e.g., a building block) that are deployed or executed within a designated integration interface (e.g., an extension point) of a software platform. For example, a bold button building block connected to a ribbon extension point of a text editor may be used multiple times. Each use of the bold button may be a different iteration. In some instances, each iteration of a building block may pick up from a prior iteration, such that each iteration differs. For example, each iteration of a building block may use a data structure and then update the data structure for the next iteration. Differing implementations of the capabilities refers to distinct and/or dissimilar applications of the capabilities. Differing versions of a building block schema refers to distinct and/or separate releases, editions, and/or variations of the building block schema. Differing versions of a building block schema may cause a building block to interact with other components on the software platform in differing ways. For instance, a building block may include a random element that changes with each iteration. Such a building block may be used to generate an interactive game, music, graphics, each iteration associated with a different game layout, a different piece of music, and/or a different graphic. As another example, a simulator building block may generate a different set of data for each simulation and may perform different operations (e.g., implement differing capabilities) on each data set.

By way of a non-limiting example, in FIG. 4, the connectivity instructions may be based on the schema for Integrate extension point 320. For example, the schema for Integrate extension point 320 may include rules, permissions, and/or filters for integrating data from external data structures into board 300. In some embodiments, differing iterations Email building block 314 hosted by Integrate extension point 320 may be associated with differing implementations of the capabilities and differing versions of the schema of Email building block 314. For instance, a first iteration of Email building block 314 hosted by Integrate extension point 320 may be limited to reading emails exchanged with specific contact 400, whereas a second iteration of Email building block 314 hosted by Integrate extension point 320 may include a capability to respond to and send an email to specific contact 400 via pop-up window 402 in board 300.

Some disclosed embodiments involve, in response to determining a mismatch between the first extension point and the first building block, preventing the linking of the first building block with the first extension point. A mismatch refers to a discrepancy, a conflict, an incompatibility, and/or an inconsistency. In the present context, it may refer to a lack of compatibility or alignment between the connectivity requirements, structural expectations, or operational constraints of the first extension point and those of the first building block. Preventing refers to averting, thwarting, intercepting, and/or blocking. In the present context, preventing may indicate that the system is configured to block or disallow the establishment of a functional relationship between the building block and the extension point. This may occur due to architectural rules, compatibility constraints, policy enforcement, or runtime conditions. The prevention may occur at design time (e.g., through schema validation), deployment time (e.g., through configuration settings), or runtime (e.g., through dynamic evaluation of conditions or permissions). Preventing the linking of a building block with an extension point refers to thwarting and/or preventing the building block from being hosted by the extension point. It may refer to a deliberate technical constraint or control mechanism within the software platform that prohibits or restricts the association, integration, or activation of a building block or modular functional unit with a designated integration interface or extension point. For example, at least one processor may halt and/or prevent execution of the connectivity instructions, and/or take a remedial action (e.g., issue an alert) upon detecting an incompatibility between data types and/or a use-case associated with the first building block and data types and/or a use-case associated with the first extension point.

In some disclosed embodiments, the first extension point includes a plurality of connection sites for linking the first building block thereto. A plurality of connection sites for linking a building block refers to multiple (e.g., at least two) locations where the building block may be attached to an extension point. For example, an extension point may include a plurality of sockets and/or slots (e.g., connection sites), each capable of hosting a building block, permitting the extension point to simultaneously host a plurality of building blocks.

Some disclosed embodiments involve enabling selection of a particular connection site from the plurality of connection sites for linking the first building block to the first extension point. Enabling selection of a particular connection site from the plurality of connection sites refers to providing a capability for a user or the system to choose a single connection site from multiple available connection sites on the extension point. For example, a software platform may provide a user interface (e.g., a menu) permitting a user to choose which connection site to user for hosting the building block. The selection may be performed using a mouse, keyboard, stylus, touch-sensitive screen, voice command, and/or any other type of user input.

By way of a non-limiting example, in FIG. 3, in response to determining a mismatch between Integrate extension point 320 and Email building block 314, at least one processor (e.g., processor 102 in FIG. 1) may prevent the linking of Email building block 314 with Integrate extension point 320. For instance, the mismatch may be associated with a lack of permission to access the email client required for implementing the capabilities of Email building block 314. In some embodiments, Integrate extension point 320 may include a plurality of connection sites for linking the first building block thereto. For instance, Integrate extension point 320 may include a plurality of connections sites for simultaneously linking Email building block 314 and Messaging building block 316 thereto. In some embodiments, at least one processor may enable selection of a particular connection site from the plurality of connection sites for linking Email building block 314 to Integrate extension point 320.

In some disclosed embodiments, hosting of the first building block by the first extension point enables generating an additional product atop the software platform. Generating refers to producing, constructing, and/or outputting. A product refers to a packaged application and/or program developed to perform one or more specific tasks and/or solve particular problems. An additional product atop a software platform may include a new board with new features.

By way of a non-limiting example, in FIG. 4, hosting of Email building block 314 by Integrate extension point 320 may generate an additional email client atop software platform 300, enabling the particular user to read and write emails from contacts included in board 300 while viewing board 300.

In some disclosed embodiments, the first building block exposes a second extension point associated with a second extension point schema defining second extension point connectivity information and configured to host at least a second subset of the plurality of differing building blocks. A first building block exposes a second extension point refers to the first building block presenting, revealing, and/or displaying the second extension point. For example, the second extension point may be a location on a user interface, such as a ribbon, a pane, a window, and/or a field. Thus, the first building block may include a socket and/or slot (e.g., a second extension point) for hosting additional building blocks, atop the first building block to add additional capabilities. The second extension point exposed from the first building block may be compatible with a differing set of building blocks than the first extension point hosting the first building block. The schema for the second extension point may define which building blocks may be hosted by the first building block. In this manner, multiple building blocks may be assembles in differing combinations and arrangements to provide a flexible, modular environment for facilitating the development of customized software applications.

Some disclosed embodiments involve accessing the second extension point to enable alteration of the software platform via the second extension point. Accessing the second extension point refers to interacting and/or making use of the second extension point. To enable alteration of the software platform via the second extension point refers to permit modifying the software platform using the second extension point. For example, the software platform may be altered by connecting another building block providing an additional set of capabilities to the second extension point. The additional set of capabilities may extend the functionality of the software platform. Some disclosed embodiments involve enabling selection of a second building block from the second subset of the plurality of differing building blocks for hosting by the second extension point on the first building block. This may be understood as described earlier for enabling selection of the first building block. Thus, the software platform may provide a user interface permitting a user to select any number of building blocks for hosting by any number of available extension points. In some disclosed embodiments, the second building block exposes a third extension point associated with a third extension point schema and is configured to host at least a third subset of the plurality of differing building blocks. This may be understood as described above for the first building block exposing the second extension point.

In some disclosed embodiments, removal of the third building block is required prior to removal of the second building block. Removal refers to detachment from, termination of, unlinking of, and/or disconnection from something. Removal of a building block may terminate the hosting by the extension point to which the building block is connected. Such a removal may halt transfers of data between the building block and the extension point, terminate of one or more execution and/or interpreting threads associated with the hosting, disable one or more capabilities associated with the building block, and/or terminate any other aspect associated with the linkage of the building block to the extension point. Required refers to necessary, mandatory, and/or requisite. Prior to removal of the second building block refers to before disconnecting the second building block from the second extension point. Thus, before removing the second building block, on which the third building block is connected, a developer may need to first disconnect the third building block. Some building blocks may depend on other building blocks, the dependency corresponding to the order in which the building blocks may be connected. For instance, implementing the capabilities of the third building block may depend on being able to implement the capabilities of the second building block, and which may depend on being able to implement the capabilities of the of the first building block. In such a case, removal of the second building block prior to removal of the third building block may lead to errors, since the capabilities of the second building block, required for implementing the third building block, may be inaccessible. Thus, to ensure consistent and/or reliable implementation of capabilities, in such cases, the third building block must be removed before removal of the second building block.

In some disclosed embodiments, the second building block inherits features from at least one other building block of the plurality of differing building blocks. To inherit refers to obtain, acquire, and/or derive. The second building block may inherit features, capabilities, and/or characteristics from at least one other building block within the platform. This means that the second building block may reuse, extend, and/or enhance the functionalities already present in an existing building block, promoting modularity and code reuse. By inheriting features, developers may efficiently build complex functionalities by leveraging and/or exploiting previously developed components, ensuring consistency and reducing duplication across the software platform.

Some disclosed embodiments involve verifying that second connectivity instructions defining how the second building block is to be linked with the second extension point are compatible with the first extension point schema and the building block schema associated with the first building block. Verifying refers to confirming, validating, and/or establishing. Compatible refers to consistent, nonconflicting, and/or reconcilable. Second connectivity instructions defining how the second building block is to be linked with the second extension point may be understood as described above for the connectivity instructions defining how the first building block is to be linked with the first extension point. Verifying that the second connectivity instructions are compatible with the first extension point schema and the first building block schema may include performance of one or more checks, probes, tests, and/or simulations to assess if implementing the second connectivity instructions cause any conflicts, and/or errors, in the context of the first extension point schema and the first building block schema. For example, at least one processor may check that the types of data and/or the number of parameters transferred between the second building block and the second extension point accord with allowable data types and/or allowable number of parameters defined in the first extension point schema and the first building block schema. As another example, at least one processor may check that the second connectivity instructions do not violate any rules, filters, and/or instructions defined in the first extension point schema and the first building block schema.

By way of a non-limiting example, in FIG. 4, Email building block 314 may expose a second extension point 404 associated with a second extension point schema defining second connectivity information for hosting building blocks 316 and/or 318. At least one processor (e.g., processor 102 of FIG. 1) may access second extension point 404 to enable alteration of software platform 302 via second extension point 404. At least one processor may enable selection of Smart Update building block 318 from the second subset of building blocks 316 and 318 for hosting by second extension point 404 on the Email building block 314. For instance, Smart Update building block 318 may include a recipe for automatically updating board 300 based on the content of the emails incorporated into board via Email building block 314.

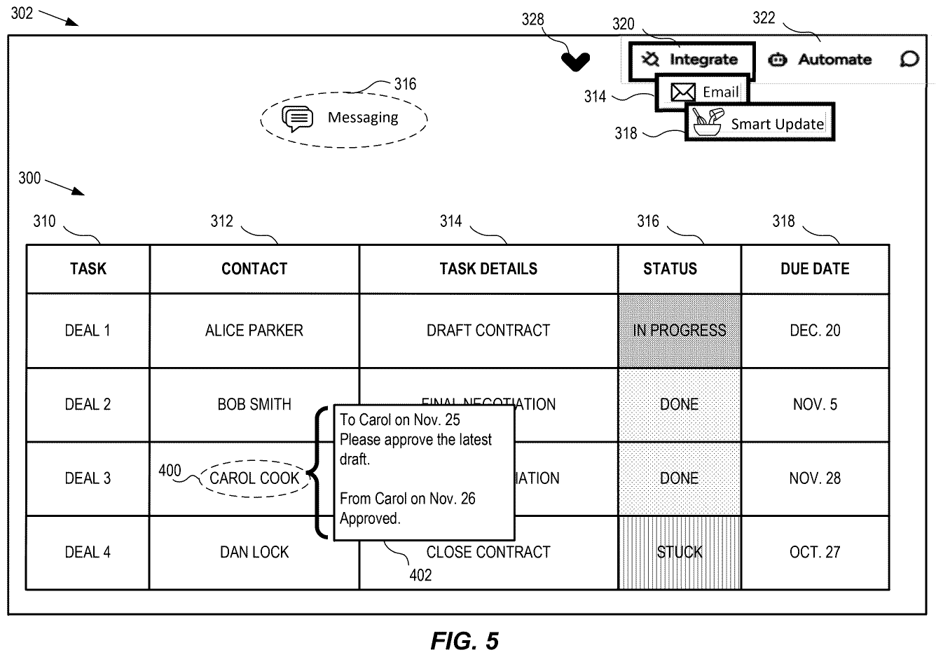

By way of a non-limiting example, reference is made to FIG. 5 which illustrates board 300 after hosting of Smart Update building block 306 on second extension point 404 of modular software platform 302, consistent with some disclosed embodiments. At least one processor may employ a recipe associated with Smart Update building block 318 to analyze the emails included in pop-up window 402, and may update board 300 based on the analysis. For instance, based on the email dated November 26 (“Approved”) the at least one processor may deduce that the status for the task associated with specific contact 400 is obsolete because the initial negotiations have been approved. Consequently, the at least one processor may update the status column 316 for specific contact 400 from “IN PROGRESS” to “DONE”. In some embodiments, removal of Smart Update building block 318 may be required prior to removal of Email building block 314. In some embodiments, Smart Update building block 318 may inherit features from Email building block 310 and/or Messaging building block 316. For instance, such inherited features may include data formats and/or types to permit automated analysis of the content of emails and/or messages. In some embodiments, at least one processor may verify that second connectivity instructions defining how Smart Update building block 318 is to be linked with second extension point 404 are compatible with the schema for Integrate extension point 320 and Email building block 314.

In addition to the foregoing email-related example, the disclosed framework may be used to assemble customized products in other domains. For example, building blocks may be linked to extension points to integrate IT service management workflows (e.g., creating/updating tickets responsive to chat messages or status changes), CRM and sales operations (e.g., synchronizing contacts, deals, and tasks across systems), calendar and scheduling workflows (e.g., generating tasks and reminders from events), HR and recruiting pipelines (e.g., ingesting applicant data and driving interview scheduling and approvals), and/or finance/procurement operations (e.g., routing invoices for approval and updating downstream systems). In such embodiments, similar schema-based compatibility checks, credential/scope validation, and connectivity instructions as described herein may be used to host user-facing components in a GUI and/or invoke server-side components through APIs, events, queues, and/or webhooks.

Some disclosed embodiments involve an AI agent configured to facilitate automated generation of a software product. An AI agent may be understood as described elsewhere herein. A software product refers to a packaged software application that may be ready for use by an end user. To facilitate refers to assist, advance, and/or promote. Automated generation of a software product refers to unmanned and/or self-operating production of a software product, without requiring manual writing of code, configuration of settings, and/or any other direct human intervention. Some disclosed embodiments involve an AI agent configured to receive a requirement specification defining a functionality to be achieved by a SaaS platform. To receive (e.g., signals) refers to obtaining, acquiring, and/or otherwise gaining access to a signal over a distance. Receiving may be performed on a wired and/or wireless channel. The signal may include information encoded in an electronic and/or electromagnetic signal, and/or electric power for driving one or more electrical components. A requirement specification defining functionality refers to a document and/or description outlining specific features, behaviors, and/or objectives for implementation by a software platform. Such a requirement specification may serve as a blueprint for desired capabilities, guiding a design and development process to ensure the software product meets user needs and/or goals. To be achieved refers to be implemented, accomplished, and/or fulfilled. A Software as a Service (SaaS) platform refers to a cloud-based software delivery model in which applications may be hosted by a service provider and made available to users over a network, as described elsewhere herein. A SaaS platform may enable a user to access and/or use software without the need for local installation and/or maintenance, streamlining deployment and/or updates while offering scalable and flexible solutions for a wide range of needs.

Some disclosed embodiments involve an AI agent configured to analyze a plurality of existing building blocks and their respective schemas to determine available capabilities within the software platform. To analyze a plurality of existing building blocks and their respective schemas refers to examine, assess, inspect, and/or investigate available building blocks and associated schemas. Such an analysis may include static and/or dynamic analysis. Static analysis may include searching for key words, phrases, and/or patterns, parsing associated code, examining one or more data structures (e.g., syntax trees, control graphs, state machines), and/or any other type of static analysis. Dynamic analysis may occur during runtime, and may include simulating a behavior of one or more building block, testing for one or more capabilities, and/or any other type of dynamic analysis. The AI agent may perform one or reasoning and/or data analytics operations based on a static and/or dynamic analysis of the available building blocks and their respective schemas. To determine available capabilities within a software platform refers to assessing and/or identifying capabilities (as described elsewhere herein) offered by the software platform.

Some disclosed embodiments involve an AI agent configured to generate a manifest specifying the required building blocks and corresponding connectivity instructions based on the received requirement and a SaaS platform schema. A manifest refers to a prospectus, tabulation, digest, and/or inventory. Specifying refers to detailing, listing, indicating, and/or defining. A SaaS platform schema refers to a structured framework and/or blueprint that defines an organization, relationships, and/or rules governing components and functionalities within the SaaS platform. Such a schema may outline how various software components (e.g., building blocks and/or extension points) may be specified, extended, customized, and/or interact with each other. A SaaS schema may serve as a guide for how new functionalities may be integrated into the platform, ensuring compatibility and consistency. The required building blocks refers to specific and/or selected building blocks capable of providing capabilities corresponding to the desired capabilities defined in the requirement specification. Corresponding connectivity instructions refers to the connectivity instructions (as described earlier) needed to link the required building blocks to the software platform. For example, the connectivity instructions may be generated based on the building block schema of the required building blocks, and any associated extension point schema. Based on the received requirement and the SaaS platform schema refers to consistent with, and/or in the context of the requirement specification and the schema of the SaaS platform. This may ensure that implementation of the connectivity instructions to link the required building blocks does not conflict with the SaaS platform schema while satisfying the functionality defined in the requirement specification.

In some disclosed embodiments, the manifest defines the required interconnections among the selected building blocks. Required interconnections refers to necessary links, relationships, interdependencies, and/or associations. In some embodiments, required interconnections may include a hierarchy, order, and/or sequence (e.g., to permit dependencies and/or inheritance between different building blocks). The required interconnections among the selected building blocks refers to how the building blocks are to be connected, and/or in which order. Since capabilities of some building blocks may depend on capabilities and/or inherit attributes from other building blocks, the AI agent may determine an order and/or structure for connecting the building such that any dependencies and/or inheritances may be satisfied.

Some disclosed embodiments involve an AI agent configured to automatically construct the software product by linking the selected building blocks in accordance with the generated manifest. To automatically construct a software product refers to generate the software product in an unmanned and/or self-operating manner that does not require manual writing of code, configuration of settings, and/or any other direct human intervention.

By way of a non-limiting example, in FIGS. 3, 4, and 5, at least one processor (e.g., processor 102 in FIG. 1) may employ an AI agent 324 to facilitate automated generation of a software product. AI agent 324 may receive a requirement specification defining a functionality to be achieved by a SaaS platform (e.g., platform 302). The requirement specification may include free text entered into a chat box of AI agent 324, such as “import relevant emails and update cells based on email content.” AI agent 324 may analyze the building blocks 314, 316, and 318 and their respective schemas to determine available capabilities within software platform 302. AI agent 324 may generate a manifest specifying building blocks 314 and 318 as required to meet the specification and may generate corresponding connectivity instructions based on the received requirement and a schema for platform 302. The manifest may define required interconnections among building blocks 314 and 318 selected for meeting the requirement specification. For instance, the manifest may stipulate that Email building block 314 must be connected to Integrate extension point 320 before Smart Update building block 318 may be connected to extension point 404 of Email building block 314. AI agent 324 may automatically construct the software product by linking selected building blocks 314 and 318 in accordance with the generated manifest.

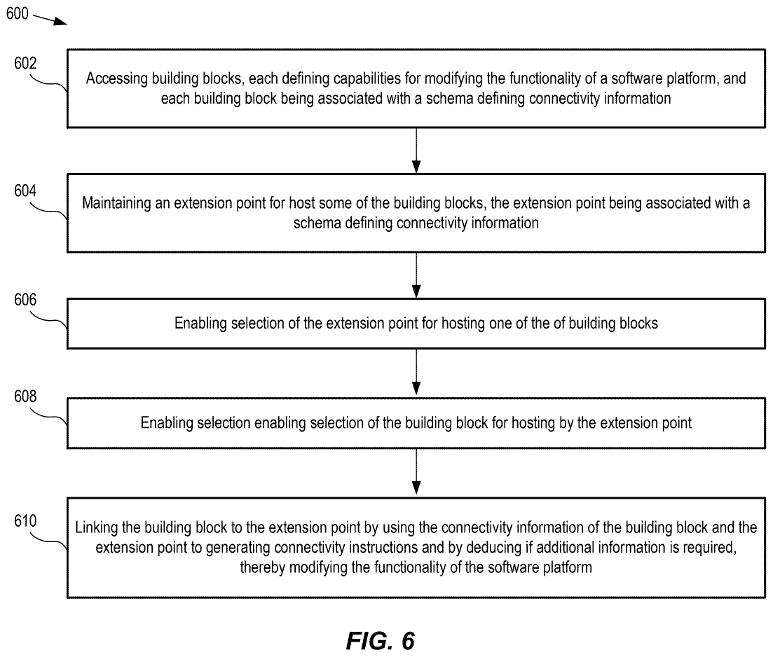

FIG. 6 is a flowchart of example process 600 for designing a modular software platform with extendable functionality, consistent with embodiments of the present disclosure. In some embodiments, process 600 may be performed by at least one processor (e.g., processor 102 in FIG. 1) to perform operations or functions described herein. In some embodiments, some aspects of process 600 may be implemented as software (e.g., program codes or instructions) that are stored in a memory (e.g., memory 104) or a non-transitory computer readable medium. In some embodiments, some aspects of process 600 may be implemented as hardware (e.g., a specific-purpose circuit). In some embodiments, process 600 may be implemented as a combination of software and hardware.

Process 600 may include a step 602 of accessing a plurality of building blocks, each building block defining a specific set of capabilities for implementation by the software platform for modifying the functionality thereof, and wherein each building block is associated with a specific building block schema defining specific building block connectivity information. By way of a non-limiting example, in FIG. 3, at least one processor (e.g., processor 102 in FIG. 1) may access plurality of building blocks 314, 316, and 318, each defining a specific set of capabilities for implementation by software platform 302 for modifying the functionality thereof. Each of building blocks 314, 316, and 318 may be associated with a specific building block schema defining specific building block connectivity information.

Process 600 may include a step 604 of maintaining a first extension point of a plurality of differing extension points available in the software platform, the first extension point being configured to host at least a first subset of the plurality of building blocks, wherein the first extension point is associated with a first extension point schema defining first extension point connectivity information. By way of a non-limiting example, in FIG. 3, at least one processor (e.g., processor 102 in FIG. 1) may maintain Integrate extension point 320 of a plurality of differing extension points 320 and 322 available in software platform 302. Integrate extension point 320 may host Email building block 314 and Messaging building block 316 of building blocks 314, 316, and 318. Integrate extension point 320 may be associated with a first extension point schema defining first extension point connectivity information.

Process 600 may include a step 606 of enabling selection of the first extension point for hosting at least one of the plurality of building blocks. By way of a non-limiting example, in FIG. 3, at least one processor (e.g., processor 102 in FIG. 1) may enable selection of Integrate extension point 320 for hosting at least one of Email building block 314 and Messaging building block 316.

Process 600 may include a step 608 of enabling selection of a first building block for hosting by the first extension point. By way of a non-limiting example, in FIG. 3, at least one processor (e.g., processor 102 in FIG. 1) may enable selection Email building block 314 for hosting by Integrate extension point 320.

Process 600 may include a step 610 of linking the first building block to the first extension point, wherein linking includes using first building block connectivity information associated with the first building block and the first extension point connectivity information to generate connectivity instructions defining how the first building block is to be linked with the first extension point, deducing whether additional information is required for implementing the connectivity instructions, and implementing the connectivity instructions thereby modifying the functionality of the software platform. By way of a non-limiting example, in FIG. 3, at least one processor (e.g., processor 102 in FIG. 1) may link Email building block 314 to Integrate extension point 320. Linking may include using connectivity information for Email building block 314 and Integrate extension point 320 to generate connectivity instructions defining how Email building block 314 may be linked with Integrate extension point 320, deducing whether additional information is required for implementing the connectivity instructions, and implementing the connectivity instructions thereby modifying the functionality of software platform 302.

Some disclosed embodiments involve altering a software functionality Altering refers to modifying, changing, adjusting, and/or transforming an existing state, structure, and/or behavior. For example, altering may involve adding, removing, or modifying features, capabilities, or components of a system. Functionality refers to a set of features, capabilities, and/or operations that a system, application, or component can perform. Functionality may include specific tasks, processes, and/or services that a software platform may provide to a user and/or system. A software platform refers to an environment, foundation, and/or ecosystem for building, running, and/or managing software applications, as described elsewhere herein. It may provide a set of tools, services, and/or interfaces that developers can use to create, customize, or extend applications. Some examples of software platforms include Salesforce®, Monday.com®, and Android®. A software application refers to a program designed to perform a defined set of tasks and/or functions. Some examples of software applications may include a word processor, an email client, and a photo editor. A software platform may provide an environment, including foundational services, tools, APIs, and/or libraries, for hosting one or more software applications. Altering software functionality may refer to modifying, extending, and/or customizing the capabilities, features, or operations of a software component. This may involve adding new features, modifying and/or updating existing features, removing obsolete and/or incompatible features, and/or reconfiguring a behavior of one or more aspects of a software platform to meet one or more requirements and/or use cases. For example, functionality of a software platform and/or application may be altered by adding and/or removing one or more building blocks and/or extension points to customize and/or extend the capabilities of a platform and/or application. This process may allow users and/or developers to add new features, modify existing features, and/or produce new applications within the software platform in an automated, codeless environment (e.g., without requiring manual writing of code).

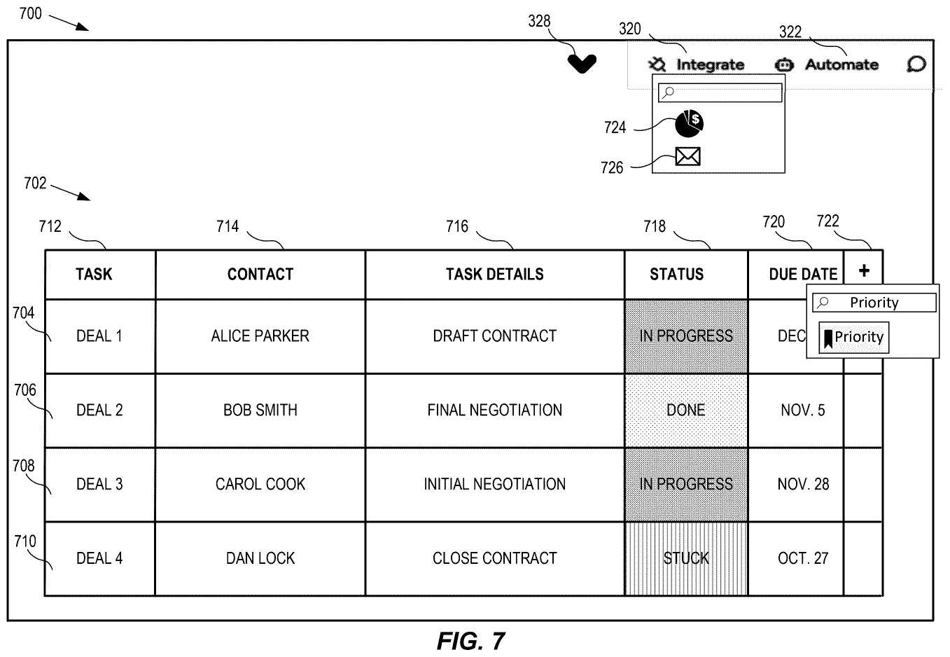

By way of a non-limiting example, reference is made to FIG. 7 illustrating an exemplary modifiable software platform 700 with alterable functionality, consistent with some disclosed embodiments. Modifiable software platform 700 may be a Software as a Service (SaaS) platform, e.g., by providing a cloud-based environment, enabling one or more client devices (e.g., client device 202 in FIG. 2) to access software services and/or data hosted by server 200 and/or data structure 206 via network 204. For instance, software platform 700 may provide a board 702 presenting task schedules for a plurality of different contacts to a plurality of different users and/or client devices over network 204, permitting the plurality of users to collaborate over network 204 by interacting with board 702. The plurality of users (e.g., one or more of the contacts indicated in a column 714 and/or one or more project managers) may view board 702 via network 204 using different instances of client device 202.

Some disclosed embodiments involve maintaining a software platform including a plurality of framework elements. Maintaining refers to the act of keeping something in a desired state or condition over time. It may include storing, protecting, updating, monitoring, and/or backing up to preserve the integrity and/or performance of a software platform. In the present context, maintaining may include allocating resources and managing versions for different framework elements, synchronizing data and logic flows between discrete interoperable software modules that collectively perform one or more functions. It may include an ongoing process of ensuring that resources remain functional and securely aligned with user needs and an evolving technological environment, validating inputs and outputs, and ensuring that plugins and/or customizations continue to function as intended across updates, deployments, and system changes. Framework elements refers to fundamental components and/or reusable units of software that form a structure of a software system and/or application. Framework elements may include building blocks, extension points, modules, libraries, data structures, functions, Application Programming Interfaces (APIs), and/or other reusable software components that may be combined in differing combinations to produce customized software applications. A plurality of different framework elements refers to a collection of differing, distinct framework elements that may be combined in different ways to produce new software applications, and/or extend functionalities of existing software applications in a modular, flexible, and scalable manner. The framework elements may be designed to support extensibility, permitting software applications to evolve, adapt, and accommodate new functionalities in a manner consistent with the underlying architecture of the platform.

Maintaining a plurality of framework elements on a software platform may involve allocating memory and/or processing resources and/or providing documentation for each framework element (e.g., including the version number, the most recent update, input and output data types, and/or any other type of information), and/or a list of available and/or permitted framework elements that may be used to alter the functionality of a software application. It may include applying regular updates to ensure the framework elements are compatibility with each other and/or with other system components as the software platform evolves over time. It may include performing version control, introducing new framework elements and/or removing obsolete and/or incompatible framework elements. It may include testing and/or troubleshooting individual framework elements, and/or differing combinations thereof. It may include providing a graphical user interface (GUI) to select, add, and/or remove framework elements from a software application in codeless environment. It may include enlistment of one or more AI agents to select, modify, update, and/or test existing framework elements, and/or generate new framework elements, e.g., based on AI-based determination of one or more software needs.

In some disclosed embodiments, at least one of the plurality of framework elements depends on at least another one of the plurality of framework elements. To depend refers to be associated and/or affiliated with, to rely on and/or to be support by something. When a second framework element depends on a first framework element, the second framework element may require the first framework element to function in a manner consistent with an expected functionality, and/or to provide one or more expected capabilities. For example, the second framework element may inherit one or more functionalities, data types, and/or other features from the first framework element, execution of the second framework element may require receiving data from the first framework element and/or may follow sequentially from an execution of the first framework element, and/or the first framework element and the second framework element may share one or more resource. Dependencies between framework elements may enable complex and/or interconnected architectures, where some framework elements may build upon and/or enhance the functionalities of other framework elements. Framework elements may depend from a single framework element or from multiple differing framework elements. Dependencies between framework elements may ensure consistent data and logical flows, and may improve efficiency when developing new framework elements.

By way of a non-limiting example, in FIG. 7, at least one processor (e.g., processor 102 in FIG. 1) may maintain software platform 700 including a plurality of framework elements. The plurality of framework elements may be presented via a GUI of a computing device (e.g., computing device 202 in FIG. 2), and may include board 702 including a plurality of rows 704, 706, 708, and 710, a plurality of columns 712, 714, 716, 718, and 720, an Add Column widget 722, a Financial Analytics widget 724, an Email building block 726 accessible via Integrate Extension point 320, and Automation extension point 322. Board 702 may provide a collaborative environment for different users to interact via a shared interface. Each of rows 704, 706, 708, and 710 may be associated with a different item (e.g., a different deal). Columns 712, 714, 716, 718, and 720 may be associated with different attributes for items in rows 704, 706, 708, and 710. For instance, column 712 may represent a “Task Name”, column 714 may represent a contact responsible for completing a task, column 716 may represent a description for each task, column 718 may represent a status for each task (e.g., “In Progress”, “Done”, “Stuck”), and column 720 may represent a due date for task completion. Add Column widget 722, a Financial Analytics widget 724, Email building block 726, Integrate Extension point 320, and Automation extension point 322 may permit extending and/or altering the functionality of software platform 700 in a codeless environment. The codeless environment may permit a user to extend or otherwise alter the functionality of board 702 without having to manually write code or manually provide code from another source, such as from a library or an AI agent.

Add Column widget 722 may automate the addition of columns to board 702, Financial Analytics widget 724 may automate the generation of financial reports, and Email building block 726 automate linkage of emails to board 702. Columns 712, 714, 716, 718, and 720 may depend on board 702 in that board 702 may provide a context, structure and/or rules for columns 712, 714, 716, 718, and 720. For instance, board 702 may define data types and permissible operations governing how each column functions, and data items presented in columns 712, 714, 716, 718, and 720 may be stored in a data structure associated with board 702. In other words, columns 712, 714, 716, 718, and 720 may not exist independently of board 702, and may rely on board 702 for initialization, data storage, and/or interaction with other components of software platform 700. Board 702 may define the schema for columns 712, 714, 716, 718, and 720, including required fields, validation logic, and/or compatibility requirements, ensuring that columns 712, 714, 716, 718, and 720 operate cohesively within the environment of board 702. Board 702 may thus host columns 712, 714, 716, 718, and 720 and enforces rules and/or integration protocols to maintain the integrity of software platform 700 and enable advanced features such as automations and/or integrations.

In some disclosed embodiments, each framework element is associated with a schema including rules defining how a functionality of the framework element is implemented. A schema associated with a framework element (e.g., an operation schema) refers to a blueprint, structure, and/or architecture governing the behavior of a building block, extension point, and/or any other type of framework element, as described elsewhere herein. A schema may be stored as a JSON file, a table, chart, map, and/or any other type of structure. It may define how a framework element interacts and/or connects with other framework elements and/or system components, dependencies and/or inherited features from other framework elements, types of data that may be exchanged, restrictions, constraints, rules, and/or protocols and/or any other information for integrating a framework element in a software application. Rules refers to directives, regulations, and/or precepts set and/or established in advance of their application to a particular use case. Rules may include instructions, conditions, and/or guidelines governing the behavior, operation, and/or implementation of a framework element. Functionality of a framework element refers to features, behaviors, and/or capabilities of the framework element. It may indicate what a framework element is able to do, the types of tasks that may be executed and/or services provided, contexts where the framework element may be used, and/or types of resources that may be affected when implementing a framework elements. Some examples of functionalities for a framework element may include data processing, user interface rendering, linking to external resources, and/or troubleshooting. Rules defining how a functionality of the framework element is implemented may refer to directives that determine how a particular feature or capability of a framework element may be executed and/or realized within the software platform. Such rules may include conditions and/or constraints for integrating a framework element in a particular context, resources that may be needed to implement the framework element, and/or logic for applying to ensure consistent and/or reliable integration of the framework element within a software application. Such rules may govern which types of data may be exchanged with other available framework elements, behavior and/or interactions of a particular framework element within a software application, which available framework elements may be connected to the particular framework element, dependencies on other available framework elements and/or dependencies of other available framework elements on the particular framework element, how the particular framework element may be integrated in a software application, and/or any other type of restriction and/or directive governing the implementation of a framework element within a software application. For example, rules might dictate permissible data types for a column, constraints on which widgets may be hosted within dashboards, and/or protocols for how automations are triggered and executed. Such rules may additionally include restrictions and/or conditions such as required fields, validation logic, and/or compatibility requirements with other framework elements, how specific features may be inherited or overridden, integration procedures for external services, timing constraints, and/or any other type of restriction governing integration of a framework element into a software application.

In some disclosed embodiments, the schema has a modifiable schema portion and a non-modifiable schema portion. A modifiable schema portion refers to a part of the schema that may be altered, customized, and/or extended. A modifiable schema portion may include optional, elective, and/or non-essential features, data types, and/or additional features, and may provide flexibility for adapting a framework element to specific use case and/or requirement. For instance, a modifiable schema portion might allow addition or removal of optional features to support for different data formats, customizable user interface elements, and/or hooks for integration with external services and/or resources. Depending on the requirements of a particular application or use case, a modifiable schema portion may permit tailoring of a framework element by adjusting one or more data types and/or additional properties, and/or incorporating one or more logic modules. A modifiable schema portion may permit extending and/or restricting capabilities of a framework element without affecting one or more core and/or fixed capabilities to thereby support a range of customization options while maintaining compatibility and/or consistency with the software platform. Some examples of modifiable schema portions may include field types (e.g., text, dropdown, status, formula), board and/or table structures, custom fields and/or columns, automation and/or integration mappings (e.g., from field to field). Some additional examples of modifiable schema portions may include columns that may be added and/or renamed, data types that may be changed (e.g., integer to string, addition or removal values from an enumeration data type), default values that may be changed, trigger events fields, condition logic structures, input/output data structures, and/or action or automation parameters.

A non-modifiable schema portion refers to a part of the schema that may be fixed and cannot be changed. A non-modifiable schema portion may be associated with essential and/or indispensable functionalities, without which a framework element may fail to operate and/or integrate into a software platform. It may include structural, platform-defined, and/or system-critical data elements that users cannot change without modifying core software and/or violating compatibility. A non-modifiable schema portion may ensure a core functionality of a framework element, maintain system integrity, and/or enforce critical rules within a software platform. It may include a data structure, field definitions, and/or system-level metadata element that may be predefined by the software platform, and/or required for the operation of boards, items, columns, automations, integrations, and/or user management within the platform. A non-modifiable schema portion may be inaccessible to user-level modification via a no-code configuration interface and/or standard API operation. A non-modifiable schema portion may include structural and/or semantic characteristics that may not be altered, overridden, and/or replaced by a user without modifying an underlying platform code. Some examples of non-modifiable schema portions may include system-generated identifiers (e.g., an item ID, a board ID, a group ID, and/or a column ID), platform-defined board and/or item metadata (e.g., group metadata, mandatory fields, and/or state attributes). Some additional examples may include internal data representations and/or validation rules associated with predefined column types (e.g., status, date, person, and/or links), metadata schemas associated with automation, integration, activity logs, API-dependent data structures. Maintaining a framework element having modifiable and non-modifiable schema portions may include dividing a schema into two parts: a first part that may be customized (modifiable) and a second part that remains fixed (non-modifiable). Such a structure may allow for flexibility in extending or adapting the platform's capabilities while preserving essential core functionalities and system integrity.

In some disclosed embodiments, the non-modifiable schema portions include core rules common to all of the framework elements. Core rules refers to fundamental principles, constraints, and/or instructions that may be essential to the functioning and/or integrity of a system. They may define basic behaviors, critical processes, and/or key relationships that may be universally applicable across different framework elements and/or applications. Core rules may establish fundamental constraints and/or behaviors to ensure interoperability between differing building blocks to cause predictable and/or reliable execution. They may ensure that differing building blocks may be combined and executed in a manner compatible with the integrity of the software platform. Some examples of core rules may include definitions governing types of data that may be exchanged with a building block, which building block may host and/or be hosted by other building blocks (e.g., a board may host an item but an item cannot host a board), how a hosted building block may execute (e.g., in an automation building block an action cannot precede a trigger), one or more required fields (e.g., each item must be associated with an identifier), validation and/or error-handling rules, and/or behaviors that are intrinsic to the software platform (e.g., an archived item cannot trigger an automation).

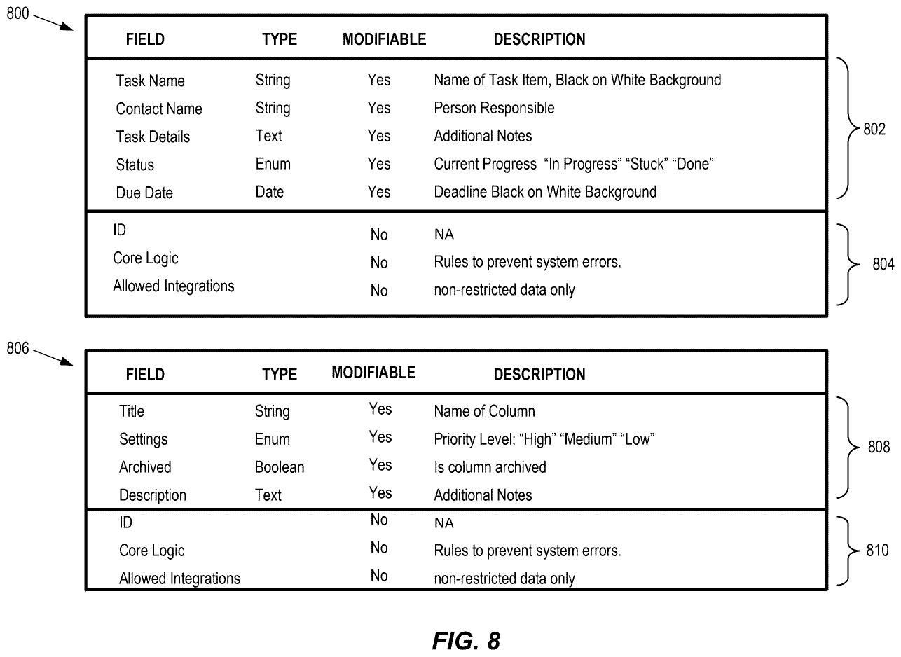

By way of a non-limiting example, reference is made to FIG. 8, which illustrates exemplary schema 800 and 806 associated with modifiable software platform 700 of FIG. 7, consistent with some disclosed embodiments. Schema 800 may be associated with board 702 and may include rules defining how a functionality of board 702 may be implemented. Schema 800 may have a modifiable schema portion 802 and a non-modifiable schema portion 804. For example, in modifiable schema portion 802, schema 800 may specify the types of data that each column may accept, e.g., Task column 712 storing a “Task Name” and Contact column 714 storing a “Contact Name” may only accept values of “string” data types (e.g., character sequences of limited length) formatted as black text on a white background. Task Details column 716 may accept values of “text” data type (e.g., text with no strict length restriction). Status column 718 storing a “Status” for each task may only accept values from an “enum” data structure (e.g., a predefined set of permitted options such as “In Progress,” “Done,” or “Stuck”). Due date column 720 may only accept values of “date” data type (e.g., month-day-year). In non-modifiable schema portion 804, schema 800 may specify an identifier for board 702, Core Logic, and Allowed Integrations.

Schema 806 may be associated with a priority column that may be added via Column widget 722 and may include rules defining how a functionality of the priority column may be implemented. Schema 806 may have a modifiable schema portion 808 and a non-modifiable schema portion 810. For instance, a modifiable portion 808 of schema 806 may specify a title for the priority column as a “string”, priority settings for each item of board 702 (e.g., “High”, “Medium”, “Low”), a Boolean value indicating if the column is archived, and a description for the priority column as “text”. A non-modifiable portion 810 of schema 806 may specify an identifier for the priority column, Core Logic, and Allowed Integrations (e.g., emails and text messages).

Similarly, software platform 700 may include schema with modifiable and non-modifiable portions for Financial Analytics widget 724, Email building block 726, Integrate Extension point 320 and Automation extension point 322), each associated schema including rules defining how a functionality of each respective framework element may be implemented.

In some embodiments, non-modifiable schema portion 804 may include core rule common to all of columns 712, 714, 716, 718, and 720, Add Column widget 722, Financial Analytics widget 724, Email building block 726, Integrate Extension point 320, and Automation extension point 322 framework elements. For instance, the ID attribute, in non-modifiable portion 804 of schema 800 for board 702 and in non-modifiable portion 810 of schema 806 for the added priority column may be immutable (non-modifiable). Similarly, non-modifiable portions of the schema for columns 712, 714, 716, 718, and 720, Add Column widget 722, Financial Analytics widget 724, Email building block 726, Integrate Extension point 320, and Automation extension point 322 may indicate a non-modifiable ID attribute.

Some disclosed embodiments involve receiving a first signal indicative of a request to link a particular building block with a particular one of the plurality of framework elements for implementation by the software platform for modifying the functionality thereof, the building block having a specific set of capabilities. Receiving (e.g., signals) refers to obtaining, acquiring, and/or otherwise gaining access to information over a distance. Receiving may be performed on a wired and/or wireless channel. Receiving may involve connecting to a network, detecting an incoming signal at a receiver (e.g., an input port and/or antenna), and/or formatting the signal for storage in memory as digital data. In some embodiments, receiving may include decrypting received data. A signal refers to a measurable quantity that conveys information over a distance via a physical medium. Examples of signals may include signals in the electromagnetic radiation spectrum (e.g., AM or FM radio, Wi-Fi, Bluetooth, radar, visible light, lidar, IR, Zigbee, Z-wave, and/or GPS signals), audio and/or ultrasonic signals, electrical signals (e.g., voltage, current, or electrical charge signals), electronic signals (e.g., as digital data), tactile signals (e.g., touch), and/or any other type of information encoded for transmission between two or more entities via a physical medium. A request refers to a notification, message, and/or signal indicative of an appeal and/or demand for one or more actions, service, and/or resource. A request may be initiated by a user, a software component, and/or an automated process. A request may be received from a user via in input device, and/or a process (e.g., an automation or an AI agent). The request may indicate a specific building block, a functionality associated with a particular building block (e.g., included in a natural language request). In some instances the request may indicate and/or may be associated with a different building block having capabilities related to or required for meeting a requested functionality. To link a building block having a specific set of capabilities may refer to combine, integrate, and/or incorporate a reusable piece of software having a particular collection of features, functions, and/or operations, as described elsewhere herein. For implementation by a software platform may refer to operationalization, execution, and/or application by the software platform, as described elsewhere herein. For modifying a functionality thereof may refer to changing (e.g., adding or removing), altering, adjusting, and/or transforming a behavior, operation, and/or capability. It may include adding, removing, and/or altering features and/or services provided by the software application. The modification may be associated with a backend of a software application (e.g., in association with a server), a frontend associated with a client device and/or user interface, and/or an external service and/or application. The modifications may include explicit requested modifications and/or implicitly requested modifications associated with explicitly requested modifications. For example, at least one processor may detect a signal (e.g., a drag-and-drop motion using an electronic mouse on an interactive display) indicative of a request to link a status column to a board to modify the functionality of the board by causing the board to display a status indication for each item (e.g., each row).

In some disclosed embodiments, at least one of the modifiable schema portion or the non-modifiable schema portion associated with each available framework element defines which building blocks are permitted for hosting. Defining refers to specifying, declaring, and/or outlining. Hosting refers to providing the environment, resources, or infrastructure for something to run or be stored, as described elsewhere herein. Hosting may enable incorporating, attaching, linking, integrating, and/or connecting a software component to a software ecosystem and/or collaborative environment. Defining which building blocks may be permitted for hosting may refer to specifying which building blocks may be linked and/or integrated via a particular framework element. By configuring schema portions to define which building blocks may be permitted for hosting, a software platform may maintain control over the types of extensions that may be made. This may ensure compatibility and prevent potential conflicts between differing system components. For example, a schema for a dashboard may permit hosting of a calendar widget but may deny hosting of a column. As another example, a schema for a status column may permit hosting of drop-down menu for a label set, but may deny hosting a formula. Framework elements may include building blocks and extension points. Each extension point may provide an environment (e.g., interfaces and/or resources) for hosting one or more building blocks, permitting hosted building blocks to operate within the software platform. Building blocks may include (e.g., expose) one or more extension points, permitting to interconnect differing building blocks, dependent on rules included in schema associated therewith.

In some disclosed embodiment, hosting the particular building block by the particular framework element defines a specific implementation for the particular framework element. A specific implementation for a framework element may refer to a particular way for realizing and/or executing the framework element, and/or putting a set of functionalities and/or features of the framework element into practice. A specific implementation for a framework element may include tailored configurations and/or processes for achieving desired outcomes and/or behaviors. A framework element may provide a structural template, a context, an execution environment, and/or configuration rules for implementing a building block hosted thereon such that changes to the hosting framework element may alter the implementation of the hosted building block. By way of example, a board may define a column type and definitions for interpreting column data for a column hosted thereon, and an automation may define one or more triggers for an action, when the action may execute, and/or what data the action may receive. As another example, a dashboard widget may define an implementation for a hosted data source, thereby shaping associated data according to the dashboard widget schema.

By way of a non-limiting example, in FIG. 7, at least one processor (e.g., processor 102 in FIG. 1) may receive a signal (e.g., via I/O 108) indicative of a request to link a priority column (a building block) to board 702 (a framework element) using Add column widget 722 for implementation by software platform 700 for modifying the functionality of board 702. The signal may be associated with an interaction of an electronic mouse with a GUI presented by software platform 700, and may indicate a selection of Add Column widget 722, and entry of “Priority” in an associated search bar.

In FIG. 8, at least one of modifiable schema portions 802 and 808 or non-modifiable schema portions 804 and 810 associated with board 702 and add column widget 722 may define which building blocks are permitted for hosting. For instance, Allowed Integrations in non-modifiable schema portion 804 may restrict board 702 from hosting Financial Analytics widget 724 for privacy, and permit board 702 to host Email building block 726.

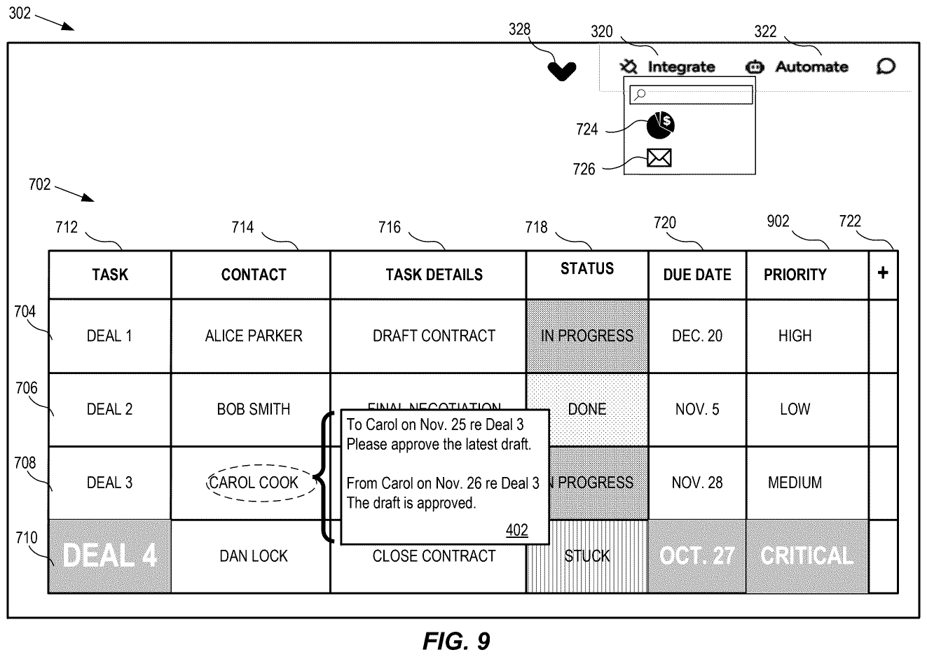

By way of a non-limiting example, reference is made to FIG. 9 illustrating exemplary modifiable software platform 700 following an alteration, consistent with some disclosed embodiments. In response to the request, at least one processor may present board 702 following the addition of a priority column 902, indicating a priority for each of items 704-710 listed in board 702. Hosting priority column 902 by board 702 may define a specific implementation for board 702. Adding priority column 902 to board 702 may change one or more display properties of board 702, e.g., the font and color for the name and due date items in row 710 in the version of board 702 in FIG. 9 may be different than the font and color for the corresponding name and due date items in row 710 in the version of board 702 in FIG. 7.

Some disclosed embodiments involve analyzing the modifiable schema portions and the non-modifiable schema portions of the particular building block and the particular framework element to determine compatibility requirements for linking the particular building block with the particular framework element. Analyzing modifiable schema portions and the non-modifiable schema portions of the particular building block and the particular framework element may include examining, investigating, organizing, and/or interpreting associated data to extract insights, identify patterns, and/or support decision-making. Analyzing may additionally or alternatively involve determining and/or applying mathematical or statistical algorithms and/or correlations between data sets, identifying patterns and/or features (e.g., using artificial intelligence). It may include simulating, testing and/or comparing portions of the two schemas to identify inconsistencies (e.g., by invoking one or more APIs or AI agents). To determine refers to arriving at an outcome. It may include, for example, undertaking an equality comparison to check whether two values are the same or are in a predetermined range. For example, the check may involve an equality operator like == in many languages (e.g., Python, JavaScript, C++). If the values are the same, the comparison evaluates to true; otherwise, it evaluates to false. Determining may additionally or alternatively include making a measurement, comparison, estimation, and/or calculation to arrive at a conclusive outcome. Compatibility requirements refer to a set of technical and/or functional conditions that must be satisfied for a building block and a framework element to be successfully linked within a software platform. These requirements may encompass both modifiable and non-modifiable schema portions of the involved components, ensuring that any customization or integration respects the essential integrity and stability of the platform. Compatibility requirements may include adherence to data formats, communication protocols, and operational dependencies, and/or prevention of changes to non-modifiable portions safeguarding core functionalities and/or critical system structures. To determine compatibility requirements, at least one processor may analyze the structural and behavioral attributes of the building block and the hosting framework element. The analysis may identify potential conflicts, dependencies, and/or necessary adaptations or constraints. For example, if rules in the non-modifiable schema portions of either component indicate inconsistency, at least one processor may block linking the building block to the framework element to prevent an action that could compromise platform stability. Compatibility requirements may ensure a balance between extensibility and reliability, allowing for tailored customizations and seamless integrations while maintaining the core integrity of the software system to thereby support the evolution of a platform to enable new functionalities without risking disruption of fundamental capabilities.

Some examples of compatibility requirements may include confirming data format alignment for ensuring that data types and structures used by both the building block and the framework element are compatible, such as matching field types (e.g., string, integer, date) or ensuring that required fields are present and properly formatted; and ensuring API interface consistency, including naming conventions, parameter types, and required endpoints for data exchange. Some additional examples of compatibility requirements may include checks to confirm that dependencies (e.g., required services, triggers, or event handlers) are available and do not conflict between the linked components. For instance, that column-level automation triggers do not interfere with board level automation triggers. Some further examples of compatibility requirements may include enforcing resource allocation and permission controls to ensure that limits (e.g., memory or processing quotas) and permissions are compatible and do not introduce security or performance risks; applying event handling protocols for ensuring that event propagation and handling are compatible so that actions triggered in one component are correctly recognized and processed by other components; and checking schema integrity to verify that references between schema elements (e.g., linking a widget to a board) do not violate integrity rules.

In some disclosed embodiments, the compatibility requirements further include prevention of modifications to the non-modifiable schema portions associated with the particular framework element. Prevention of modifications to the non-modifiable schema portions associated with the particular framework element may refer to restricting and/or denying changes and/or adjustments to the non-modifiable schema portions. At least one processor may determine when changes are attempted to a non-modifiable schema portion and block implementation of the changes. In some disclosed embodiments, linking omits modifications to the non-modifiable schema portion associated with the particular framework element. Omitting modifications to non-modifiable schema portions may refer to bypassing, excluding, and/or prohibiting the modifications. For example, at least one processor may treat each board, column, widget, or automation as a building block having its own schema with modifiable and non-modifiable portions. When a user adds a new framework element (e.g., a new column type or a custom automation) to a board, at least one processor may evaluate the compatibility between the schema of the board with the schema of the new framework element to ensure that only the modifiable portions of each schema are adjusted, while the non-modifiable (e.g., core) portions remain unchanged to maintain platform integrity and stability. Preservation of non-modifiable schema portions may prevent modifications to core and/or protected sections of the schema, such as essential system rules, validation constraints, and/or critical data relationships that maintain platform integrity.

For example, when adding a new status column to a board, at least one processor may check that the data types, permissions, and event triggers between the new status column and the board are compatible. Customizations, e.g., for updating allowed values or configuring automation triggers, may be exclusively applied to the modifiable portions of the schema. If a conflict is detected in the non-modifiable portions, at least one processor may block the integration and/or trigger a resolution of the incompatibility (e.g., using an AI agent). This approach may permit customizing and/or extending the functionality while ensuring that critical rules and relationships are preserved. Consequently, the software platform may provide a variety of extension points (e.g., board-level, column-level, and widget-level extension points) for hosting new building blocks, to enable seamless integration of new features (e.g., third-party integrations, custom fields, or dashboards) without risking the stability or security of the underlying system.

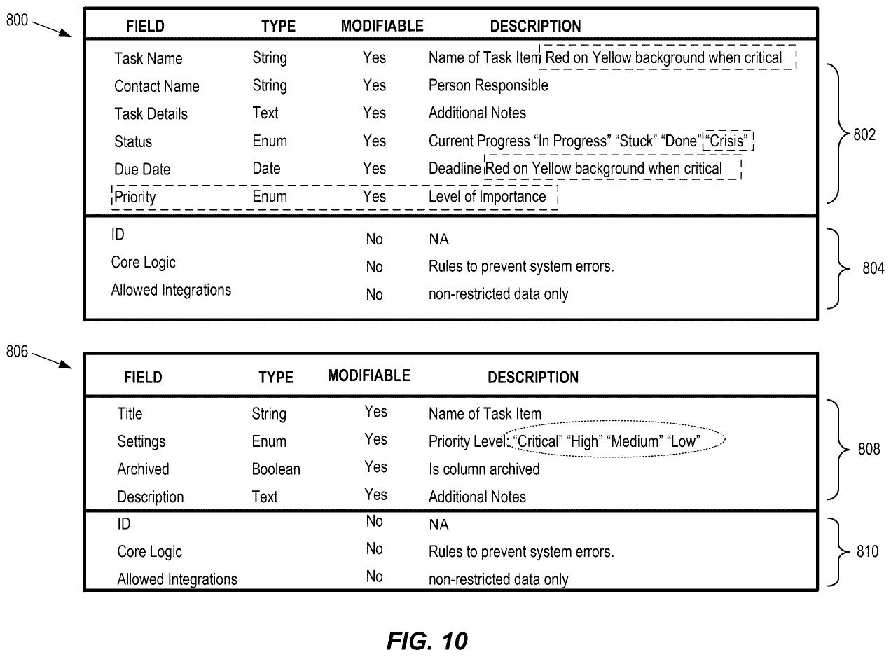

By way of a non-limiting example, in FIG. 8, at least one processor (e.g., processor 102 in FIG. 1) may analyze modifiable schema portion 808 and non-modifiable schema portion 810 of priority column 902 and modifiable schema portion 802 and non-modifiable schema portion 804 of board 702 to determine compatibility requirements for linking priority column 902 with the board 702. In some embodiments, the compatibility requirements may include prevention of modifications to non-modifiable schema portion 804 associated with board 702. For instance, at least one processor may prevent modifications to the Allowed Integrations attributed, thereby blocking integration of Financial Analytics widget 724 to board 702. When linking priority column 902 to board 702, at least one processor may omit making modifications to non-modifiable schema portion 804 associated with board 702. Thus, non-modifiable schema portion 804 in FIG. 8, prior to adding the priority column, is substantially similar to non-modifiable schema portion 804 in FIG. 10, following the addition of priority column 902 in FIG. 9.

In some disclosed embodiments, linking the particular building block to the particular framework element extends capabilities associated with the particular framework element. Extending capabilities associated with a framework element may refer to adding, enhancing, and/or expanding one or more functionalities, features, and/or operations of the framework element. Extending capabilities of a framework element by linking a building block may add one or more features beyond an original scope of the framework element. It may improve functionalities, and/or permit integration of the framework element with one or more tools and/or services to promote flexibility and scalability. For example, a status column may be linked to a board to enable users to visually monitor the progress of tasks. Similarly, adding a formula to a board may permit automated calculations on item data, such as summing time estimates and/or calculating deadlines. Linking an automation to a board or item may introduce new workflow capabilities, such as sending notifications when a status changes or automatically moving items between groups based on certain triggers.

In some disclosed embodiments, extending the capabilities associated with the particular framework element includes overriding at least one attribute associated with the modifiable schema portion associated with the particular framework element. Overriding refers to replacing, overruling, and/or superseding. It may include cancelling an existing property and replacing the cancelled property with a new property. An attribute refers to a property, trait, and/or setting. An attribute may include a method, a functionality, an implementation, a value, and/or any other information associated with a framework element. Overriding an attribute associated with a modifiable schema portion may permit customization and/or specialization of a behavior of a framework element while maintaining a structure and/or interface that is compatible with the software platform. It may enable fine-tuned customization of a framework element, providing user with flexibility to adapt specific aspects to meet particular requirements and/or use cases. For example, overriding a modifiable attribute may include changing a default status from “Working on it” to “Stuck,” or change a default date format from “MM/DD/YYYY to DD/MM/YYYY. As another example, overriding a modifiable attribute may condition a trigger on a specific label, instead of for any status change. At least one processor may override values in a dropdown column to tailor the selection options to a specific workflow, and/or customize a formula to perform a bespoke calculation (e.g., calculating business days instead of total days between two dates).

In some disclosed embodiments, extending the capabilities associated with the particular framework element includes customizing at least one attribute associated with the modifiable schema portion associated with the particular framework element. Customizing refers to modifying and/or tailoring a trait, feature, and/or attribute to meet one or more specific needs, preferences, and/or requirements. Customization may include adjusting and/or altering one or more parameters, behaviors, or adding and/or removing one or more functionalities. Customizing attributes in a modifiable schema portion may allow to introduce nuanced adjustments to a framework elements, permitting a user to fine-tune one or more specific aspects of a framework element without completely replacing an existing functionality. For example, at least one processor may customize an attribute of a modifiable schema portion by adjusting an allowed value in a dropdown column, e.g., by adding “Urgent” or “Backlog” to the default options (e.g., “Low,” “Medium,” and “High”) in a “Priority” dropdown column.

In some disclosed embodiments, extending the capabilities associated with the particular framework element includes redefining which building blocks are permitted for hosting. Redefining refers changing, revising, and/or updating a definition, scope, and/or permission. Redefining which building blocks are permitted for hosting may include modifying an existing criteria and/or establishing a new guideline governing which building blocks may serve as hosts for other building blocks. Redefining thus may enable a user to adjust the extensibility of framework elements based on evolving requirements and/or newly available framework elements. For example, a dashboard widget that previously only allowed hosting of visual display components may be redefined to permit hosting of automation triggers and/or integrations. As another example, a file column may be redefined to permit hosting of embedded documents and/or approval workflows in addition to files, to introduce new collaborative features. Permissions for a group building block may be redefined to allow hosting of custom widgets, such as time trackers and/or feedback forms, which were originally denied. This may permit adaptation of the platform to meet evolving needs by unlocking new configurations and/or integrations for existing framework elements.

In some disclosed embodiments, linking the particular building block to the particular framework element reduces capabilities associated with the particular framework element. To reduce capabilities refers to limiting, restricting, or removing one or more functionalities, features, and/or abilities. Reducing capabilities may simplify an interface, improve performance, enhance security, permit differing levels permissions, and/or for any other reason. Allowing for reduction of capabilities by linking building blocks may provide a mechanism to generate specialized and/or streamlined versions of a framework element, for instance to improve performance, simplify a user interface, and/or tailoring functionalities for specific use cases. By way of example, linking a “Read-Only” column to a board may reduce the capabilities of the board by preventing users from editing data to simplify an interface and enhance data integrity. As another example, linking a “Restricted Access” building block to a dashboard widget may limit who may view and/or interact with a specific component to authorized entities. As a further example, linking a “Minimal View” widget to a group may remove advanced filtering and/or sorting features, focusing a user experience on essential information to reduce potential distractions or complexity.

By way of a non-limiting example, in FIG. 9, linking priority column 902 to board 702 may extend capabilities associated with board 702 by presenting the priorities for each of items 704-710 in board 702 in priority column 902. In some instances, at least one processor (e.g., processor 102 in FIG. 1) may determine the priorities for priority column 728 by analyzing content from an additional data source (e.g., emails accessed by linking email building block 726 to board 702). In some embodiments, extending the capabilities associated with board 702 may override at least one attribute associated with modifiable schema portion 802 associated with board 702. For instance, a display characteristic for the “Task Name” presented in column 712 and for the date presented in due date column 720 may be overridden from a default black-on-white display to red-on-yellow background for items associated with a “Critical” priority (e.g., item 710 in board 702). In some embodiments, extending the capabilities associated with board 702 may customize at least one attribute associated with modifiable schema portion 802 associated with board 702. For instance, at least one processor may adjust a size of board 702 included added priority column 902 to accommodate a fixed display by reducing column widths for one or more of columns 712, 714, 716, 718, or 720. In some embodiments, capabilities associated with board 702 may be extended to redefine which building blocks are permitted for hosting by board 702. For example, an administrator may redefine financial data as non-restricted, permitting board 702 to host Financial Analytics widget 724 to generate financial reports. In some disclosed embodiments, linking priority column 902 to board 702 may reduce capabilities associated with board 702. For example, priority column 902 may be associated a rule restricting editing attributes of items associated with a “Critical” status. Thus, attributes of items in rows 704, 706, and 708 (Deal 1, Deal 2, and Deal 3) may be editable, whereas attributes of item 710 (Deal 4) may not be editable.

Some disclosed embodiments involve when rules of the non-modifiable schema portions of the particular building block and the particular framework element indicate inconsistency with the compatibility requirements, preventing linkage of the particular building block with the particular framework element. Rules refers to directives, regulations, and/or precepts set and/or established in advance of their application to a particular use case. Rules may include one or more conditions, constraints, or guidelines that govern the behavior, operation, or interaction of software components within a system. Rules may specify requirements, limitations and/or protocols that must be followed to ensure proper functioning and compatibility between different elements of a software platform. Inconsistency with compatibility requirements may refer to a lack of agreement, harmony, and/or interoperability between two or more elements, concepts, and/or states. Inconsistency may include conflicts in data types, logic, and/or operational requirements, and/or any other criteria preventing reliable integration or functioning of components. It may indicate operational incompatibility between the particular building block and framework element, operational and/or structural constraints, policy and/or security constraints. The inconsistency may be evident from the definitions of the schema (e.g., at design time), at deployment time (e.g., based on associated configuration settings), and/or during runtime (e.g., through testing and/or simulating runtime conditions).

For example, rules defined in the non-modifiable portions of the schemas for a building block and a framework element may reveal conflicts, disagreements, and/or incompatibilities that prevent successful integration. At least one processor may determine inconsistency with compatibility requirements by comparing rules and constraints for the building block and the framework element against the determined compatibility requirements, and identifying areas where the rules and constraints cannot be reconciled without violating the non-modifiable aspects of their respective schemas. Preventing linkage refers to prohibiting, blocking, and/or disallowing the establishment of a connection or association between two or more components. Preventing linkage may involve implementing checks, validations, or safeguards, and/or stopping, halting, and/or interrupting an integration process. It may refer to the execution of one or more technical operations that block data and/or logical flows between the building block and the framework element. It may involve invoking a different process to trigger an alert, log an event, and/or initiate troubleshooting.

For example, a non-modifiable schema portion of a board may require that all columns use a specific data type (e.g., “string”). When a user attempts to link a status column of type “integer”, at least one processor may detect the inconsistency and prevent the linkage. As another example, a non-modifiable schema portion for a widget may require elevated permissions (e.g., to access sensitive user data). If a user attempts to add the widget to a dashboard having a non-modifiable schema that prohibits access to sensitive user data, at least one processor may prevent linking of the widget and the dashboard, to ensure that protected system rules remain unaltered.

By way of a non-limiting example, in FIG. 7, upon receiving a signal indicative of a request to link Financial Analytics widget 724 with board 702, when rules of non-modifiable schema portion of Financial Analytics widget 724 and non-modifiable schema portion 804 of board 702 indicate inconsistency with the compatibility requirements, at least one processor (e.g., processor 102) may prevent linkage of Financial Analytics widget 724 with board 702. For instance, upon receiving a signal indicative of a request to link Financial Analytics widget 724 to board 702, at least one processor may analyze the schema for Financial Analytics widget 724 and board 702, to determine compatibility requirements for linking Financial Analytics widget 724 to board 702. At least one processor may determine that integration of financial data is restricted, and prevent linkage of Financial Analytics widget 724 with board 702.

In some embodiments, preventing linkage may operate as a design-time guardrail for builders (e.g., a no-code tool implemented by at least one processor for automations). For example, if at least one processor attempts to link a building block associated with restricted data handling to a framework element configured for public exposure, at least one processor may determine a security mismatch, and/or that rules and/or policies associated with a non-modifiable schema portion may be violated. Consequently, at least one processor may block finalization of the linkage, optionally identifying which constraint was violated and which configuration changes would bring the linkage into compliance.

Some disclosed embodiments involve when the rules of the non-modifiable schema portions of the particular building block and the particular framework element indicate consistency with the compatibility requirements, determining if modifications to the modifiable schema portions of the particular building block or the particular framework element are required. To indicate consistency with compatibility requirements may refer to presenting and/or demonstrating an alignment and/or agreement with one or more the rules ensuring harmonious integration. At least one processor may compare the rules and constraints of the particular building block and the particular framework element against the compatibility requirements to confirm that integration is possible without violating the non-modifiable portions of their respective schemas. Determining if modifications are required may refer to evaluating and/or establishing if changes and/or adjustments are needed to ensure successful integration. At least one processor may make such a determination by analyzing the compatibility requirements, assessing the current state of the modifiable schema portions for the particular building block and the particular framework element, and identifying any gaps and/or discrepancies that need to be addressed to link the particular building block with the particular framework element. Some disclosed embodiments involve implementing the modifications to the modifiable schema portions when the modifications are required, and linking the particular building block to the particular framework element. Implementing modifications when the modifications are required may refer to putting into effect and/or applying changes and/or adjustments to the modifiable schema portions when the changes are necessary for successful integration of a building block with a framework element. It may include the execution of one or more instructions that establish, manage, or facilitate communication between the particular building block and the particular framework element, and/or with additional components of the software platform and/or external services and/or resources. The instructions may be embedded in code, triggered by user actions and/or automated processes (e.g., associated with an AI agent), and/or automatically executed by a processor, and they may serve to enable data exchange, service invocation, or resource access across networked environments. The modifications may alter, enhance, restrict, or reconfigure the operational behavior of the particular building block and/or the particular framework element. The modifications may enable new features, activate integrations, alter data and/or logical flows, and/or change interactions with additional associated framework elements. The modifications may cause changes to a backend operation of a software application (e.g., non-observable by a user) and/or front changes that may be directly sensed by a human user.

For example, at least one processor may identify data formats, operational rules, and/or API definitions that may require updates to accommodate a new linkage. At least one processor may then apply one or more changes exclusively within the modifiable schema portions, such as by updating data type definitions, adding and/or adjusting rules governing the behavior of framework elements, and/or reconfiguring operational parameters, such as resource allocations or event triggers. Importantly, at least one processor may avoid alterations to any non-modifiable (protected) schema portions, thereby safeguarding essential system constraints and relationships. By confining changes to the modifiable sections, the software platform may enable customizable and extensible integrations while maintaining the reliability and security of the underlying software framework.

For example, if a new building block requires a specific data format and/or additional automation rules, at least one processor may insert and/or adapt the specific data format and/or additional automation rules within the modifiable schema portions. This may involve adding new rules, modifying existing logic, and/or introducing new configuration parameters that tailor the behavior of the combination of the particular building and particular framework element to the intended functionality. The at least one processor may then establish a connection between the particular building block and the particular framework element, ensuring seamless operation within the platform's architecture. As another example, when integrating a custom priority column into a project board, at least one processor may add a new rule to the modifiable portion of the board schema to cause notifications to be triggered when a priority for a task changes to “High” extending the functionality of the board, while preserving the board's core structure. As a further example, a dashboard may have an initial rule for aggregating task completion times. Adding a time-tracking widget to the dashboard may cause at least one processor to modify the initial rule to account for the real-time tracking and reporting, enabling the dashboard to display updated time metrics as users log hours, without altering protected, non-modifiable schema segments.

By way of a non-limiting example, in FIGS. 8-9, when the rules of non-modifiable schema portions 804 and 810 for a new priority column and board 702, respectively, indicate consistency with the compatibility requirements, at least one processor (e.g., processor 102 in FIG. 1) may determine if modifications to modifiable schema portions 802 and 808 the new priority column or board 702, respectively, are required. For instance, at least one processor may determine that changes to modifiable schema portion 802 of board 702 need to include a new “priority” column and a new rule to change the display characteristics for the “Task Name” in column 712 and the due date column 720 when the priority for an item (e.g., item 710) is “critical”. Similarly, at least one processor may determine that an additional status “critical” should be added to modifiable schema portion 808 for priority column 902.

By way of a non-limiting example, reference is made to FIG. 10 illustrating exemplary schema 800 and 806 associated with modifiable software platform 700 following alteration of the functionality of board 702, consistent with some disclosed embodiments. At least one processor (e.g., processor 102 in FIG. 1) may implement the modifications to modifiable schema portions 802 and 808 for board 702 and priority column 902, respectively, when the modifications are required. In FIG. 9, at least one processor may link priority column 902 to board 702.

In some disclosed embodiments, the plurality of framework elements include at least one extension point and at least one additional building block exposing at least one additional extension point. An extension point may be understood as described elsewhere herein. An extension points may serve as a predefined hook and/or connection point for extending the capabilities of a software application. A building block exposing an extension point may refer to a building block presenting, revealing, and/or providing the extension point, as described elsewhere herein. By including extension points and building blocks within the available framework elements, a software platform may provide hierarchical and/or modular components that may be interconnected to permit customized extensibility. This may allow for complex and/or nested customizations to produce specialized and/or adaptable software solutions. For example, a dashboard widget may exposes extension points for integrating data sources, visualizations, and/or automation triggers, permitting a user to add widgets for displaying project metrics, timelines, charts, and/or embedded third-party apps and/or custom automations. As another example a column may expose extension points for custom field values, formulas, and/or integrations, permitting user to customize interactions between columns and automations, and/or integrate with external tools (e.g., email or Slack®). As a further example, an automation may expose extension points for custom triggers, actions, and/or conditions, enabling users to generate workflows that respond to specific events.

In some disclosed embodiments, the at least one extension point includes a core extension point having a modifiable core extension point schema portion and a non-modifiable core extension point schema portion. A core extension point refers to a fundamental and/or essential extension point that may provide basic or critical functionality for customization and/or extension. A core extension point may serve as a primary interface for integrating additional software components and/or features. It may be included in a minimalist set of components, that together span the fundamental functionalities of the software platform. By incorporating both modifiable and non-modifiable schema portions in core extension points, a software platform may maintain a balance between flexibility and stability, permitting customization of nonessential aspects while preserving critical functionalities and/or structures. A core extension point may provide a foundational integration interface and/or customizable area for a user to extend the functionality of a software platform. As an example, a board may include a column as a core extension point. Such a column may be customized and/or extended with new column types (e.g., Status, Formula, Dropdown, Date) while providing essential interfaces for adding automation triggers, calculations, and/or integrations to a board. As another example, an automation engine may exposes core extension points for custom triggers and actions, allowing users to define workflows in response to changes to board data and/or external events while preserving core board behavior and data integrity. As a further example, an integration API may include a core extension point for connection with third-party apps (e.g., Slack®, email, or calendar services) to permit interaction and data synchronization with boards and items, and thereby operate as a standardized hooks for expanding platform capabilities of the software platform.

In some disclosed embodiments, the particular building block is linked to the particular framework element within a hierarchy, and wherein the core extension point is at the highest level in the hierarchy. A hierarchy refers to an organization in which components may be arranged in levels and/or ranks, each level subordinate to a level above. A hierarchy may define relationships and/or dependencies between different framework elements. A highest level in a hierarchy refers to an uppermost and/or topmost level in the hierarchy such that any other level in the hierarch is below the highest level. A highest level in a hierarchy may have a scope encompassing all other levels in the hierarchy such that changes made to the highest level cascade to all the other levels in the hierarchy. Positioning a core extension point at the highest level of the hierarchy may establish a foundational structure for a software platform, and may ensure that critical functionalities and interfaces are consistently available throughout, while permitting specialized customizations at lower levels. For example, a board may serve as a core extension point at the highest level in a hierarchy. The board may thus serve as a foundational structure for adding and/or customizing columns, widgets, and/or automations, each of which may operate as an extension point for further integrations and/or enhancements. For instance, columns within a board (e.g., Status, Formula, or Dropdown) may be modifiable extension points that allow users to adapt the board to specific workflows, while the board may remain as a central hub for all items, views, and/or integrations. By positioning the board as the top-level extension point, a software platform may ensure that core functionalities such as item organization, workflow automation, and/or external integrations may be consistently accessed and extended throughout the platform.

By way of a non-limiting example, in FIG. 9, the plurality of framework elements may include board 702 (an extension point) and Email building block 726 (an additional building block) exposing an additional extension point (e.g., for linking an automation). Linking email building block 726 to board 702 may permit integration of data from an email client into board 702. Email building block 726 may expose an extension point for linking pop-up window 402 permitting users to read and write emails while viewing board 702. In some embodiments, board 702 may be a core extension point. In FIG. 8, modifiable schema portion 802 may be a modifiable core extension point schema portion, and non-modifiable extension point schema 804 may be a non-modifiable core extension point schema portion. In FIG. 9, priority column 902 may be linked to board 702 within a hierarchy, and board 702 may be at the highest level in the hierarchy. For instance, changes made to board 702 (e.g., changing the font or permissions) may be automatically implemented on priority column 902 which depends on board 702.

In some disclosed embodiments, the compatibility requirements include implementing an additional modification on the modifiable schema portion associated with at least one additional framework element of the plurality of framework elements. Additional modifications to a modifiable schema portion may refer to a supplementary changes, adjustments, and/or alterations made to the modifiable schema portion beyond one or more primary and/or initial changes. Such additional modifications may ensure compatibility and/or consistency, and/or improve performance across multiple interconnected framework elements (e.g., due to cascading effects and/or dependencies). Thus, changes made to one part of an application may propagate and/or be reflected in additional related and/or dependent framework elements. The process of determining and/or implementing additional modifications may be automated by at least one processor (e.g., by use of one or more AI agents). Compatibility requirements include implementing an additional modification on the modifiable schema portion associated with at least one additional framework element may refer to implementing one or more changes to the modifiable schema portion of one or more other framework elements to ensure consistency and integrity. Linking a building block to a framework element may require changes to higher level framework elements whose scope encompasses the building block and the framework element). For example, linking an automation to a widget linked to a column may require changes made to the board to ensure that the automation executes according to an expected execution flow. In some disclosed embodiments, linking the particular building block to the particular framework element includes implementing the additional modification. Implementing additional modifications may refer to performing and/or enacting the additional modifications. For example, linking the particular building block to the particular framework element may have a cascading effect on other associated framework elements. Such modifications may include, for example, updating allowed values in a dropdown column to accommodate new workflow categories introduced by the additional building block, adjusting one or more default settings (e.g., a default status and/or date format) to align with requirements of the additional framework element, and/or refining automation triggers or actions to incorporate functionalities of the additional framework element. Additionally or alternatively, one or more schema relationships and/or references may be updated to permit a correct interaction between the additional framework element and the particular building block, such as by linking new columns or widgets to board-level automations or permissions. In some cases, implementing additional modifications may include redefining which building blocks may host or be hosted by other building blocks, introducing new extension points (e.g., exposed from the additional framework element), or customizing attributes to fine-tune how the additional framework element behaves within the hierarchy. This may ensure that the particular building block and the additional framework element operate in a cohesive manner and that changes propagate effectively throughout, supporting both flexibility and stability as the platform evolves. For example, adding a natural language interface (e.g., a particular building block) to a column (e.g., a particular framework element) on a board (e.g., an additional framework element) may require modifying a modifiable schema portion of the board to enable integration with a third party Natural Language Model. Similarly, linking a calendar widget to a status column may require adding new rules and/or configuration parameters to the modifiable portion of a board schema for defining how the alarm widget may interact with the status column. Furthermore, integrating a new data structure to a first board may require changing the modifiable schema or a second board linked to the first board.

In some disclosed embodiments, the additional framework element is at a higher level in the hierarchy than the particular framework element when the particular framework element is other than a core extension point. A higher level in a hierarchy refers to a level having a status and/or rank above another level in the hierarchy. Implementing modifications on framework elements at higher levels in the hierarchy may ensure that changes propagate effectively throughout the system. Thus, changes made to lower hierarchical framework elements may propagate through the hierarchy requiring modifications to modifiable schema portions of higher hierarchical framework elements to maintain consistency and compatibility across the software platform, allowing for coordinated customizations that respect the hierarchical structure. For example, linking an automation to a calendar widget connected to a status column may require modifications to the modifiable schema portion of the status column. The status column may be at a higher level in the hierarchy than the calendar widget.

By way of a non-limiting example, in FIG. 9, at least one processor (e.g., processor 102 in FIG. 1), may receive a signal indicative of a request to link an automation building block hosted via automation extension point 322 (e.g., a particular building block) to email building block 726 (e.g., a particular framework element) linked to contact column 714 (an additional framework element) of board 702. Board 702 may be a core extension point at the highest level in the hierarchy. The compatibility requirements for linking automation 322 to email building block 726 may include implementing an additional modification on the modifiable schema portion associated with status column 718 and/or board 702. Linking automation 322 to the email building block 726 may include implementing the additional modifications. For instance, automation 322 may trigger email building block 726 to send an alert email when status column 718 indicates “Customer Crisis”. To ensure that automation 322 operates as expected, at least one processor may modify the modifiable schema portion of status column 718 (e.g., also shown in modifiable schema portion 802 of board in FIG. 10) to include a “Crisis” setting. Status column 718 may be at a higher level in the hierarchy than email building block 726 since email building block 726 is not a core extension point.

In some disclosed embodiments, the particular building block includes a core building block associated with a core building block schema including a modifiable core building block schema portion and a non-modifiable core building block schema portion, and wherein the core building block includes a core building block extension point. A core building block refers to a fundamental and/or essential component within a modular software platform for providing basic and/or critical functionality. Core building blocks may serve as primary units for constructing more complex features or applications, and may be included in a minimalist set of components, that together span the fundamental functionalities available of the software platform. For example, framework elements such as boards, columns, and/or widgets may be core building blocks because they establish a foundational structure upon which users may organize data, customize workflows, and build integrations. By linking core building blocks with core extension points, a software platform may enable generation of robust and extensible units that may be tailored to specific needs while maintaining overall platform compatibility and integrity. A core building block schema refers to a structured definition outlining the essential attributes, properties, and/or behaviors associated with a core building block (e.g., a board, column, or widget). Such a schema may include a modifiable portion allowing for customization to meet specific workflow needs, and a non-modifiable portion for preserving critical functionalities and ensuring platform integrity. A core building block schema may serves as a foundational blueprint for how such primary software components operate and interact within the modular software platform, enabling users to build, extend, and/or integrate complex features while maintaining compatibility and stability across the platform. A core building block extension point refers to an extension point associated with a core building block.

For example, board extension points for adding columns, widgets, or automations may be core extension points. A board may permit integration with new column types, embedding of dashboard widgets, or linking to automation triggers in response to item changes. Core extension points may additionally include column extension points, e.g., for adding custom field values, custom formulas, or integrations with external services (e.g., Slack®, email), and/or widget extension points for connecting to data sources, presenting visualizations, and/or providing automation hooks. For example, a widget may permit display of additional metrics, embed third-party analytics, and/or trigger actions based on user interactions. Some additional examples of core extension points may include automation extension points for adding custom triggers, actions, and/or conditions, permitting users and/or an AI agent to define workflows that activate on specific status changes, item creations, and/or external events, allowing for highly tailored automation. Some further examples of core extension points may include integration APIs for connecting with external applications, such as calendar services, messaging platforms, or external databases, standardizing how third-party apps interact with boards, items, or workflows, and enabling data synchronization and platform expansion.

In some disclosed embodiments, linking the particular building block to the particular framework element including linking the core building block to the core extension point to form a combined unit. Linking a core building block to a core extension point may be understood as described elsewhere herein. For example, a board may serve as a core building block with a core schema and a core extension point. To form a combined unit refers to producing an integrated outcome formed by linking a core building block (such as a column or widget) to a core extension point (such as a board or dashboard) within a modular software platform. The combined unit may incorporate both components into a unified structure, allowing the components to function together while maintaining their individual schema requirements. Such a unified structure may enable new capabilities and/or customizations, such as allowing a status column to work seamlessly with a board for workflow tracking, while ensuring that both the board's foundational features and the column's configurable elements are preserved and compatible within the platform's architecture. A combined unit may be governed by a combined schema, which may merge the modifiable and non-modifiable schema portions of both the building block and the extension point. This schema integration may ensure that customizations are applied only where permitted, while critical system rules and relationships remain protected, supporting both extensibility and platform integrity. For example, linking a status column to a board, may form a combined unit that allows visual tracking of the progress of tasks through various stages (e.g., “To Do,” “In Progress,” and “Done”). The board may maintain a foundational role in organizing items, while the status column may introduce new capabilities for workflow tracking and automation, all within a unified and extensible structure. The combined unit may be further customized by overriding default status values and/or adding automation rules.

In some disclosed embodiments, the combined unit has a combined schema conforming to the modifiable core extension point schema portion, the non-modifiable core extension point schema portion, the modifiable core building block schema portion, and the non-modifiable core building block schema portion. A combined schema refers to a unified and/or integrated schema that incorporates elements, rules, or structures from multiple source schemas. A combined schema may define an overall structure, behavior, and constraints of a combined unit. It may resolve any inconsistencies between the modifiable and non-modifiable core extension point schema portions and modifiable and non-modifiable core building block schemas. For instance, linking a status column to a board may produce a combined unit conforming to both the board's and the column's schema requirements, allowing for custom automations to trigger notifications based on status changes, while preserving the essential data organization features of the board. As another example, adding a file column to a board may form a combined unit, redefining the file column functionality to additionally include hosting of embedded documents and/or approval workflows. This may expand the capabilities of a default file column beyond merely storing files, permitting integration of third-party document viewers and/or building of custom approval processes via automation and integration building blocks, while ensuring that critical board functionalities remain stable and unaltered. As a further example, a time-tracking widget may be added to a dashboard to form a combined unit, exposing extension points for further customization, e.g., permitting addition of custom filters and/or connection to external tools such as Slack® for real-time notifications, while preserving the dashboard's core structure and data visualization capabilities. As another example, an automated process (e.g., send an email when a status changes) may be added to a board to form a combined unit while ensuring the board's underlying workflow logic and data integrity remain intact.

In some disclosed embodiments, linking the core building block with the core extension point includes generating connectivity instructions for the combined unit based on the combined schema. Generating connectivity instructions may be understood as described elsewhere herein. For example, at least one processor may synthesize the requirements and/or constraints defined in the combined schema of the core building block and the core extension point, and/or analyze the combined schema to identify necessary data flows, interaction protocols, and/or operational dependencies between the linked components. Based on the analysis, the at least one processor may generate a set of connectivity instructions that specify how the building block and the framework element may communicate, exchange data, and/or function together as a unified entity. The connectivity instructions may include mappings between input and output fields, definitions of event triggers and responses, and specifications for permitted customizations that respect non-modifiable constraints. For instance, the instructions may outline how user actions on a status column may trigger automation rules on a board, or how data updates in a widget may be reflected in a core structure of a dashboard. By basing connectivity instructions in the combined schema, at least one processor may ensure that all interactions within the combined unit are compatible, stable, and extensible, and preserve the integrity of essential system functionalities.

By way of a non-limiting example, in FIGS. 8-10, priority column 902 may be a core building block associated with a core building block schema 806 including a modifiable core building block schema portion 808 and a non-modifiable core building block schema portion 810. Priority column 902 may include a core extension point (e.g., for connecting additional widgets and/or automations). Linking priority column 902 to board 702 may form a combined unit. In some embodiments, the combined unit has a combined schema conforming to modifiable schema portions 802 and 808 and non-modifiable schema portions 804 and 810 of board 702 and priority column 902, respectively. In some embodiments, linking priority column 902 with board 702 includes generating connectivity instructions for the combined unit based on the combined schema 800 and 806. In some embodiments, at least one processor may store connectivity instructions in a structured descriptor (e.g., a manifest or blueprint file) used to package, deploy, and/or reproduce the assembled configuration of building blocks and extension points.

In some disclosed embodiments, implementing the modifications to the modifiable schema portions includes adding at least one rule to the modifiable schema portions. Adding a rule to the modifiable schema portions may refer to inserting, introducing, and/or appending a rule to the modifiable schema portions. Adding a rule may include comparing, testing and/or simulating to identify one or more rules for adding, accessing the modifiable schema portions, and inserting one or more rules in modifiable portions thereof. For example, when a user adds an “Approval Status” column to a board, at least one processor may check that the non-modifiable schema portions of the board are consistent and do not conflict with the non-modifiable schema portions of the “Approval Status” column, e.g., by verifying that the board's core data types and/or protected permission rules are respected. Upon confirming the rules are obeyed, at least one processor may determine that the “Approval Status” column requires specific automation rules, such as to automatically notify a manager when a status changes to “Approved.” The at least one processor may apply the new rules only to the modifiable schema portions of the board, ensuring that core, non-modifiable rules (such as system-enforced data integrity constraints) remain unchanged.

In some disclosed embodiments, implementing modifications to the modifiable schema portions includes adapting at least one rule of the modifiable schema portions in accordance with a functionality of the particular building block. Adapting a rule refers to modifying, adjusting, and/or tailoring the rule (as described elsewhere herein). Adapting a rule may include comparing, testing and/or simulating to identify one or more rules for that need to be adapted, accessing the modifiable schema portions, and editing one or more rules in modifiable portions thereof. It may include adding, changing, and/or removing one or more conditions and/or constraints for applying the rule, checking the that the adaptations are consistent with additional rules, for instance, rules of non-modifiable schema portions, and/or testing the adapted rule. Adapting a rule of a modifiable schema portion in accordance with a functionality of a building block may include identifying the functionality, and adjusting the rule to enable implementation of the identified functionality. For example, when a user adds a “Status” column to a board for notifying a manager when a status changes to “Approved,” at least one processor may adapt one or more automation rules of the board's modifiable schema to trigger the notification when the value in the “Status” column changes to “Approved.” To implement the adaptation, at least one processor may modify existing logic and/or rules in the modifiable schema portion of the board to support the new behavior introduced by the “Approval Status” column, while ensuring that non-modifiable core schema rules (e.g., system-enforced data integrity and/or security constraints) remain unchanged. At least one processor may apply such changes only within permissible, modifiable schema portions to enable the new functionality without compromising the integrity or stability of the underlying software platform.

In some disclosed embodiments, implementing modifications to the modifiable schema portions includes implementing a corresponding modification to modifiable schema portions of another framework element to ensure consistency there between. Implementing a corresponding modification to modifiable schema portions of another framework element to ensure consistency therebetween may refer to applying a similar and/or correlated change to modifiable schema portions of a different framework element to maintain agreement between the schemas for the particular framework element, the particular building block, and the different framework element. For example, when integrating a custom automation widget with a dashboard extension point, the automation widget may introduce new notification triggers based on user activity. This may require at least one processor to update the modifiable schema portion of an existing “User Activity Log” to recognize and log events generated by the widget, and ensure that the widget and the activity log remain synchronized such that triggered notifications are reliably recorded within a workflow. As another example, to add a custom “Risk Assessment” column to a board via a column-level extension point, at least one processor may update the modifiable schema portion of a related “Task Prioritization” building block on the board to incorporate the new risk scores into the prioritization logic. The adaptation may permit the prioritization mechanism to account for risks when determining task order, thereby maintaining consistency while enhancing the board's functionality.

In some disclosed embodiments, implementing the modifications in the modifiable schema portions includes implementing additional modifications on additional framework elements dependent on the particular framework element. Modifications refer to alterations, changes, and/or adjustments. Modifications may involve additions, deletions, and/or edits to an electronic file, and may be associated with a particular version. Implementing additional modifications on additional framework elements dependent on the particular framework element may refer to applying a similar and/or correlated change to modifiable schema portions of a different framework element related to, and/or contingent upon the particular framework element. For instance, the additional framework element may send, receive, and/or share data with the particular framework element and/or building block, and/or share any other type of association. For example, when integrating a custom “Risk Assessment” column (a building block) into a first board using a column-level extension point, at least one processor may determine that a “Task Prioritization” column (another building block) included in a second board, linked to the first board, is dependent on the Risk Assessment” column. To permit the integration of the “Risk Assessment” column in the first board, at least one processor may update the modifiable schema portion of the “Task Prioritization” column of the second board, e.g., to incorporate risk scores from the new “Risk Assessment” column into the prioritization logic of the “Task Prioritization” column. This may ensure that task order reflects both priority and risk, maintaining consistency and enhancing the overall workflow on both boards.

By way of a non-limiting example, in FIGS. 9-10, at least one processor (e.g., processor 102 in FIG. 1) may implement the modifications to modifiable schema portions 802 and 808 by adding at least one rule to the modifiable schema portions 802 and 808. For instance, at least one processor may add a rule to highlight the “Task Name” and due date in columns 712 and 720, respectively when the priority in priority column 902 for item 710 is indicated as “critical.” In some embodiments, at least one processor may implement modifications to modifiable schema portions 802 and 808 by adapting at least one rule of the modifiable schema portions 802 and 808 in accordance with a functionality of priority column 902 (e.g., causing data items associated with a “critical” priority level to be displayed in highlight may accord with a functionality of priority column 902). In some embodiments, implementing modifications to modifiable schema portions 802 and 808 may include implementing a corresponding modification to modifiable schema portions of another framework element (e.g., due date column 720) to ensure consistency there between. For instance, display characteristics may be modified in a modifiable schema portion for due date column 720 to maintain consistency with schema 802 and 808. In some disclosed embodiments, at least one processor may implement additional modifications on popup window 402 dependent on board 702, e.g., to ensure a consistent display font.

By way of another non-limiting example, a user may link Automation extension point 322 (a building block) to status column 718 (a framework element) for implementing an escalation workflow on board. In response, the at least one processor may add a rule to a modifiable schema portion of status column 718 (e.g., within the modifiable schema portion associated with the board) specifying that when a status value changes to “Escalate,” an escalation event is generated and an associated action is triggered. The at least one processor may also adapt an existing rule in the modifiable schema portion (e.g., a notification rule) to condition execution on an additional criterion, such as a due date being within a threshold time window, to implement the requested functionality in accordance with the linked automation. Because Email building block 726 (and/or a related pop-up email window) may be dependent on board 702 and/or on the automation's output, the processor may further implement a corresponding modification to a modifiable schema portion of the dependent element—e.g., adding a field mapping that routes the “Escalate” event to a designated recipient group, thereby ensuring consistency between the status/automation configuration and the dependent email element. Importantly, core rules in non-modifiable schema portions remain unchanged—for example, immutable identifier attributes (e.g., board/column IDs) are not modified, and platform-wide core execution constraints (e.g., that an automation action does not precede its trigger) are preserved, thereby maintaining platform integrity.

In some embodiments, linking and configuring building blocks may be performed in a design-time environment (e.g., a studio, builder, and/or administrative configuration mode) used by developers, administrators, and/or other builders to assemble a software product before deployment or prior to end-user use. In such embodiments, at least one processor associated with the software platform may validate proposed linkages against applicable schemas as at least one processor assembles building blocks and extension points, thereby preventing incompatible architectures from being finalized. In other embodiments, at least one processor may perform similar validations at deployment time and/or runtime.

At least one processor may evaluate modifications required for linking the particular building block to the particular framework element. For instance, such modifications may impact the non-modifiable schema portions.

Schema impacts may include proposed changes to a hosting framework element required for linking a building block thereto. Examples of schema impacts may include registering UI hooks/commands (e.g., adding a toolbar button), requesting permission scopes/credentials, specifying required inputs/outputs or event subscriptions, adding configuration fields/parameters, requesting permitted data flows/mappings, and/or requesting execution constraints. At least one processor may evaluate schema impacts against schema constraints (e.g., including non-modifiable/core rules) and may reject disallowed schema impacts, constrain disallowed schema impacts to a permitted subset, and/or apply only permitted schema impacts to modifiable portions when implementing the linkage between the building block and the framework element.

When rules in the non-modifiable schema portion indicate that a requested impact is not permitted (e.g., a prohibited permission scope or prohibited access to protected content), at least one processor may automatically constrain the requested impact to a permitted subset (e.g., by downgrading ‘Write Access’ to ‘Read-Only’) rather than rejecting the linking entirely. When permitted (or effectively constrained), at least one processor may implement schema impacts by modifying only the modifiable schema portion—such as by registering permitted UI hooks or adding configuration parameters—thereby enabling controlled evolution of the platform without compromising its integrity.

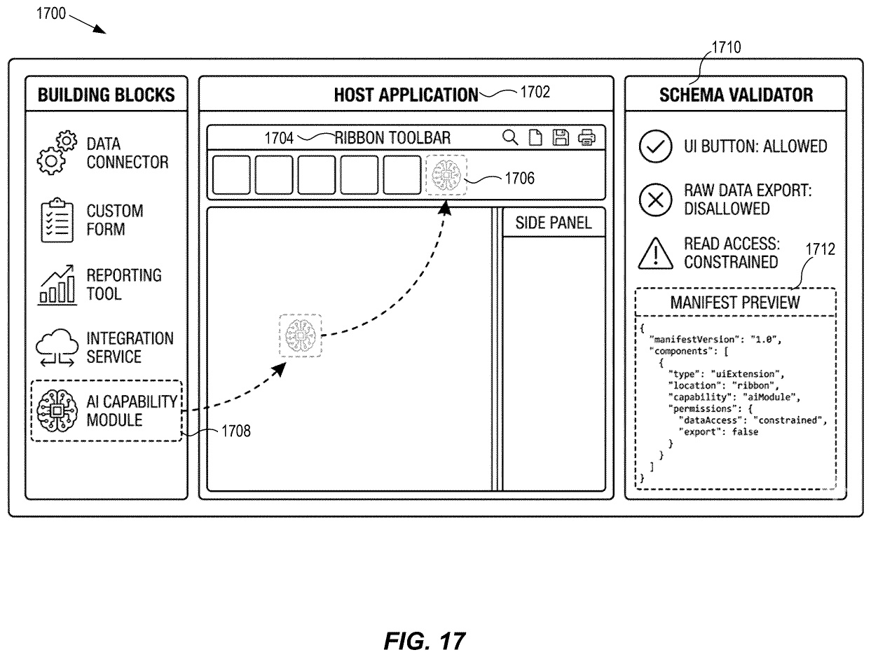

By way of another non-limiting example, reference is made to FIG. 17, which is a screen shot of an exemplary user interface 1700, for adding an AI capability to a framework element, consistent with embodiments of the present disclosure. User interface 1700 may include a host application 1702 presenting a ribbon toolbar 1704 with an extension point 1706 for hosting an AI capabilities building block 1708 of a plurality of available building blocks presented in a sidebar 1710. For instance, host application 1702 may be a text editor. A developer may interact with user interface 1700 to link AI capabilities building block 1708 with extension point 1706 in ribbon/toolbar region 1704 of host application 1702 to implement a “smart editor” integrating one or more artificial intelligence engines to enhance the editing capabilities of host application 1702. For instance, a developer may use an electronic mouse to drag AI capabilities building block 1708 to extension point 1706, which may trigger a signal indicative of a request to link AI capabilities building block 1708 with extension point 1706. Upon receiving the request, at least one processor (e.g., processor 102 in FIG. 1) may analyze associated modifiable and non-modifiable schema portions to determine whether the linking is permitted. At least one processor may assess one or more schema impacts associated with the linking. For instance, such schema impacts may be associated with registration of a new command (e.g., a “Summarize” button) with host application 1702, permitting access to selected document content, and/or with configuration of an approved model endpoint. At least one processor may analyze modifiable and non-modifiable schema portions associated with extension point 1706 and/or host application 1702 hosting AI capabilities building block 1708 to determine whether the requested schema impacts are permitted. If the linking is not permitted (e.g., linking violates a rule), at least one processor may prevent the linkage, or determine a context and/or conditions under which the linking may be permitted (e.g., for a reduced scope of the functionality), and what functionalities may be available to a user once a permitted version of the linking is implemented (e.g., redacted text, metadata-only, or an on-platform model). When permitted, at least one processor may implement the requested schema impacts by modifying only the modifiable schema portions of AI capabilities building block 1708, extension point 1706, and/or host application 1702 (e.g., command registration and configuration fields) and generating connectivity instructions consistent with the resulting modified schema. User interface 1700 may include a schema validator window 1710 presenting which functionalities are permitted via the linking and which functionalities are prohibited. At least one processor may generate a manifest 1712 for incorporating a reduced subset of the available functionalities of AI capabilities building block 1708 into host application 1702, to enable proceeding with the requested linking without violating any schema rules. At least one processor may present a preview of manifest 1712 in a schema validator window 1710 for review by a user.

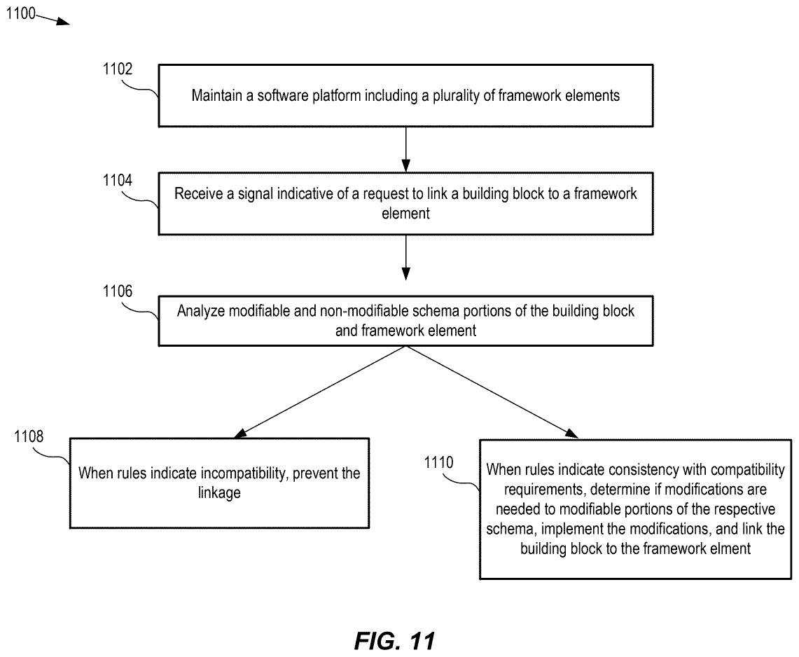

FIG. 11 is a flowchart of example process 1100 for altering a functionality of a software platform, consistent with embodiments of the present disclosure. In some embodiments, process 1100 may be performed by at least one processor (e.g., processor 102 in FIG. 1) to perform operations or functions described herein. In some embodiments, some aspects of process 1100 may be implemented as software (e.g., program codes or instructions) that are stored in a memory (e.g., memory 104) or a non-transitory computer readable medium. In some embodiments, some aspects of process 1100 may be implemented as hardware (e.g., a specific-purpose circuit). In some embodiments, process 1100 may be implemented as a combination of software and hardware.

Process 1100 may include a step 1102 of maintaining a software platform including a plurality of framework elements, each framework element being associated with a schema including rules defining how a functionality of the framework element is implemented, the schema having a modifiable schema portion and a non-modifiable schema portion. By way of a non-limiting example, in FIG. 7, at least one processor (e.g., processor 102 in FIG. 1) may maintain software platform 700 including a plurality of framework elements, e.g., board 702 with rows 704, 706, 708, and 710, columns 712, 714, 716, 718, and 720, an Add Column widget 722, a Financial Analytics widget 724, an Email building block 726, Integrate Extension point 320, and Automation extension point 322. In FIG. 8, board 702 may be associated with schema 800 including rules defining how a functionality of board 702 may be implemented. Schema 800 may have a modifiable schema portion 802 and a non-modifiable schema portion 804. Priority column 902 (see FIG. 9) may be associated with schema 806 and may include rules defining how a functionality of priority column 902 may be implemented. Schema 806 may have a modifiable schema portion 808 and a non-modifiable schema portion 810.

Process 1100 may include a step 1104 of receiving a first signal indicative of a request to link a particular building block with a particular one of the plurality of framework elements for implementation by the software platform for modifying a functionality thereof, the building block having a specific set of capabilities. By way of a non-limiting example, in FIG. 7, at least one processor (e.g., processor 102 in FIG. 1) may receive a signal (e.g., via I/O 108) indicative of a request to link priority column 902 (see FIG. 9) to board 702 using Add column widget 722 for implementation by software platform 700 for modifying the functionality of board 702. Priority column 902 may have specific capabilities, e.g., for triggering automations when a priority value changes.

Process 1100 may include a step 1106 of analyzing the modifiable schema portions and the non-modifiable schema portions of the particular building block and the particular framework element to determine compatibility requirements for linking the particular building block with the particular framework element. By way of a non-limiting example, in FIG. 8, at least one processor (e.g., processor 102 in FIG. 1) may analyze modifiable schema portion 808 and non-modifiable schema portion 810 of priority column 902 and modifiable schema portion 802 and non-modifiable schema portion 804 of board 702 to determine compatibility requirements for linking priority column 902 with the board 702.

Process 1100 may include a step 1108 of, when rules of the non-modifiable schema portions of the particular building block and the particular framework element indicate inconsistency with the compatibility requirements, preventing linkage of the particular building block with the particular framework element. By way of a non-limiting example, in FIG. 7, when rules of a non-modifiable schema portion of Financial Analytics widget 724 and non-modifiable schema portion 804 of board 702 indicate inconsistency with the compatibility requirements, at least one processor (e.g., processor 102) may prevent linkage of Financial Analytics widget 724 with board 702.

Process 1100 may include a step 1110 of, when the rules of the non-modifiable schema portions of the particular building block and the particular framework element indicate consistency with the compatibility requirements, determining if modifications to the modifiable schema portions of the particular building block or the particular framework element are required, implementing the modifications to the modifiable schema portions when the modifications are required, and linking the particular building block to the particular framework element. By way of a non-limiting example, in FIGS. 8-9, when the rules of non-modifiable schema portion 804 for a board 702 and non-modifiable schema portion 810 for the priority column indicate consistency with the compatibility requirements, at least one processor (e.g., processor 102 in FIG. 1) may determine if modifications to modifiable schema portions 802 and 808 the new priority column or board 702, respectively, are required. At least one processor may implement the modifications to modifiable schema portions 802 and 808 for board 702 and priority column 902, respectively, when required. In FIG. 9, at least one processor may link priority column 902 to board 702.

Some disclosed embodiments involve automated generation of a software application on a software platform. A software platform refers to an environment, foundation, and/or ecosystem for building, running, and/or managing software applications, as described elsewhere herein. A software platform may provide a framework upon which software applications may be built, deployed, or executed. A software platform may provide a set of tools, services, and/or resources that developers can use to create, manage, and distribute software applications more efficiently. Examples of software platforms may include operating systems, cloud computing environments, or specialized development frameworks. Automated generation refers to originating and/or producing something with minimal human intervention, for instance through the use of computer systems, algorithms, and/or other automated mechanisms. For example, automated generation may involve using predefined templates, rules, and/or artificial intelligence to construct software components, generate code, and/or assemble application elements without direct manual input from a human. A software application refers to a computer program and/or group of programs designed to perform one or more specific tasks and/or functions for end-users. Software applications may include, but are not limited to, mobile apps, web applications, desktop programs, or enterprise software solutions that address particular user needs or business requirements. A software application may be executed at a server device, a client device, and/or distributed between one or more servers and clients via a network. Automated generation of a software application on a software platform may refer to originating and/or producing a functional software application using automated tools and/or processes provided by and/or compatible with a specific software platform. This may involve leveraging capabilities of the software platform to automatically select, configure, and/or integrate differing software components and/or modules to fulfill desired application requirements with minimal human intervention.

Some disclosed embodiments involve receiving a request for a desired functionality for implementation by software application on a software platform. Receiving (e.g., signals) refers to obtaining, acquiring, and/or otherwise gaining access to information over a distance. Receiving may be performed on a wired and/or wireless channel. Receiving may involve connecting to a network, detecting an incoming signal at a receiver (e.g., a input port and/or antenna), and/or formatting the signal for storage in memory as digital data. In some embodiments, receiving may include decrypting received data. For example, receiving may involve capturing user input, accepting data transmissions, and/or detecting signals from sensors and/or other devices. A request refers to a formal or informal solicitation, inquiry, or appeal for something to be provided, performed, or implemented. A request may take various forms, such as a user input, an API call, and/or a system-generated signal indicating a need or desire for a particular action or resource. A desired functionality refers to a set of features, capabilities, and/or operations intended to be implemented or made available within a software application. Desired functionality may encompass user requirements, system specifications, and/or business objectives that the software application aims to fulfill. For example, desired functionalities may include accessing one or more data structures, integration with one or more internal and/or external software applications, and/or performing particular data processing procedures. A desired functionality may include explicitly expressed features (e.g., as a user request) and/or implicit features that may be needed to implement explicitly expressed features (e.g., communication, security, and/or authentication protocols). For implementation by software application on a software platform refers to realizing, executing, or bringing into effect a set of desired functionalities within a software application operating on or supported by a particular software platform. It may include installing, configuring, integrating, deploying and/or activating a software application and/or associated components on the software platform, so that the software application performs its intended functions for end users or systems. It may involve coding, configuring, and/or assembling differing software components, deploying executable code, setting up databases, configuring APIs, and/or ensuring compatibility with existing infrastructure of the software platform to produce a functional application that meets specified requirements within constraints and/or capabilities of the underlying platform.

In some embodiments, the request includes natural language text. Natural language text refers to typed, written, and/or spoken human language. Natural language text may include everyday words, phrases, and sentences that people use to communicate, and may include content in emails, chat messages, and/or spoken commands. Allowing requests to include natural language text may enhance user accessibility and flexibility by permitting users to describe a desired functionality using natural language rather than requiring specialized technical terms or formal specifications. At least one processor may parse and/or interpret a natural language input to extract meaningful information pertaining to the request. For example, in response to the request “Create an application that can track inventory and generate monthly sales reports” at least one processor may identify key requirements such as inventory tracking and report generation capabilities for inclusion in the software application.

In some embodiments, the request includes signals received via a Graphical User Interface (GUI). A signal refers to information encoded for transmission over a distance via a physical medium, as described elsewhere herein. A Graphical User Interface (GUI) refers to a visual mechanism for enabling human interactions with a computer or electronic device using graphical elements, such as icons, buttons, menus, and windows. A GUI may allow users to interact with electronic devices through visual indicators and/or graphical icons rather than text-based interfaces and/or command-line syntax, and may be implemented using a touch-sensitive display, and/or one or more input devices (e.g., an electronic mouse, a keyboard, and/or stylus). For instance, a GUI may present a series of drag-and-drop components, a dropdown menu, or may permit drawing connections between elements to indicate associations, and/or provide any other method allowing users to visually indicate a desired functionality for a software component.

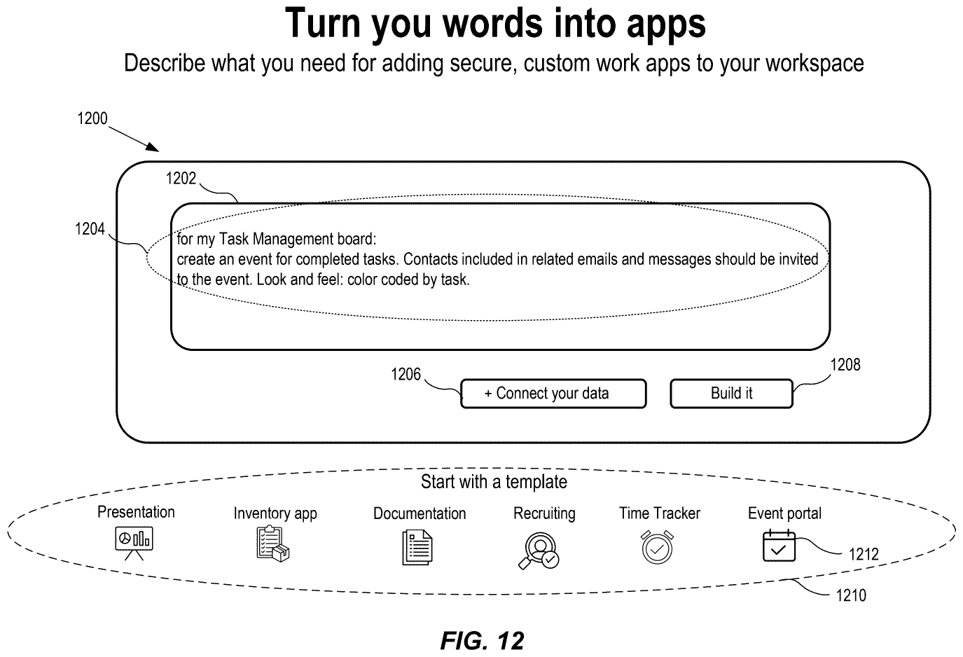

By way of a non-limiting example, reference is made to FIG. 12 illustrating an exemplary user-interface 1200 for automated generation of a software application on a software platform, consistent with disclosed embodiments. User-interface 1200 may include an input window 1202 for receiving a request 1204 for a desired functionality for implementation by a software application on a software platform (e.g., see platform 302 in FIG. 3). In some embodiments, request 1204 may include natural language text. For instance, request 1204 may recite “for my Task Management board: create an event for completed tasks. Contacts included in related emails and messages should be invited to the event. Look and feel: color coded by task.” In some embodiments, request 1204 may include signals received via a GUI. For instance, user-interface 1200 may include a connect button 1206 to link existing data into the application to be generated, a build button 1208 to generate the application, and one or more templates 1210 for simplifying and/or facilitating with phrasing request 1204. For example, selecting event portal 1212 from templates 1210 may cause at least one processor (e.g., processor 102 in FIG. 1) to insert default natural language text into input window 1202 for implementing a generic version of an event, permitting a user to edit the default text to generate a customized application based on event portal 1212 (e.g., the event should include contacts from emails associated with completed tasks). As another example, in response to receiving a signal indicative of a selection of board 300 of FIG. 3 (e.g., “Task Management board”) via a drop down menu associated with connect button 1206, at least one processor may automatically insert the text “for my Task Management board” into input window 1202, causing at least one processor to associate any subsequently request entered into input window 1202 with board 300.

In some embodiments, a user may access user-interface 1200 directly from platform 302 using a dedicated button 328 (see FIG. 3) and/or within board 300 via AI agent 324. In some embodiments, a user may access user-interface 1200 directly from board 300 to generate new views and/or tabs. Additionally or alternatively, a user may access user-interface 1200 from a menu presenting a plurality of available applications (e.g., Base44®), independent of a specific board permitting linkage of a newly generated application to a plurality of different boards.

In some disclosed embodiments, a software platform provides a plurality of available framework elements, each available framework element providing at least one available capability. Available refers to attainable, accessible, and/or usable. Something that is available may be capable of being used and/or applied for accomplishing a purpose. An available framework element refers to pre-existing, reusable software component, module, and/or building block provided by a software platform that may be utilized in the construction of software applications. An available framework element may be designed according to an interface and compatibility requirements of the software platform, and may adhere to standardized communication protocols and data formats. It may have undergone testing to validate its functionality, reliability, and integration with other framework elements. An available framework element may be associated with documentation describing its capabilities, interfaces, and/or configuration options needed for deployment and may be packaged and/or registered within a library and/or repository of the platform, to enable seamless selection, configuration, and/or integration by users or automated tools (e.g., plug-and-play). Such framework elements may include libraries, APIs, plugins, building blocks, extension points, widgets, dashboards, automations, integrations, data items and/or structures, and/or other modular components that offer specific functionalities or capabilities. An available capability refers to a function, feature, or service that a framework element can provide or perform within the context of a software application. Available capabilities may include data processing, user interface components, network communication, or any other discrete functionality that may be leveraged in application development.

Some examples of capabilities may include integration with external applications (e.g., emails, messages), linking to internal and/or external databases (e.g., additional boards hosted on the platform, train schedules, weather forecasts), and/or generation of reports, translation to additional languages and/or audio content. Some additional examples of capabilities may include integration of user authentication, automated alerts of important changes or deadlines, task assignment features, custom reporting tools, and collaboration modules such as chat or file sharing. Some further examples of capabilities may include visual analytics dashboards to track progress, calendar integration for scheduling, and workflow automation to streamline repetitive tasks.

A software platform providing a plurality of available framework elements refers to a software platform supporting, offering, and/or presenting differing pre-built components and/or modules that may be combined to generate one or more software applications. The components may be readily accessible and may be integrated to add specific features and/or functionalities to a software application. To permit seamless integration of different combinations of framework elements to deliver desired functionalities for a software application, a software platform may provide one or more tools, services, and/or resources (e.g., libraries, APIs, and/or plugins) to permit selecting, configuring, and/integrating various framework elements. Each available framework element providing at least one available capability may refer to differing framework elements having an ability, potential, and/or capacity to implement different functionalities and/or features. This may permit combining individual framework elements in a flexible and modular manner to achieve a desired functionality for a software application, with each framework element contributing distinct subsets of the desired functionalities.

In some disclosed embodiments, the plurality of available framework elements include building blocks, as defined elsewhere herein. For example, a software platform might offer building blocks for user authentication, database connectivity, API integration, and/or user interface components. To generate a new application, at least one processor may select one or more building blocks based on the requested functionality. For instance, in response to a request for an e-commerce application, at least one processor may select building blocks for product catalog management, shopping cart functionality, and/or payment processing. Building blocks may provide tested and/or optimized code components for inclusion in a software application in a modular and/or flexible manner.

In some embodiments, the plurality of available framework elements include extension points. An extension point may be understood as described elsewhere herein. A framework element including an extension point refers to a framework element (e.g., a building block) exposing and/or presenting an extension point, for connecting another framework element thereto. Inclusion of extension points in framework elements may enhance the flexibility and customizability of generated applications. The extension points may serve as hooks and/or interfaces for connecting additional framework elements, integrating custom logic and/or third-party services, and/or modify default behaviors to meet specific requirements that may not be fully addressed by the available framework elements. For example, framework elements for an e-commerce application may include extension points for integrating custom product recommendation algorithms, third-party payment gateways, and/or specialized inventory management systems. When generating an application, at least one processor may utilize these extension points to incorporate requested features that go beyond the standard capabilities of the platform. Extension points may permit versatility and/or adaptability when constructing as software application, permitting an application to evolve over time, accommodate changing needs and/or integrate with new technologies without requiring a complete rebuild, striking a balance between the efficiency of using pre-built components with flexibility for addressing custom needs.

By way of a non-limiting example, in FIGS. 3 and 12, software platform 302 may provide a plurality of available framework elements, such as board 300, email building block 314, messaging building block 316, and Smart Update building block 318, and templates 1210 including event portal 1212. These available framework elements may include building blocks (e.g., email building block 314, messaging building block 316, and Smart Update building block 318, and event portal 1212) and one or more extension points (e.g., board 300 and/or an add column widget 326).

Some disclosed embodiments involve processing a request to identify a plurality of desired capabilities for fulfilling the desired functionality. Processing a request refers to performing operations on a request and/or on associated data, to extract meaningful content from the request. For example, processing may include parsing text, identifying tokens, determining associations and/or patterns, querying data structures, applying algorithms, and/or executing computational tasks to derive insights and/or actionable information from the request. To identify refers to recognizing, determining, and/or distinguishing specific elements, features, or characteristics within a set of data or information. For example, identifying may involve pattern matching, classification, and/or selection of relevant components from a larger dataset. Desired capabilities refers to functions, features, and/or abilities that are required, preferred, and/or requested to achieve a particular goal or outcome. Desired capabilities may include, but are not limited to, software functionalities, hardware specifications, and/or system performance metrics necessary to fulfill user requirements or application objectives. A least one processor may analyze a request to determine capabilities needed to satisfy the requested functionality, such that including those capabilities in a software application fulfills the request. Some of the desired capabilities may be gleaned directly from the request (e.g., based on identifiable terms in the request) and some of the desired capabilities may be identified implicitly by association with the request. For instance, based on a request to produce a collaborative calendar, at least one processor may determine that a calendar capabilities is needed (e.g., explicitly stated in the request), as well as an authentication capability to ensure that only authorized users may collaborate on the shared calendar (e.g., implicit to collaborative environments). Fulfilling refers to meeting, satisfying, and/or meeting terms and/or conditions. A desired functionality refers to a required, preferred, and/or requested outcome, performance, and/or operation. Fulfilling a desired functionality refers to satisfying, meeting, and/or accomplishing a particular need, requirement, and/or objective associated with the desired functionality. Fulfilling a desired functionality may include providing components and/or resources for completing a task and/or achieving a desired outcome that meets requirements specified in the request.

By way of a non-limiting example, in FIG. 12, at least one processor (e.g., processor 102 in FIG. 1), may process request 1204 to identify a plurality of desired capabilities for fulfilling the desired functionality. For example, at least one processor may parse request 1204 “for my Task Management board: create an event for completed tasks. Contacts included in related emails and messages should be invited to the event. Look and feel: color coded by task.” into tokens (e.g., “Task Management board”, “create an event”, “completed tasks”, “contacts”, “related emails and messages”, and “invited to the event”) to identify desired capabilities for fulfilling the desired functionality (e.g., creating an event, accessing the Task Management board, identifying completed tasks, accessing email and messaging clients, identifying contacts in related emails and messages, inviting the identified contacts to the event).

Some disclosed embodiments involve generating a mapping between the available capabilities provided by the plurality of available framework elements to the desired capabilities identified for fulfilling the desired functionality. Generating refers to originating, producing, and/or bringing something new into existence. For example, generating may involve constructing data structures, producing and/or compiling instructions, and/or synthesizing content based on inputs and/or data stored in memory. A mapping refers to a set of relationships and/or correspondences between elements in two or more sets or domains. A mapping may include one or more associations, links, and/or transformations between different data structures, parameters, and/or functionalities. A mapping between available capabilities provided by a plurality of available framework elements to desired capabilities identified for fulfilling a desired functionality refers to a set of relationships, associations, and/or correspondences between the capabilities offered by existing framework elements within the software platform and the specific capabilities required to implement the requested functionality for the software application hosted by the software platform. Generating such a mapping may involve analyzing and/or comparing the available capabilities and the desired capabilities, and determining associations or links there between, to determine how existing framework elements may be utilized and/or combined to fulfill the desired functionality. Such a mapping may identify which framework elements to include in a software application such that the capabilities provided by those framework elements satisfy at least some of the desired functionality. In some embodiments, generating the mapping may include applying one or more rules and/or permissions, e.g., restricting which framework elements may be included and/or combined with other framework elements.

In some embodiments, generating the mapping between desired capabilities and available capabilities includes evaluating one or more capability descriptors associated with the available framework elements (e.g., metadata, schemas, interface definitions, documentation strings, tags, or a capability registry) against the desired capability set derived from the request. For example, the platform may generate the mapping using rule-based matching against a taxonomy/ontology of capability labels and synonyms (e.g., keyword and entity extraction with normalization), similarity-based matching using vector representations of the desired capability text and available capability descriptors (e.g., embedding similarity with configurable thresholds), or model-based classification (e.g., using an inference model to assign desired capabilities to one or more ontology classes and to select corresponding available capabilities), optionally constrained to permitted capability classes and schema rules. In some embodiments, at least one processor may determine a confidence score for candidate matches and apply one or more thresholds to accept or reject candidates; where multiple candidates satisfy a threshold, at least one processor may apply a tie-breaker or ranking policy based on factors such as schema compatibility, required permission scopes, data-type compatibility, dependency constraints, version compatibility, performance/latency, cost, and/or user or administrator preferences, thereby producing a ranked mapping used to select the subset of available framework elements for constructing the software application.

By way of another non-limiting example, a request may be associated with constructing a document-workspace application rather than a task board. For instance, a user or developer may submit a request such as: ‘Create a smart document editor that summarizes selected text, flags risky clauses, and routes the document for approval.’ Based on the request, at least one processor may identify desired capabilities such as text selection capture, document rendering, access control, versioning, annotations/comments, summarization, clause classification, and approval routing. Using the mapping between desired capabilities and available capabilities, at least one processor may select a subset of available framework elements including, for example, a document-rendering element, an authentication/permissions element, a version-control element, an annotation element, and a notification/approval-workflow element. If the mapping indicates that a desired capability (e.g., clause risk scoring for a particular jurisdiction) is unfulfillable by the selected available framework elements, at least one processor may generate a new framework element providing that capability and include the new framework element with the selected subset in a manifest used to assemble and deploy the resulting document-workspace application.

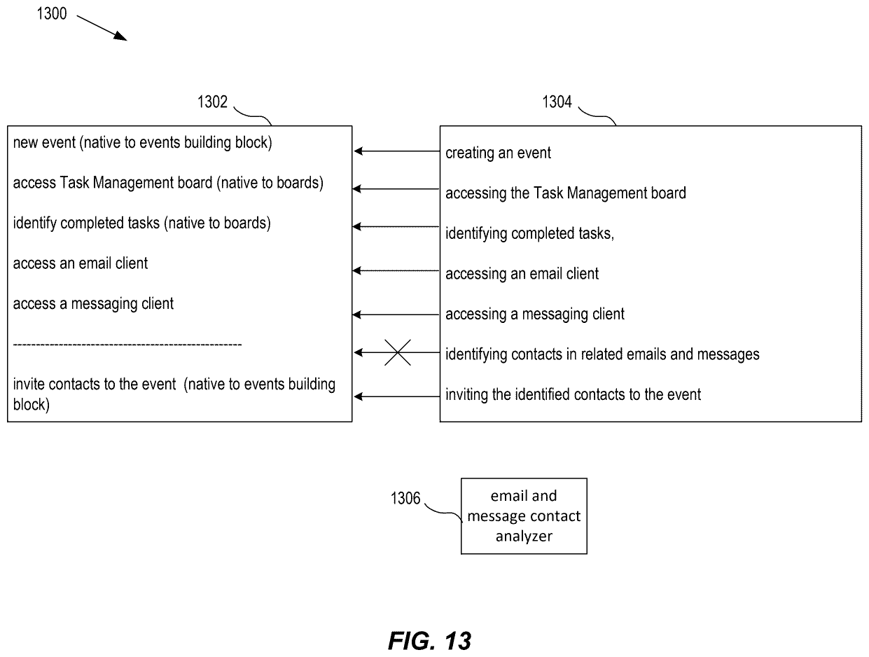

By way of a non-limiting example, reference is made to FIG. 13, illustrating an exemplary mapping 1300 between available capabilities to desired capabilities, consistent with some disclosed embodiments. For instance, at least one processor (e.g., processor 102 of FIG. 1) may include capabilities available on the software platform (e.g., platform 300 in FIG. 3) in a listing 1302, and may include the desired capabilities identified earlier in a listing 1304. At least one processor may generate mapping 1300 between available capabilities listing 1302 provided by the plurality of available framework elements to desired capabilities listing 1304 identified for fulfilling the desired functionality based on the processing of request 1204. For instance, at least one processor may map desired capabilities “create an event” and “invite contacts to the event” to capabilities native to event portal 1212, map “accessing the task management board” and “identifying completed tasks” to capabilities native to boards, and map “accessing an email client” and “accessing a messaging client” to capabilities native to email building block 314 and messaging building block 316 (see FIG. 3).

Some disclosed embodiments involve using the mapping to select a subset of the available framework elements for including in the software application, wherein each selected framework element included in the subset provides at least one available capability for fulfilling a portion of the desired functionality. Using refers to employing, utilizing, and/or applying something for a particular purpose or to achieve a specific outcome. For example, using may involve leveraging data, tools, or resources to perform a task or solve a problem. To select refers to choosing, picking, and/or identifying one or more items from a larger set based on specific criteria or requirements. Selecting may include evaluating options and/or making decisions about which elements may be more suitable for a given purpose. Selecting may additionally include filtering, testing, and/or simulating. A subset refers to a smaller group selected from a larger group. Elements included in a subset may share certain characteristics and/or fulfill specific requirements lacking from elements excluded from the subset. A subset of available frameworks for including in a software application may refer to a smaller group of the frameworks made available by the software platform for incorporating and/or integrating into the software application. Framework elements selected for inclusion in the subset may share one or more common characteristic, meet certain criteria, fulfill specific requirements, and/or possess particular attributes. At least one processor may select a framework element for inclusion in a subset based on the ability of the selected framework element to fulfill one or more requirements to provide the desired capabilities for the software application. Fulfilling a portion of the desired functionality refers to satisfying or meeting part of the overall requirements and/or capabilities requested for the software application. Each selected framework element may contribute to achieving the desired functionality by providing one or more specific features or services.

Each selected framework element included in the subset providing at least one available capability for fulfilling a portion of the desired functionality refers to each framework element in the subset contributing at least one capability needed to satisfy the desired functionality. At least one processor may use the mapping to determine which of the available framework elements to include in the software application to meet the requested functionality. The selection process may involve analyzing the mapping to identify which available framework elements provide capabilities aligning with the desired capabilities and/or may be permitted for inclusion in the software application. The at least one processor may analyze the completeness of the capabilities of the selected framework elements to assess if those capabilities cover the desired functionality, assess an efficiency for implementing the software application using the selected framework elements, and/or identify synergies between different selected framework elements, such that, when combined, the selected framework elements fulfill the entire desired functionality or at least a portion thereof. The at least one processor may leverage the mapping to identify and choose appropriate, permitted, and/or relevant framework elements for inclusion in the software application to ensure that each chosen framework element contributes meaningfully to the overall functionality of the software application. The at least one processor may ensure that framework elements that lack capabilities for achieving the desired functionality are excluded from the subset, e.g., to improve efficiency and streamlining of software applications, and/or reduce unnecessary complexity and potential conflicts between framework elements.

By way of a non-limiting example, in FIGS. 3 and 13, at least one processor (e.g., processor 102 of FIG. 1) may use mapping 1300 to select a subset including four of the available framework elements for including in the software application, e.g., board 300, email building block 314, and messaging building block 316, and event portal 1212. Each of board 300, email building block 314, and messaging building block 316, and event portal 1212 may provide at least one available capability for fulfilling a portion of the desired functionality. For instance, board 300 may provide capabilities to access contacts column 306 and status column 316, email building block 314, and messaging building block 316 may provide capabilities to access emails and messages, and event portal 1212 may provide capabilities for inviting contacts to an event.

Some disclosed embodiments involve identifying at least one of the desired capabilities that is unfulfillable by the available framework elements provided by the software platform. Identifying refers to recognizing, ascertaining, and/or discovering. Identifying may include recognizing, determining, and/or distinguishing specific elements, features, or characteristics within a set of data or information. For example, identifying may involve pattern matching, classification, or selection of relevant components from a larger dataset, determining a match (e.g., within a threshold) between two or more items, and/or associating an item with an (e.g., uniquely) identifying code and/or index. Unfulfillable refers to a condition or requirement that cannot be met, satisfied, and/or accomplished using currently available resources or methods. For example, an unfulfillable capability may be a functionality or feature that is not supported by existing framework elements and/or cannot be implemented within given constraints. At least one of the desired capabilities is unfulfillable by the available framework elements may refer to one or more functionalities and/or features requested for the software application that cannot be fully implemented or satisfied using only the available framework elements provided by the software platform. At least one processor may identify an unfulfillable capability by analyzing, pattern matching, classifying, and/or comparing the requested functionality against the capabilities natively supported within the platform to determine one or more gaps and/or limitations in the capabilities offered by the software platform. For instance, an unfulfillable capabilities may be associated with a service, a data structure, and/or a computation inconsistent with, unsupported by and/or non-native to the software platform. The software platform may lack a native framework element able to provide an unfulfillable capability.

Some disclosed embodiments involve generating a new framework element capable of providing the at least one of the desired capabilities that is unfulfillable by the available framework elements. Capable of providing refers to having an ability, capacity, and/or potential to deliver, implement, and/or make available a specific function, feature, or service. For example, a software component may be capable of providing data processing, user interface elements, or specialized algorithms to fulfill particular application requirements. Generating a new framework element refers to originating and/or producing a framework element that is different from the currently available framework elements on the software platform. The new framework element may extend and/or enhance the available capabilities of the software platform. A new framework element may be designed to integrate seamlessly with existing components while providing additional functionality or addressing specific requirements not met by the current system. At least one processor may generate a new framework element by generating and/or producing code, identifying and/or accessing resources (e.g., APIs, libraries) capable of satisfying at least some of the unfulfillable capabilities, calling one or more functions, integrating internal and/or external services, modifying one or more templates, testing the new framework element (e.g., in a sandbox), and/or performing any other task for generating a new framework element. A desired capability unfulfillable by the available framework elements refers to a required, preferred and/or requested capability that cannot be met and/or satisfied by any of the available framework elements. It may be associated with gap between the capabilities provided by the software platform versus the functionalities desired, requested and/or required by a user. Generating a new framework element capable of providing a desired capability unfulfillable by the available framework elements may include producing and/or outputting a custom software component that addresses one or more capability gaps identified in the existing platform.

At least one processor may analyze the unfulfilled capabilities, design a solution to meet the unfulfilled capabilities, and produce and/or retrieve code and/or resources for including in the new framework element, such that adding the new framework element to the software application provides at least some of the desired capabilities that were unfilled by the available framework elements. At least one processor may generate a new framework element, for example, by accessing one or more templates, APIs, libraries, and/or any other resource such that the new framework element provides at least some of the functionality missing from the available framework elements, while adhering to the platform architecture and design principles to ensure seamless integration and maintain overall system coherence. In some embodiments, at least one processor may store the new framework element in memory (e.g., a library) in association with one or more of an identifier, timestamp, version number, context (e.g., an identifier for the requested software application). In some embodiments, generating a new framework element may include generating a plurality of new framework elements, each new framework providing one or more requested capabilities that cannot be satisfied by the available framework elements.

For instance, at least one AI agent may design a solution tailored to address a specific gap in capabilities provided by a software platform. This may include selecting appropriate algorithms, defining data structures, and/or determining integration requirements. At least one AI agent may generate executable instructions, such as code, scripts, and/or configuration files that implement the unfulfilled capability. The at least one AI agent may employ inference operations (using trained models to predict or deduce behaviors) or learning operations (adjusting models based on new data) to enable the component to adapt or perform advanced tasks. The at least one AI agent may ensure that the new framework element aligns with the platform's schema, maintaining consistency in data formats, interfaces, and communication protocols to ensure seamless integration with existing components and support reliable data flow and interoperability. The at least one AI agent may test the new framework element in a controlled environment, validate its performance, and store it in a repository with relevant metadata for future use or updates.

In some disclosed embodiments, a new framework element may include an automation, a workflow, or an integration connector generated to operate in the background. For example, at least one processor may generate a new framework element including serverless code and/or configuration logic that executes in a sandbox environment to trigger actions based on platform events (e.g., ‘when a status changes, update an external database’). These generated workflow elements may be constructed to strictly adhere to platform schema constraints regarding execution time, API rate limits, and data access permissions, ensuring that AI-generated automations do not degrade platform stability.

Further, the new framework element may not be limited to standalone applications or backend logic but may include functional extensions to existing platform components. Non-limiting examples of such new framework elements may include a custom column type (e.g., a specific data visualization cell), an autonomous agent service configured to perform background tasks on behalf of a user, or a persistent user interface layer (e.g., a floating widget or ‘sticky note’) that remains visible while a user navigates between different views. At least one processor may generate such elements dynamically to fulfill a capability gap identified in the request.

In some embodiments, generating the new framework element includes generating executable instructions for implementing the at least one of the desired capabilities that is unfulfillable by the available framework elements. Executable instructions refers to a set of commands and/or code that may be directly executed, interpreted and/or otherwise implemented by at least one processor to perform specific tasks or operations. Executable instructions may include machine code, bytecode, and/or high-level programming language statements that define a behavior of a software component. Implementing refers to realizing, executing, and/or bringing into effect. Implementing the at least one of the desired capabilities that is unfulfillable by the available framework elements refers fulfilling, effectuating, and/or realizing one or more of the desired capabilities that the available framework elements were incapable of satisfying, and that represented gaps between the platform's current offerings versus the requested functionality. Generating executable instructions for implementing unfulfillable capabilities may include translating high-level requirements into functional code, generating corresponding data structures, algorithms, defining data and/or control flows, selecting programming paradigms, optimizing code for performance and/or resource utilization, and/or ensuring compatibility with the platform architecture and/or schema. For example, if the unfulfillable capability includes a data processing method not available in the existing framework elements, at least one processor may generate executable instructions for implementing the data processing method, handle input and output data flows, and/or integrate the method with the platform's data management systems, e.g., by defining new classes, custom data structures, and/or functions, and/or computations. Additionally or alternatively, the at least one processor may define error handling, resource management, and/or scalability to ensure the new capability operates effectively within the broader application context. By generating executable instructions for unfulfillable capabilities, at least one processor may extend the functionality of the platform beyond the original scope, enabling the development of diverse and/or specialized applications while maintaining overall system coherence.

In some embodiments, generating the executable instructions for implementing the at least one of the desired capabilities that is unfulfillable by the available framework elements includes performance of at least one of an inference operation or a learning operation. An inference operation refers to drawing conclusions and/or making predictions based on available data, patterns, and/or rules. An inference operation may use existing parameters for a trained model to produce an output. Inference may include applying learned patterns to new, and/or unseen inputs without modifying the model. Inference may be suitable for real-time responsiveness due to relatively light computational needs. A learning operation refers to adjusting internal parameters for a model based on data. Learning may include one or more of training, optimizing, and/or updating a model using example inputs and outputs, which may be known. Learning may improve a capability of a model to generalize from examples to unseen or unencountered situations. Learning may be suitable for offline computations due to heavy computational needs. Incorporating inference and/or learning operations to generate executable instructions for unfulfillable capabilities may permit at least one processor to generate customized and/or adaptable components to satisfy functionalities that may be non-native to the software platform. For example, at least one processor may use inference to deduce an intent behind a natural language query, and/or may use learning to improve accuracy in pattern recognition. Use of inference and/or learning may permit generation of framework elements that may be adaptable to changes in user behavior and/or systemic conditions of a software platform. For instance, a generated framework element for fraud detection may include learning operations to adjust the detection criteria based on new patterns of fraudulent activity.

By way of a non-limiting example, in FIG. 3, and 13, at least one processor (e.g., processor 102 of FIG. 1) may identify at least one of the desired capabilities (e.g., “identifying contacts in related emails and messages”) that is unfulfillable by available framework elements board 300, email building block 314, messaging building block 316, and Smart Update building block 318, and templates 1210 provided by software platform 302. At least one processor may generate a new framework element 1306 capable of providing the at least one of the desired capabilities (e.g., “identifying contacts in related emails and messages”) that is unfulfillable by the available framework elements. For instance, new framework element 1306 may cause at least one processor to analyze emails and messages associated with a particular task, identify any contacts addressed and/or mentioned in the associated emails and messages (e.g., in the “To:” “From:”, “cc:”, “bcc:” fields and/or payload content) and access a directory to retrieve contact information for the identified contacts. In some embodiments, at least one processor may generate the new framework element by generating executable instructions for implementing the desired capability that is unfulfillable by available framework elements board 300, email building block 314, messaging building block 316, and Smart Update building block 318, and templates 1210, e.g., by performing at least one of an inference operation or a learning operation.

Some disclosed embodiments involve constructing a manifest specifying the new framework element and the selected framework elements for including in the software application. A manifest refers to a document, file, and/or data structure that provides a listing or description of components, resources, or dependencies associated with a software application or system. For example, a manifest may include information about files, modules, configurations, or other elements necessary for the proper functioning of an application. Constructing refers to building or assembling something from various components or elements. For example, constructing may include combining different components, generating a structure, and/or formulating a document based on specific criteria or requirements. Specifying refers to stating, describing, and/or defining something in a clear and precise manner. Specifying may include detailing requirements, characteristics, or components of a system or process to ensure accurate implementation or understanding. For including in the software application may refer to incorporating or integrating into a structure and/or execution flow of a software program. This may involve adding code, configuring settings, or establishing connections between different parts of the software application to achieve the desired functionality. At least one processor may construct such a manifest by producing a comprehensive document and/or data structure that outlines components necessary for building the software application. The manifest may serve as a blueprint or recipe for assembling the application from differing framework elements, ensuring that all required elements are included, configured, and/or interconnected. The manifest may include information about framework elements selected from the available elements provided by the software platform and any newly generated framework elements created to fulfill capabilities unfulfilled by the selected framework elements. At least one processor may include in the manifest information about the selected framework elements, including identifiers, versions, dependencies, and/or any specific configuration parameters and/or additional metadata and/or documentation. The at least one processor may add to the manifest details about any newly generated framework element, such as identifiers, functionalities, dependencies, and/or integration requirements. In some instances, at least one processor may include in the manifest metadata about the software application, such as a name, version, and/or target platform. By specifying both the new framework element and the selected framework elements in the manifest, at least one processor may ensure that necessary components are accounted for during the application construction process. This comprehensive listing may facilitate in maintaining consistency and completeness in the application structure, facilitating easier deployment, maintenance, and potential future updates.

In some disclosed embodiments, a manifest may be constructed as a structured, machine-readable data object, such as a JavaScript Object Notation (JSON) file, an Extensible Markup Language (XML) file, or a YAML configuration file. Unlike a generic list or human-readable document, this structured manifest may function as a machine-executable blueprint that is strictly parsed by a platform compiler, a build engine, and/or a runtime orchestration service. The manifest may define a dependency graph where nodes represent the framework elements (both selected and newly generated) and edges represent the determined connectivity instructions. When processed by at least one processor (e.g., associated with a runtime engine), the manifest may cause the processor to instantiate specific object classes corresponding to the framework elements, allocate memory for shared data contexts, and configure event listeners according to the schema-compliant pathways defined therein. This data structure may thus physically configure the runtime environment to support the functional workflow of the software application, converting the abstract user request into a specific, executable machine configuration.

In some embodiments, at least one processor may store and/or manage a constructed manifest as a reusable template. This template-based management may permit duplication, versioning, and/or transferring of a software application between different workspaces or tenants of the software platform. For instance, when a user ‘clones’ a generated application, at least one processor may duplicate the manifest and re-instantiate the associated framework elements and connectivity instructions in a new context. Such a template may permit further bundling of pre-authorized connectors, schema definitions, and/or ownership metadata, allowing the transfer of application maintenance responsibilities between users or teams.

Additionally, in some embodiments, at least one processor may publish a manifest and/or the constructed software application to a centralized repository or marketplace accessible to other users of the software platform. The publication process may involve associating the manifest with distribution metadata, such as version numbers, compatibility requirements (e.g., required framework elements or permission scopes), and developer identity. This may permit a community of users to discover, install, and/or purchase AI-generated applications. At least one processor associated with the software platform may utilize the manifest to automatically provision the necessary resources and connections needed for installation.

Some disclosed embodiments involve determining connectivity instructions for interconnecting the new framework element with the selected framework elements in compliance with a schema of the software platform. Determining refers to arriving at an outcome. Determining may include establishing, deciding, or ascertaining something through reasoning, calculation, or investigation. For example, determining may involve analyzing data, applying algorithms, or making decisions based on predefined criteria or rules. It may include, for example, undertaking an equality comparison to check whether two values are the same or are in a predetermined range. Determining may additionally or alternatively include making a measurement, comparison, estimation, and/or calculation to arrive at a conclusive outcome. Connectivity instructions refers to a set of directives, rules, and/or specifications that define how different components or elements within a system may be connected and/or interact with each other. For example, connectivity instructions may include information about data flow, communication protocols, and/or interface requirements between software modules to ensure compatibility between connected elements. Connectivity instructions may include connectivity information as described elsewhere herein, indicating how data is to be exchanged, where data may be sent to, where data may be received from, and/or what types of operations may be supported by a framework element in a standardized manner. Connectivity instructions may include code and/or scripts readable and/or executable by at least one processor. Interconnecting refers to establishing connections and/or relationships between two or more components, elements, and/or systems. For example, interconnecting may include producing data pathways, defining communication interfaces, and/or establishing dependencies between software modules to enable them to work together as a cohesive unit. Compliance refers to conforming to or adhering to specific rules, standards, and/or requirements. For example, compliance may involve ensuring that software components meet certain architectural guidelines, follow specific coding practices, and/or adhere to predefined security protocols.

A schema refers to a blueprint, structure, and/or architecture as described elsewhere herein. A schema for a software platform may define an organized blueprint or structure that defines how various data elements, software components, and their relationships are arranged and/or managed within the platform. A schema may outline rules, standards, protocols, and/or permissions governing the interaction, integration, and communication between different parts of the platform. For instance, a schema may specify the types and formats of data that can be stored or exchanged, the allowable interactions between modules or framework elements, and the hierarchy or organization of resources within the platform. A schema for a software platform may ensure consistency, reliability, and compatibility across various platform components. The schema may serve as a guide for developers and/or automated processes, enabling seamless integration of new and/or existing framework elements, and facilitating proper data flow and functional workflows throughout the application. Adhering to the schema may be critical for maintaining system integrity, supporting scalability, and simplifying maintenance and future updates. Compliance with the schema of the software platform may ensure that interconnections between framework elements adhere to the predefined rules and structure of the platform. This compliance may maintain consistency, reliability, and compatibility across different parts of the application, ensuring that data flows correctly, interfaces are consistently defined, and components interact in expected and supported ways. At least one processor may determine the connectivity instructions by analyzing the requirements of the newly generated framework element and the existing selected framework elements to establish how they should interact within constraints defined by the schema of the software platform. Consequently, executing the connectivity instructions may integrate the new framework element and the selected framework elements into the software application in a manner consistent with the rules and/or guidelines for the software platform to maintain the overall integrity and functionality of the software application. By determining connectivity instructions compliant with the schema of the software platform, at least one processor may automate the construction and integration of new framework elements that introduce new capabilities previously unavailable on the platform, thereby removing the need for human writing of code or scripts.

In some embodiments, generating the new framework element includes causing the new framework element to comply with the schema of the software platform. Causing a new framework element to comply with a schema of a software platform refers to ensuring that a newly generated framework element adheres to predefined rules, structures, and/or conventions defined by the schema. This compliance may ensure seamlessly integration of the new framework element with existing components. At least one processor may analyze the schema to determine the structure, data types, and/or relationships, e.g., by parsing schema definitions, examining data models, and/or querying metadata repositories. Based on the analysis, At least one processor may construct a new framework element to align with the schema's requirements, e.g., by defining permissible data structures, implementing required interfaces, and/or adhering to specific naming conventions. For example, if the software platform's schema defines a specific format, mandatory properties and/or methods for framework elements, at least one processor may ensure that the new framework element follows the specific format, mandatory properties and/or methods. By adhering to the schema, the at least one processor may ensure that the new framework element interacts correctly with other components, utilizes platform services, and/or maintains data integrity. Ensuring schema compliance may promote consistency across an application, reduce the risk of integration errors, and facilitate easier maintenance and updates, and may permit leveraging of existing platform tools and services that rely on the schema structure, such as validation mechanisms, data mapping utilities, or code generation tools.

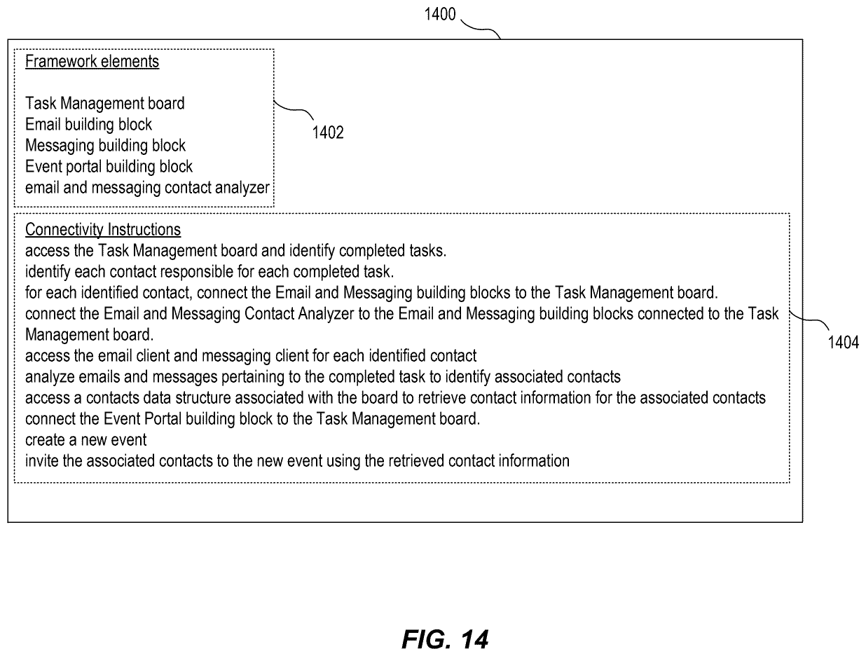

By way of a non-limiting example, reference is made to FIG. 14 illustrating an exemplary manifest 1400 for interconnecting the selected framework elements with the new framework element to construct a software application. At least one processor (e.g., processing 102 of FIG. 1) may construct manifest 1400 specifying email-and-messaging-contact-analyzer 1306 (e.g., the new framework element) and board 300, email building block 314, and messaging building block 316, and event portal 1212 (e.g., the selected framework elements) for including in the software application (e.g., framework elements 1402). At least one processor may determine connectivity instructions 1404 for interconnecting email-and-messaging-contact-analyzer 1306 with the board 300, email building block 314, and messaging building block 316, and event portal 1212 in compliance with a schema of software platform 302. In some embodiments, at least one processor may cause email-and-messaging-contact-analyzer 1306 to comply with the schema for software platform 302.

In some disclosed embodiments, the connectivity instructions define a functional workflow between the new framework element and the selected framework elements. A functional workflow refers to a sequence of operations, tasks, or processes that define how different components or elements work together to achieve a specific goal or functionality. For example, a functional workflow may describe the step-by-step progression of data or control flow through various software components to complete a particular operation. The connectivity instructions define a functional workflow by specifying how data and control should flow between the new framework element and the selected framework elements. A functional workflow may outline a sequence of operations, data transformations, and/or interactions that may occur when an application performs its intended functions. By defining a functional workflow, at least one processor may ensure that different framework element interact in a predictable and consistent manner. Connecting the selected framework elements and the new framework element according to a sequence contrary to the functional workflow may produce a sub-optimal software application resulting in errors, and/or an inefficient use of resources.

In some embodiments, the connectivity instructions define logical connections between the selected framework elements and the new framework element, wherein the logical connections comply with the schema of the software platform. Logical connections refers to conceptual (e.g., virtual) and/or functional relationships between differing components or elements within a software system. Logical connections may define input and output interfaces (e.g., how information flows), data transformation rules, how components interact, and/or dependency relationships between differing software and/or hardware components without necessarily specifying physical implementation details. Defining refers to specifying, declaring, establishing, and/or outlining. Defining may include specifying parameters, setting rules, and/or outlining structures governing how different parts of a software application may interact and/or operate. Defining logical connections that comply with the platform's schema refers to developing and/or stipulating logical connections that conform with the schema of the software platform, as described elsewhere herein. Consequently, logical connections between a new framework element and the selected framework elements may be consistent with the schema for the software platform. For example, if the software platform's schema specifies a particular communication protocol for inter-component messaging, the connectivity instructions may define logical connections that adhere to this protocol, e.g., by specifying message formats, defining event listeners, and/or establishing publish-subscribe relationships that align with the platform's communication standards. To define schema-compliant logical connections, at least one processor may analyze the schema to identify allowable connection types, data formats, and/or interaction patterns, and generate connectivity instructions establishing relationships between the new framework element and selected existing elements based on the analysis. For instance, if a new framework element provides a data processing capability, at least one processor may generate connectivity instructions defining how the new framework element receives input from existing data source elements and/or how the new framework element outputs processed data to visualization elements, in compliance with the platform schema. Ensuring that logical connections comply with the platform's schema may promote consistency, maintainability, and/or scalability of software applications, permit utilization of existing platform functionalities (e.g., logging, security, or transaction management), in a standardized manner, and/or facilitate debugging, testing, and/or future modifications.

By way of a non-limiting example, in FIG. 14, at least one processor (e.g., processor 102 in FIG. 1) may generate connectivity instructions 1404 to define a functional workflow between email-and-messaging-contact-analyzer 1306 and board 300, email building block 314, and messaging building block 316, and event portal 1212. In some embodiments, connectivity instructions 1404 may define logical connections between board 300, email building block 314, and messaging building block 316, and event portal 1212 and the email-and-messaging-contact-analyzer 1306, wherein the logical connections comply with the schema of software platform 302. In some embodiments, connectivity instructions 1404 may define data flows between board 300, email building block 314, and messaging building block 316, and event portal 1212 and the email-and-messaging-contact-analyzer 1306, where the data flows comply with the schema of software platform 302.

In some embodiments, the connectivity instructions define data flows between the selected framework elements and the new framework element, wherein the data flows comply with the schema of the software platform. Data flow refers to the movement of data. A data flow between the selected framework elements and the new framework element may refer to the movement, transfer, and/or exchange of information between framework elements included in the software application. Data flows may specify input and output data structures, and may describe how data is passed between differing system components, how and which data may be transformed or processed as data moves through various parts of an application, and how an overall data processing pipeline may be structured. A data flow in compliance with the schema of the software platform refers to a data flow that is consistent and/or coherent with one or more rules and/or standards included in the schema. At least one processor may analyze the platform schema to identify allowable data types, formats, and/or processing patterns to generate connectivity instructions that establish permitted data flows between the new framework element and the selected framework elements. For instance, if a schema specifies certain data formats or encoding standards, at least one processor may ensure that the connectivity instructions define data flows that adhere to these specifications. This may involve defining how data is serialized when passed between components, specifying data validation rules, and/or establishing data transformation pipelines that maintain compliance with the platform's data standards. By way of example, if a new framework element provides a machine learning capability, at least one processor may generate connectivity instructions defining how a machine learning model receives training data from existing data storage elements, how the model processes this data, and/or how the model outputs predictions and/or parameters in compliance with the platform schema. Schema-compliant data flows may promote data integrity, consistency, and/or interoperability with other system components, and may facilitate data management, monitoring, and/or auditing. Defining schema-compliant data flows may allow use of built-in data validation, caching, and/or encryption that expect data to be structured or handled in specific ways, which may lead to improved performance, security, and reliability.

By way of a non-limiting example, in FIG. 14, at least one processor (e.g., processor 102 in FIG. 1) may generate connectivity instructions 1404 to define a functional workflow between email-and-messaging-contact-analyzer 1306 and board 300, email building block 314, and messaging building block 316, and event portal 1212. In some embodiments, connectivity instructions 1404 may define logical connections between board 300, email building block 314, and messaging building block 316, and event portal 1212 and the email-and-messaging-contact-analyzer 1306, wherein the logical connections comply with the schema of software platform 302. In some embodiments, connectivity instructions 1404 may define data flows between board 300, email building block 314, and messaging building block 316, and event portal 1212 and the email-and-messaging-contact-analyzer 1306, where the data flows comply with the schema of software platform 302.

In some embodiments, the schema of the software platform defines interface contracts for framework elements, including permitted input/output data types, required fields, and serialization/encoding rules. When determining connectivity instructions, at least one processor may validate that an output of a first framework element satisfies an input contract of a second framework element and, where permitted by the schema, may generate one or more transformation directives to reconcile differences. For example, a first framework element may output a message object (e.g., including a message identifier, sender address, recipient address list, timestamp, and body text), while a second framework element expects a normalized contact record (e.g., including a contact identifier and canonical email address). In such embodiments, the connectivity instructions may specify extraction and normalization operations (e.g., parsing sender/recipient fields into contact records), type conversions, required-field checks, and/or validation rules (e.g., email address format validation). If the schema prohibits a required transformation (e.g., converting or exporting certain fields), the processor may prevent interconnection and/or may require an intermediate adapter element that produces a schema-compliant output.

In some embodiments, the schema includes policy and sequencing constraints that govern permissioning and event ordering for interactions among framework elements. For example, the schema may specify that accessing emails and/or messages requires a credential or access token with particular permission scopes, and that certain content fields (e.g., message bodies) may be processed only under specified authorization and/or consent conditions. Accordingly, the connectivity instructions may include directives to request, validate, and/or refresh credentials, enforce least-privilege scopes, and/or apply data minimization (e.g., redaction or field-level filtering) prior to invoking a downstream framework element. In addition, the schema may impose ordering constraints (e.g., authentication and permission validation must occur before data retrieval or write-back, and event listeners must be registered before dependent processing executes). In such embodiments, the connectivity instructions may incorporate a sequence satisfying dependencies and may include gating checks that prevent downstream execution until prerequisite events and authorization checks are completed.

In some embodiments, particularly where the software application aggregates data from a plurality of sources (e.g., a dashboard summarizing hundreds of boards), the connectivity instructions may define a data aggregation layer. Such a layer may be configured to perform pre-computation of metrics, batch data requests to minimize network overhead, and/or implement incremental refresh strategies (e.g., updating only changed data rather than reloading entire datasets). The connectivity instructions may further specify caching policies for this aggregation layer, ensuring that the generated software application remains responsive even when processing large volumes of distributed data, in compliance with platform performance schemas.

Some disclosed embodiments involve including the connectivity instructions in the manifest. Including refers to incorporating, inserting, and/or adding. At least one processor may incorporate, merge, and/or insert the connectivity instructions into the document of the manifest specifying the new framework element and the selected framework element such that information necessary for producing the software application may be formally documented and available for constructing the software application. Including the connectivity instructions in the manifest may organize the information necessary for constructing the application in a single, comprehensive document to simplify the process of assembling the application, and may provide a reference for required components and their interactions to ensure consistency between the planned architecture of the software application and its implementation. Explicitly documenting the connectivity instructions in the manifest may reduce a risk of discrepancies and/or errors when constructing the software application. At least one processor may format the connectivity instructions in a manner compatible with a structure and/or syntax of the manifest, such as by translating instructions into a specific data format and/or markup language. The at least one processor may determine an appropriate location within the manifest to insert the connectivity instructions, e.g., based on a logical organization of the manifest and/or dependencies between different components, and append or merge the connectivity instructions at the appropriate location, e.g., by updating existing entries and/or creating new sections within the manifest. The at least one processor may perform validation checks to ensure that the inclusion of the connectivity instructions does not introduce conflicts or inconsistencies with other parts of the manifest.

Some disclosed embodiments involve using the manifest to interconnect the selected framework elements with the new framework element to thereby construct the software application capable of providing the desired functionality. Using the manifest refers to employing, leveraging, and/or applying information in the manifest. Using the manifest may include reading content, interpreting instructions, and/or executing commands specified in the manifest. Using the manifest to interconnect the selected framework elements with the new framework element may include, for example, accessing information in the manifest for use in connecting framework elements, and/or parsing the manifest to extract information about the selected framework elements, the new framework element, and the connectivity instructions, and/or executing the connectivity instructions to establish connections between the selected framework elements and the new framework element necessary to achieve the desired functionality. At least one processor may user the manifest to set up data flows, define interfaces, configure dependencies between the selected framework elements and the new framework element, link libraries, set up API calls, configure event listeners, and/or establish database and/or network connections. The at least one processor may compile code, generate configuration files, and/or assemble resources into a deployable package. By following the instructions in the manifest, at least one processor may ensures that each framework element is correctly positioned within the overall structure of the software application and can communicate effectively with other framework elements and/or resources. To construct a software application capable of providing the desired functionality refers to building and/or assembling a software application able to perform, execute, and/or deliver the features, operations, and/or capabilities that were requested or specified. Use of a manifest to construct a software application may ensure that the application is constructed in a consistent, repeatable, and/or traceable manner that is aligned with the requirements specified in the request. Constructing the application based on the manifest may permit the application to perform the tasks, operations, and features that were initially requested.

By way of a non-limiting example, in FIG. 14, at least one processor (e.g., processor 102 in FIG. 1) may include connectivity instructions 1404 in manifest 1400. At least one processor may use manifest 1400 to interconnect board 300, email building block 314, and messaging building block 316, and event portal 1212 with email-and-messaging-contact-analyzer 1306 to thereby construct a software application capable of providing the desired functionality.

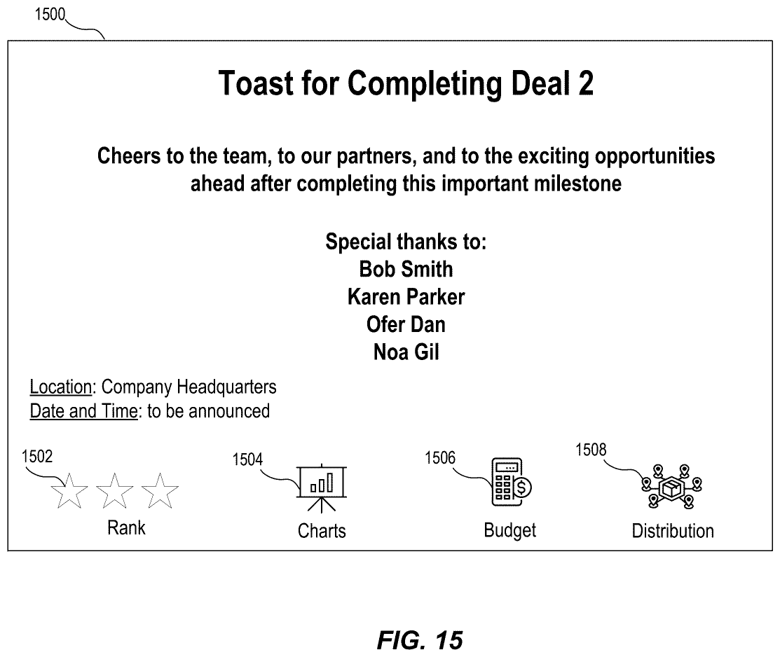

By way of a non-limiting example, reference is made to FIG. 15 illustrating an exemplary software application 1500 generated automatically on software platform 302, consistent with some disclosed embodiments. Software application 1500 may provide interactive access to an event associated with board 300. Software application 1500 may be generated wholly by at least one processor based on request 1204 using available capabilities on software platform 302 and email-and-messaging-contact-analyzer 1306, without the addition of human-generated code. At least one processor may automatically generate software application 1500 using manifest 1400. For instance, software application 1500 may include an event celebrating the completion of Deal 3 indicated as “Done” in status column 310 of board 300. Software application 1500 may indicate the contact (“Bob Smith”) associated with the complete event from contact column 306 in board 300, and additional associated contacts identified by linking email building block 314 and messaging building block 316 and analyzing associated emails and messages in accordance with connectivity instructions 1404. At least one processor may link data associated with board 300 to software application 1500, permitting access to a rank 1502, charts 1504, a budget 1506, and distribution 1508 associated with Deal 3.

In some embodiments, using the manifest to interconnect the selected framework elements with the new framework element to construct the software application on the software platform causes the software platform to host the software application on one of the plurality of available framework elements. To host refers to providing the resources, an environment, and/or infrastructure to run, maintain, and/or support a software application or service. Hosting may involve setting up a runtime environment for a software application, such as by allocating computational resources, managing data storage, providing network connectivity, configuring virtual machines, containers, and/or serverless functions, establishing security policies, and/or initializing platform services. To cause a software platform to host a software application may refer to prompting interconnection of the framework elements included in the manifest to construct a software application, and prompting an automatic deployment and execution of the constructed application within the environment of the software platform. At least one processor may interpret and/or execute instructions included in the manifest to produce a fully functional, platform-integrated application that may be executed within the software platform's environment. At least one processor may analyze the constructed application to determine resource requirements, such as computational power, memory allocation, and/or storage needs. In some embodiments, at least one processor may select an extension point and/or building block for hosting a software application constructed based on a manifest, for example by selecting an extension point capable of supporting the desired functionality of the software application. For example, if a software application constructed from a manifest requires specific database capabilities, at least one processor may choose to host the software platform on a framework element that provides database management services. Alternatively, if an application has high computational demands, at least one processor may choose to host the software platform on a framework element optimized for processing-intensive tasks. Automating the hosting process may eliminates the need for manual deployment, reducing the potential for configuration errors and ensuring consistency across different deployments, and may permit leveraging of the platform's built-in scalability, reliability, and/or management features, such as automatic load balancing, fault tolerance mechanisms, and/or monitoring tools. Automated hosting may facilitate updates and maintenance of a software application, permitting seamless deployment of future modifications and/or enhancements using a manifest-driven process.

By way of a non-limiting example, in FIGS. 3, 14 and 15, at least one processor (e.g., processor 102 in FIG. 1) may use manifest 1400 to interconnect board 300, email building block 314, and messaging building block 316, and event portal 1212 with email-and-messaging-contact-analyzer 1306 to construct software application 1500 on software platform 302. At least one processor may cause the software platform 302 to host software application 1500, e.g., by linking software application 1500 to board 300.

In some disclosed embodiments, causing a software platform to host a software application may include determining a specific user interface context or location for the application within the platform's visual hierarchy. For example, the software application may be hosted as a ‘custom object’ within a workspace navigation pane (e.g., a left-sidebar item), as a tab or view within a specific item or task detail page, or as a global tool accessible via a top navigation bar. Additionally or alternatively, the software application may be hosted as a homepage replacement (e.g., a dashboard), an administrative-only view restricted to specific user roles, or a persistent overlay accessible across multiple products or views within the platform. The platform may dynamically select the hosting location based on the nature of the desired functionality (e.g., placing a high-frequency tool in the top bar versus a project-specific tool in an item view).

In some embodiments, at least one processor may generate a deployable package for a software application to permit execution outside a standard platform interface. This may include publishing the software application to a dedicated Uniform Resource Locator (URL) (e.g., a public or partner-facing site) or generating an embeddable widget for inclusion in external third-party websites. To secure these external deployments, at least one processor may configure access controls such as tenant scoping, token-based authentication, or public-access permissions managed via the manifest, thereby allowing external users to interact with platform data without requiring direct access to the internal platform environment

Some embodiments involve determining a sequence for interconnecting the new framework element with the selected framework elements to satisfy the desired functionality and comply with the schema of the software platform. A sequence refers to an ordered arrangement, e.g., of things, events, or steps that follow one another in a particular order. A sequence for interconnecting framework elements may refer to a specific order according to which the framework elements may be linked together. The sequence in which framework elements are connected to construct a software application may influence a workflow and/or functionality of the software application. For example, dependencies among framework elements, data capture and/or display requirements, integration and/or synchronization with other components, logical grouping of related processes for efficiency, automation triggers, reporting needs, and/or elimination of redundancies may cause differing connection sequences to yield software applications having differing workflows and/or functionalities. Determining a sequence for interconnecting the new framework element with the selected framework elements to satisfy the desired functionality and comply with the schema of the software platform may refer to identifying, selecting, and/or establishing an order for connecting the new framework element with the selected framework elements such that a software application constructed as a result of the connecting provides the desired functionality in a manner consistent with the schema for the software platform. To determine the sequence, at least one processor may analyze the platform schema to assess constraints and/or requirements regarding an initialization and/or connection order for the framework elements. At least one processor may establish a logical order for assembling the framework elements based on the workflow that the software application is intended to accomplish, which framework elements are inputs and which are outputs, and/or which processes occur automatically versus manually, and validate these against the schema. The at least one processor may determine one or more dependencies between differing framework elements, define data flows and directionality, determine if integrations are needed with external components and/or systems, determine logical groupings for improved efficiency. Once a sequence is identified, at least one processor may test the sequence to eliminate conflicts and/or confirm that interactions between the connected framework elements are valid and consistent with the schema for the software platform. For example, if the new framework element depends on data processed by one of the selected elements, at least one processor may determine a sequence ensuring that the data-processing element is initialized and connected before the new element. Similarly, if multiple elements need to access shared resources, at least one processor may determine a sequence ensuring that the initialization of resource management components are prioritized to prevent conflicts or race conditions.

In some embodiments, the sequence is associated with at least one dependency between at least two of the selected framework elements and the new framework element. A dependency refers to a relationship between two or more components where one component relies on another component to achieve a desired outcome. For example, a framework element may require an output from another framework element to perform its tasks, a board must exist before items may be added and/or automations may be configured, a column must be defined before it can be referenced by an integration, and/or an item structure must be defined before a workflow logic may be applied to it. As another example, if a new framework element requires data processed by an existing framework element, a sequence may ensure that the data-processing framework element is initialized and connected before the new framework element. To determine a sequence, at least one processor may map dependencies between framework elements, e.g., by employing dependency graph analysis, and/or apply topological sorting techniques to determine a sequence that satisfies dependencies while minimizing potential conflicts or deadlocks. Determining a sequence based on dependencies between framework elements may prevent circular dependencies, ensure that resources are available when needed, and reduce wait times and/or redundant operations.

Some embodiments involve incorporating the sequence into the connectivity instructions. To incorporate refers to include, integrate, and/or combining one thing with another to form a unified whole. Incorporating may include merging two documents, and/or embedding content from one document into another document. Incorporating the determined sequence into the connectivity instructions may include transforming a logical sequence into executable instructions for constructing a software application and adding the executable instructions to connectivity instructions. Such transformation may include generating specific initialization calls, setting up event listeners in a particular order, and/or establishing data flow pipelines according to the determined sequence. At least one processor may incorporate the sequence into the connectivity instructions such that when the connectivity instructions are executed, the framework elements are connected according to the sequence. The determined sequence may be added to the manifest together with the connectivity instructions.

In some disclosed embodiments, interconnecting the new framework element with the selected framework elements according to a different sequence produces a sub-optimal software application. Sub-optimal refers to less than the best possible level, standard, or quality. For example, something that does not achieve the most desirable or ideal outcome. A sub-optimal software application may refer to an application that fails to perform, and/or performs below a threshold standard of acceptability. A sub-optimal software application may include errors, unnecessary redundancies, inefficient use of resources, and/or or limited functionality. For example, if a data storage framework element is connected after a data processing element, a software application may attempt to process data that has not yet been stored or properly initialized, leading to runtime errors, data loss, and/or error handling routines. As another example, if a user authentication framework element is initialized after a workflow automation, the workflow automation may execute tasks without appropriate access control, potentially exposing sensitive operations and/or data to unauthorized users.

In some embodiments, interconnecting the selected framework elements with the new framework element according to differing connectivity instructions produces a sub-optimal version of the software application. A version refers to a form, variant, or edition of something that, for example, differs in some way from other forms of the same thing. A sub-optimal version may refer to a form, variant, and/or release of something that may function but may not perform at its highest potential efficiency or effectiveness. Differing connectivity instructions refers to alternate, other, and/or substitute connectivity instructions. For example, differing connectivity instructions may specify alternative data flows, communication protocols, and/or integration patterns between framework elements. The process of interconnecting framework elements according to specific connectivity instructions may involve complex considerations of data flow, resource utilization, and/or component dependencies. Interconnecting framework elements according to altered and/or differently implemented connectivity instructions may lead to inefficiencies and/or limitations in the resulting software application. For example, different connectivity instructions may fail to properly sequence the initialization of interdependent components, which may result in race conditions or deadlocks, leading to reduced performance or reliability. Similarly, connectivity instructions that fail to optimize data flow between components may result in unnecessary data transfers or processing, impacting efficiency and responsiveness of the software application. Incorporating machine learning techniques when determining connectivity instructions for interconnecting building blocks to predict and/or mitigate potential inefficiencies in a resulting software application may distinguish an automated generation process for a software application from manual processes, and improve performance of the resulting software application.

By way of a non-limiting example, in FIGS. 3, 14, and 15, at least one processor (e.g., processor 102 in FIG. 1) may determine a sequence for interconnecting board 300, email building block 314, and messaging building block 316, and event portal 1212 with email-and-messaging-contact-analyzer 1306 to satisfy the desired functionality and comply with the schema of board 300 and software application 1500. For instance, the sequence may stipulate that email building block 314 and messaging building block 316 must be connected to board 300 before email-and-messaging-contact-analyzer 1306. In some embodiments, the sequence may be associated with a dependency between email building block 314 and messaging building block 316 and email-and-messaging-contact-analyzer 1306. For instance, email-and-messaging-contact-analyzer 1306 may require data from email building block 314 and messaging building block 316. In some embodiments, at least one processor may incorporate the sequence into connectivity instructions 1404. In some embodiments, interconnecting email-and-messaging-contact-analyzer 1306 with board 300, email building block 314, and messaging building block 316, and event portal 1212 according to a different sequence produces a sub-optimal software application. For instance, connecting email-and-messaging-contact-analyzer 1306 to board 300 before email building block 314, and messaging building block 316 are connected to board 300 may prevent email-and-messaging-contact-analyzer 1306 from accessing emails and messages. In some embodiments, interconnecting email-and-messaging-contact-analyzer 1306 with board 300, email building block 314, and messaging building block 316, and event portal 1212 according to according to differing connectivity instructions produces a sub-optimal version of the software application.

Some embodiments involve running the application within a secure environment of the software platform. A secure environment refers to a protected and/or controlled computational space designed to isolate and/or safeguard software execution from potential security threats or unauthorized access. For example, a secure environment may include sandboxes, virtual machines, and/or containerized systems that provide isolation, access control mechanisms, and/or security features. In this context, running refers to executing. Running an application within a secure environment of a software platform may refer to executing, simulating, and/or testing the software application within a protected space provided by the software platform to ensure safe operation. For example, the software platform may generate an isolated runtime environment, such as a container or virtual machine, dedicated to the software application. The isolated runtime environment may have restricted network connectivity, limited access to system resources, and controlled interactions with other components of the platform. The isolated runtime environment may permit process isolation, memory protection, and/or fine-grained permission management to prevent unauthorized access to sensitive data or system resources. By running the application in a secure environment, the software platform may provide a safe extension framework to mitigate potential security risks associated with newly generated and/or third-party components.

In some embodiments, the software platform is a SaaS platform, and operations involve running the software application on a server. A Software as a Service (SaaS) platform refers to a cloud computing model where software applications are hosted by a vendor and made available to customers over the Internet, as described elsewhere herein. A server refers to a computer or system that provides services, resources, or functionality to other computers, known as clients, over a network. For example, a server may host websites, process database queries, or manage email communications for multiple users or applications. Running a software application on a server may refer to execution and/or operation of the software application on a remote computer system that is part of the SaaS platform infrastructure, rather than on the end-user's local device. Running an application on a server may allow for centralized management, scalability, and/or accessibility of the application, while leveraging the resources and infrastructure provided by the SaaS platform. A SaaS platform may employ virtualization to create isolated instances of an application, ensuring resource allocation and security, load balancing to distribute incoming requests across multiple servers, and/or optimization of performance and reliability. For example, when a user accesses an application hosted on a SaaS platform, the user's request may be routed to a selected server within the SaaS platform. The selected server may execute the application code, process data, and return results to the user's device, e.g., via a web interface. This approach may allow for real-time updates and maintenance, consistent performance across different user devices, centralized data management, scalability, and improved data security and compliance, as sensitive information may be stored and processed within a controlled environment of the SaaS platform.

By way of a non-limiting example, in FIGS. 1 and 2, at least one processor 102 may run software application 1500 (FIG. 15) within a secure environment of software platform 302 (FIG. 3). For instance, at least one processor 102 may run software application 1500 inside a virtual machine configured on server 200. In some embodiments, software platform 302 may be a SaaS platform, and at least one processor 102 may run software application 1500 on server 200 (e.g., over network 204).

Some embodiments involve providing a Graphical User Interface (GUI) for visualizing the plurality of available framework elements and the new framework element. A Graphical User Interface (GUI) refers to an interactive system permitting a user to exchange information with an electronic device using visual elements rather than text-based interfaces or command-line syntax. A GUI may present visual elements (e.g., icons, buttons, menus, windows, and/or any other interactive visual element) that are intuitive and easily understood and/or interpreted by users, and may include event handlers to receive information from one or more input devices (e.g., a keyboard, mouse, stylus, touch sensitive screen, and/or any other type of input device). For example, event handlers may process signals associated with interactive manipulations, such as drag-and-drop, selection, resizing, context menu access, connecting elements, grouping and/or ungrouping elements, undo and/or redo actions, and/or tooltip and hover interactions (for displaying information when hovering on an item). In this context, visualizing refers to representing, depicting, displaying, and/or indicating. Providing a GUI for visualizing a plurality of framework elements may refer to enabling and/or presenting a GUI displaying graphic elements representing a plurality of framework elements. The GUI may permit selecting, moving, translating, rotating, zooming in/out, connecting, disconnecting, grouping and/or ungrouping of different framework elements in response to associated signals. In some embodiments, a GUI might display a hierarchical tree structure and/or a networked graph representing relationships and/or dependencies between different framework elements. Users may interact with a GUI visualizing the framework elements to explore dependencies, examine properties of individual elements, or understand the flow of data and control within an application. In some embodiment, the GUI may indicate a new framework element generated to meet capabilities unfulfilled by the available framework elements, e.g., by highlighting and/or otherwise visually distinguishing the new framework element from the available framework elements.

By way of a non-limiting example, in FIG. 12, at least one processor (e.g., processor 102 in FIG. 1) may provide a Graphical User Interface (GUI) for visualizing the plurality of available framework elements and the new framework element (e.g., see icons for templates 1210).

In some embodiments, the new framework element includes an AI capability configured to analyze schema of the selected framework elements and determine a data context and data hierarchy for inputs received from the selected framework elements based on the schema, thereby enabling context-aware processing of the inputs. An AI capability refers to the ability of an automated electronic system or component to perform tasks that typically require human intelligence, such as learning, problem-solving, decision making, and/or pattern recognition. For example, AI capabilities may include natural language processing, computer vision, and/or machine learning. An AI capability may include identifying a capability unfulfillable by a software platform, generating a new framework element to provide the capability, and integrating the new framework element with the software platform. A framework element including an AI capability may refer to a framework element capable of enlisting an AI agent and/or an AI engine to perform one or more processing tasks. For example, code associated with a framework element may include one or more calls (e.g., via APIs) to one or more AI agents and/or services to analyze data, interpret schemas, and/or automate context-aware processing. To analyze schema of the selected framework elements may refer to examining, investigating, organizing, and/or interpreting the schema of the selected framework elements to extract insights, identify patterns, and/or support decision-making. Analyzing the schema of the selected framework elements may additionally or alternatively involve determining and/or applying mathematical or statistical algorithms and/or correlations between data sets, identifying patterns and/or features (e.g., using artificial intelligence).

Inputs received from the selected framework elements based on the schema may refer to information obtained via the selected framework. This may include data received via a user interface presented and/or associated by one or more of the selected framework elements, data that underwent processing by one or more of the selected framework elements, and/or data sourced by one or more of the selected framework elements. A data context refers to surrounding and/or peripheral information and/or circumstances, and/or relationships with additional data that give meaning to a particular piece of data. A data hierarchy refers to an organization of data into levels of importance, relevance, abstraction, and/or relationships. For example, a data hierarchy may represent a structure of information in a database, indicating how different data elements relate to each other in terms of categories, subcategories, and/or dependencies.

Determining a data context and data hierarchy for inputs received from the selected framework elements based on the schema may refer to ascertaining and/or establishing a data context and hierarchy for the inputs using information included in and/or associated with the schema. Thus, an AI agent may determine a context and/or hierarchy for the inputs using information included in and/or otherwise associated with the schema. Such information may include a structure and/or content of the schema, schema metadata, information referenced by and/or linked to the schema, and/or any other information associated with the schema. For example, an AI component may employ machine learning algorithms to identify patterns and relationships within the schema of the selected framework elements. It may use natural language processing to interpret semantic meanings within data structures or field names included in the schema, and/or leverage graph analysis techniques to map out the interconnections and dependencies between the inputs and different data elements. Context-aware refers to the ability to detect, interpret, and adapt behavior based on relevant contextual information. Enabling context-aware processing of inputs may refer to permitting and/or providing service for interpreting and/or handling incoming data based on surrounding circumstances, relationships, and/or intended use within an application. This may include involves analyzing the schema and/or metadata of the input sources to assess not only the raw values, but also how the inputs relate to other data elements, their hierarchical position, and the purpose for which the inputs were received. For example, context-aware processing may determine whether an input is a user command, a system-generated event, or a piece of data intended for integration with other components, so that processing logic may be tailored accordingly.

For instance, when the new framework element receives inputs from one of the selected framework elements, its AI capability may analyze the schema to understand the structure and/or context of the input, such as by identifying primary keys, foreign key relationships, and/or hierarchical structures associated with the input. Based on this analysis, the AI capability may determine the context of the input, such as if the input was received from a user for further processing, if the input is intended for further processing before being outputted to the user, or if the input is associated with internal processing of the software application. By enabling context-aware processing of inputs, an AI-enhanced framework element may significantly improve the functionality and adaptability of the software application. It may allow for more intelligent data handling, potentially automating complex data integration tasks that would otherwise require manual configuration. Such an AI capability may lead to more efficient data processing, improved decision-making within the application, and the ability to handle diverse and evolving data structures more effectively.

By way of a non-limiting example, in FIG. 12, email-and-messaging-contact-analyzer 1306 may include an AI capability configured to analyze schema of board 300, email building block 314, and messaging building block 316, and event portal 1212 and determine a data context and data hierarchy for inputs received from the selected framework elements based on the schema, to enable context-aware processing of the inputs. For instance, the AI capability may use the schema of board 300, email building block 314, and messaging building block 316, and event portal 1212 to identify that Deal 3, indicated as “Done” indicates “Bob Smith” as the responsible contact for Deal 3. The identification of “Bob Smith” may permit email building block 314 and messaging building block 316 to access emails and messages sent from and received by “Bob Smith” to identify additional contacts for including in the event presented by software application 1500.

Traditional software development processes often struggle with creating customized applications efficiently that fully leverage existing platform capabilities while addressing custom, unfulfilled requirements. This challenge may be particularly acute in rapidly evolving technological landscapes where new functionalities are constantly needed, but time and resources for manual development may be limited. The disclosed embodiments may provide a technical solution to this problem by enabling at least one processor to implement an automated approach to application generation using mapping and analysis techniques to evaluate capabilities of available components against requested features and identify how existing framework elements may be utilized to fulfill desired functionalities. Upon identifying requirements that cannot be met by existing elements, at least one processor may dynamically generate one or more new framework elements. This generation process may extend beyond simple template-based approaches, and may include generation of tailored framework elements that seamlessly integrate with the existing platform architecture. At least one processor may analyze the platform schema to ensure that the newly generated framework elements comply with all structural and operational requirements, maintaining system integrity while extending functionality. The capability to automate determination of connectivity instructions and sequencing for interconnecting framework elements may represent a significant technical improvement over conventional (e.g., non-AI) approaches. By analyzing dependencies and potential interactions between components, at least one processor may construct a functional workflow that improves performance and efficiency of a software application over software applications developed using non-automated approaches (e.g., developed manually by humans). This improvement in performance may result from complex computational analysis to evaluate numerous potential configurations and select a more effective arrangement. Consequently, time and computational resources required for application development may be reduced.

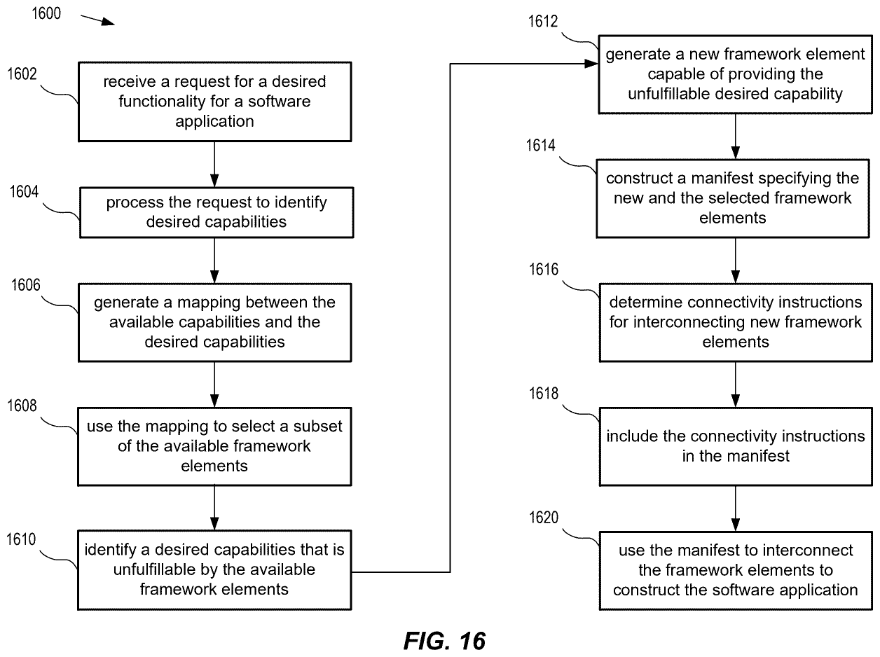

FIG. 16 is a flowchart of example process 1600 for automated generation of a software application on a software platform, consistent with embodiments of the present disclosure. In some embodiments, process 1600 may be performed by at least one processor (e.g., processor 102 in FIG. 1) to perform operations or functions described herein. In some embodiments, some aspects of process 1600 may be implemented as software (e.g., program codes or instructions) that are stored in a memory (e.g., memory 104) or a non-transitory computer readable medium. In some embodiments, some aspects of process 1600 may be implemented as hardware (e.g., a specific-purpose circuit). In some embodiments, process 1600 may be implemented as a combination of software and hardware.

Process 1600 may include a step 1602 of receiving a request for a desired functionality for implementation by software application on a software platform, wherein the software platform provides a plurality of available framework elements, each available framework element providing at least one available capability. For instance, this may involve capturing user input through various interfaces, such as natural language text or signals received via a Graphical User Interface (GUI). By way of a non-limiting example, in FIGS. 3, 12 and 15, at least one processor (e.g., processor 102 of FIG. 1) may receive a request 1204 for a desired functionality for implementation by software application 1500 on software platform 302. Software platform 302 may provide a plurality of available framework elements board 300, email building block 314, messaging building block 316, and Smart Update building block 318, and templates 1210 including event portal 1212, each providing at least one available capability.

Process 1600 may include a step 1604 of processing the request to identify a plurality of desired capabilities for fulfilling the desired functionality. For instance, this may involve analyzing the request using natural language processing techniques or interpreting user interactions with GUI elements to extract specific requirements and functionalities needed for the software application. By way of a non-limiting example, in FIG. 12, at least one processor (e.g., processor 102 in FIG. 1), may process request 1204 to identify a plurality of desired capabilities for fulfilling the desired functionality.

Process 1600 may include a step 1606 of generating a mapping between the available capabilities provided by the plurality of available framework elements to the desired capabilities identified for fulfilling the desired functionality. By way of a non-limiting example, at least one processor (e.g., processor 102 of FIG. 1) may generate mapping 1300 between available capabilities 1302 provided by the plurality of available framework elements to desired capabilities 1304 identified for fulfilling the desired functionality based on the processing of request 1204.

Process 1600 may include a step 1608 of using the mapping to select a subset of the available framework elements for including in the software application, wherein each selected framework element included in the subset provides at least one available capability for fulfilling a portion of the desired functionality. By way of a non-limiting example, in FIGS. 3 and 13, at least one processor (e.g., processor 102 of FIG. 1) may use mapping 1300 to select a subset including 3 of the available framework elements for including in the software application. Each of board 300, email building block 314, and messaging building block 316, and event portal 1212 may provide at least one available capability for fulfilling a portion of the desired functionality.

Process 1600 may include a step 1610 of identifying at least one of the desired capabilities that is unfulfillable by the available framework elements provided by the software platform. By way of a non-limiting example, in FIG. 3, and 13, at least one processor (e.g., processor 102 of FIG. 1) may identify at least one of the desired capabilities (e.g., “identifying contacts in related emails and messages”) that is unfulfillable by available framework elements board 300, email building block 314, messaging building block 316, and Smart Update building block 318, and templates 1210 provided by software platform 302.

Process 1600 may include a step 1612 of generating a new framework element capable of providing the at least one of the desired capabilities that is unfulfillable by the available framework elements. By way of a non-limiting example, in FIG. 13, at least one processor (e.g., processor 102 of FIG. 1) may generate email-and-messaging-contact-analyzer 1306 capable of providing the at least one of the desired capabilities (e.g., “identifying contacts in related emails and messages”) that is unfulfillable by available framework elements board 300, email building block 314, messaging building block 316, and Smart Update building block 318, and templates 1210 provided by software platform 302.

Process 1600 may include a step 1614 of constructing a manifest specifying the new framework element and the selected framework elements for inclusion in the software application. By way of a non-limiting example, in FIG. 14 at least one processor (e.g., processing 102 of FIG. 1) may construct manifest 1400 specifying email-and-messaging-contact-analyzer 1306 (e.g., the new framework element) and board 300, email building block 314, and messaging building block 316, and event portal 1212 (e.g., the selected framework elements) for including in the software application (e.g., framework elements 1402).

Process 1600 may include a step 1616 of determining connectivity instructions for interconnecting the new framework element with the selected framework elements in compliance with a schema of the software platform, wherein the connectivity instructions define a functional workflow between the new framework element and the selected framework elements. By way of a non-limiting example, in FIG. 14 at least one processor (e.g., processing 102 of FIG. 1) may determine connectivity instructions 1404 for interconnecting email-and-messaging-contact-analyzer 1306 with the board 300, email building block 314, and messaging building block 316, and event portal 1212 in compliance with a schema of software platform 302. At least one processor may generate connectivity instructions 1404 to define a functional workflow between email-and-messaging-contact-analyzer 1306 and board 300, email building block 314, and messaging building block 316, and event portal 1212.

Process 1600 may include a step 1618 of including the connectivity instructions in the manifest. For instance, this may consolidate all necessary information for application construction in a single document. By way of a non-limiting example, in FIG. 14, at least one processor (e.g., processor 102 in FIG. 1) may include connectivity instructions 1404 in manifest 1400.

Process 1600 may include a step 1620 of using the manifest to interconnect the selected framework elements with the new framework element to thereby construct the software application capable of providing the desired functionality. By way of a non-limiting example, in FIGS. 14 and 15, at least one processor (e.g., processor 102 in FIG. 1) may use manifest 1400 to interconnect board 300, email building block 314, and messaging building block 316, and event portal 1212 with email and email-and-messaging-contact-analyzer 1306 to thereby construct software application 1500 capable of providing the desired functionality.

Various example embodiments for gamified exertion session technologies are articulated below in the form of clauses. It is to be understood the term “technology” refers equally to systems (e.g., exercise machines, computing devices (e.g., processors, non-transitory computer readable media), resistance motors, and methods for operating these systems.
Clause 1. A non-transitory computer readable medium containing instructions that when executed by at least one processor cause the at least one processor to perform operations for designing a modular software platform with extendable functionality, the operations comprising: accessing a plurality of building blocks, each building block defining a specific set of capabilities for implementation by the software platform for modifying the functionality thereof, and wherein each building block is associated with a specific building block schema defining specific building block connectivity information; maintaining a first extension point of a plurality of differing extension points available in the software platform, the first extension point being configured to host at least a first subset of the plurality of building blocks, wherein the first extension point is associated with a first extension point schema defining first extension point connectivity information; enabling selection of the first extension point for hosting at least one of the plurality of building blocks; enabling selection of a first building block for hosting by the first extension point; and linking the first building block to the first extension point, wherein linking includes using first building block connectivity information and the first extension point connectivity information to generate connectivity instructions defining how the first building block is to be linked with the first extension point, deducing whether additional information is required for implementing the connectivity instructions, and implementing the connectivity instructions thereby modifying the functionality of the software platform.
Clause 2. The technology of clause 1, wherein the first extension point is anchored to a particular location in an architecture of the software platform.
Clause 3. The technology of each preceding clause alone or in combination, wherein the first extension point is anchored to a particular location on a graphical user interface associated with the software platform.
Clause 4. The technology of each preceding clause alone or in combination, wherein the first extension point is exposed to a user interface configured to enable connection of the first building block to the first extension point.
Clause 5. The technology of each preceding clause alone or in combination, wherein the user interface includes a no-code environment for enabling receiving of the selection of the building block.
Clause 6. The technology of each preceding clause alone or in combination, wherein the first extension point is unexposed to a user interface.
Clause 7. The computer readable medium of claim 1, wherein the connectivity instructions resolve the first building block connectivity information with the first extension point connectivity information.
Clause 8. The technology of each preceding clause alone or in combination, wherein resolving the first building block connectivity information with the first extension point connectivity information defines input-output types enabling communication between the first building block and the first extension point.
Clause 9. The technology of each preceding clause alone or in combination, wherein resolving the first building block connectivity information with the first extension point connectivity information defines an implementation of the capabilities of the first building block while hosted by the first extension point.
Clause 10. The technology of each preceding clause alone or in combination, wherein differing iterations of the first building block hosted by the first extension point are associated with differing implementations of the capabilities and differing versions of the building block schema of the first building block.
Clause 11. The technology of each preceding clause alone or in combination, further comprising, in response to determining a mismatch between the first extension point and the first building block, preventing the linking of the first building block with the first extension point.
Clause 12. The technology of each preceding clause alone or in combination, wherein the first extension point includes a plurality of connection sites for linking the first building block thereto, the operations further comprising enabling selection of a particular connection site from the plurality of connection sites for linking the first building block to the first extension point.
Clause 13. The technology of each preceding clause alone or in combination, wherein hosting of the first building block by the first extension point enables generating an additional product atop the software platform.
Clause 14. The technology of each preceding clause alone or in combination, wherein the connectivity instructions are based on the first extension point schema.
Clause 15. The technology of each preceding clause alone or in combination, wherein the first building block exposes a second extension point associated with a second extension point schema defining second extension point connectivity information and configured to host at least a second subset of the plurality of differing building blocks, the operations further comprising accessing the second extension point to enable alteration of the software platform via the second extension point.
Clause 16. The technology of each preceding clause alone or in combination, wherein the operations further comprise enabling selection of a second building block from the second subset of the plurality of differing building blocks for hosting by the second extension point on the first building block.
Clause 17. The technology of each preceding clause alone or in combination, wherein the second building block exposes a third extension point associated with a third extension point schema and is configured to host at least a third subset of the plurality of differing building blocks.
Clause 18. The technology of each preceding clause alone or in combination, wherein removal of the third building block is required prior to removal of the second building block.
Clause 19. The technology of each preceding clause alone or in combination, wherein the second building block inherits features from at least one other building block of the plurality of differing building blocks.
Clause 20. The technology of each preceding clause alone or in combination, further comprising verifying that second connectivity instructions defining how the second building block is to be linked with the second extension point are compatible with the first extension point schema and the building block schema associated with the first building block.
Clause 21. The technology of each preceding clause alone or in combination, further comprising an AI agent configured to facilitate automated generation of a software product, the AI agent being operative to: receive a requirement specification defining a functionality to be achieved by a SaaS platform; analyze the plurality of existing building blocks and their respective schemas to determine available capabilities within the software platform; generate a manifest specifying the required building blocks and corresponding connectivity instructions based on the received requirement and a SaaS platform schema, wherein the manifest defines the required interconnections among the selected building blocks; and automatically construct the software product by linking the selected building blocks in accordance with the generated manifest.
Clause 22. A system for designing a modular software platform with extendable functionality, the system comprising: at least one processor configured to: access a plurality of building blocks, each building block defining a specific set of capabilities for implementation by the software platform for modifying the functionality thereof, and wherein each building block is associated with a specific building block schema defining specific building block connectivity information; maintain a first extension point of a plurality of differing extension points available in the software platform, the first extension point being configured to host at least a first subset of the plurality of building blocks, wherein the first extension point is associated with a first extension point schema defining first extension point connectivity information; enable selection of the first extension point for hosting at least one of the plurality of building blocks; enable selection of a first building block for hosting by the first extension point; and link the first building block to the first extension point, wherein linking includes using first building block connectivity information and the first extension point connectivity information to generate connectivity instructions defining how the first building block is to be linked with the first extension point, deducing whether additional information is required for implementing the connectivity instructions, and implementing the connectivity instructions to thereby modify the functionality of the software platform.
Clause 23. A method for designing a modular software platform with extendable functionality, the method comprising: accessing a plurality of differing building blocks, each building block defining a specific set of capabilities for implementation by the software platform for modifying the functionality thereof, and wherein each building block is associated with a specific building block schema defining specific building block connectivity information; maintaining a first extension point of a plurality of differing extension points available in the software platform, the first extension point being configured to host at least a first subset of the plurality of building blocks, wherein the first extension point is associated with a first extension point schema defining first extension point connectivity information; selecting the first extension point for hosting at least one of the plurality of building blocks; selecting a first building block for hosting by the first extension point; and linking the first building block to the first extension point, wherein linking includes causing use of first building block connectivity information and the first extension point connectivity information to generate connectivity instructions defining how the first building block is to be hosted by the first extension point, causing deducement of whether additional information is required for implementing the connectivity instructions, and causing implementation of the connectivity instructions to thereby modify the functionality of the software platform.
Clause 24. A computer readable medium containing instructions that when executed by at least one processor cause the at least one processor to perform operations for altering a software functionality, the operations comprising: maintaining a software platform including a plurality of framework elements, each framework element being associated with a schema including rules defining how a functionality of the framework element is implemented, the schema having a modifiable schema portion and a non-modifiable schema portion; receiving a first signal indicative of a request to link a particular building block with a particular one of the plurality of framework elements for implementation by the software platform for modifying a functionality thereof, the particular building block having a specific set of capabilities; analyzing the modifiable schema portions and the non-modifiable schema portions of the particular building block and the particular framework element to determine compatibility requirements for linking the particular building block with the particular framework element; when rules of the non-modifiable schema portions of the particular building block and the particular framework element indicate inconsistency with the compatibility requirements, preventing linkage of the particular building block with the particular framework element; and when the rules of the non-modifiable schema portions of the particular building block and the particular framework element indicate consistency with the compatibility requirements, determining if modifications to the modifiable schema portions of the particular building block or the particular framework element are required, implementing the modifications to the modifiable schema portions when the modifications are required, and linking the particular building block to the particular framework element.
Clause 25. The technology of each preceding clause alone or in combination, wherein the compatibility requirements further include prevention of modifications to the non-modifiable schema portions associated with the particular framework element and wherein linking omits modifications to the non-modifiable schema portion associated with the particular framework element.
Clause 26. The technology of each preceding clause alone or in combination, wherein at least one of the modifiable schema portion or the non-modifiable schema portion associated with each available framework element includes defines which building blocks are permitted for hosting.
Clause 27. The technology of each preceding clause alone or in combination, wherein hosting the particular building block by the particular framework element defines a specific implementation for the particular framework element.
Clause 28. The technology of each preceding clause alone or in combination, wherein linking the particular building block to the particular framework element extends capabilities associated with the particular framework element.
Clause 29. The technology of each preceding clause alone or in combination, wherein extending the capabilities associated with the particular framework element includes overriding at least one attribute associated with the modifiable schema portion associated with the particular framework element.
Clause 31. The technology of each preceding clause alone or in combination, wherein extending the capabilities associated with the particular framework element includes customizing at least one attribute associated with the modifiable schema portion associated with the particular framework element.
Clause 31. The technology of each preceding clause alone or in combination, wherein extending the capabilities associated with the particular framework element includes redefining which building blocks are permitted for hosting.
Clause 32. The technology of each preceding clause alone or in combination, wherein linking the particular building block to the particular framework element reduces capabilities associated with the particular framework element.
Clause 33. The technology of each preceding clause alone or in combination, wherein the plurality of framework elements include at least one extension point and at least one additional building block exposing at least one additional extension point.
Clause 34. The technology of each preceding clause alone or in combination, wherein the at least one extension point includes a core extension point having a modifiable core extension point schema portion and a non-modifiable core extension point schema portion.
Clause 35. The technology of each preceding clause alone or in combination, wherein the particular building block is linked to the particular framework element within a hierarchy, and wherein the core extension point is at the highest level in the hierarchy.
Clause 36. The technology of each preceding clause alone or in combination, wherein the compatibility requirements include implementing an additional modification on the modifiable schema portion associated with at least one additional framework element of the plurality of framework elements, and wherein linking the particular building block to the particular framework element includes implementing the additional modification.
Clause 37. The technology of each preceding clause alone or in combination, wherein the additional framework element is at a higher level in the hierarchy than the particular framework element when the particular framework element is other than a core extension point.
Clause 38. The technology of each preceding clause alone or in combination, wherein the particular building block includes a core building block associated with a core building block schema including a modifiable core building block schema portion and a non-modifiable core building block schema portion, and wherein the core building block includes a core building block extension point, and wherein linking the particular building block to the particular framework element including linking the core building block to the core extension point to form a combined unit.
Clause 39. The technology of each preceding clause alone or in combination, wherein the combined unit has a combined schema conforming to the modifiable core extension point schema portion, the non-modifiable core extension point schema portion, the modifiable core building block schema portion, and the non-modifiable core building block schema portion.
Clause 40. The technology of each preceding clause alone or in combination, wherein linking the core building block with the core extension point includes generating connectivity instructions for the combined unit based on the combined schema.
Clause 41. The technology of each preceding clause alone or in combination, wherein at least one of the plurality of framework elements depends on at least another one of the plurality of framework elements.
Clause 42. The technology of each preceding clause alone or in combination, wherein implementing the modifications to the modifiable schema portions includes adding at least one rule to the modifiable schema portions.
Clause 43. The technology of each preceding clause alone or in combination, wherein implementing modifications to the modifiable schema portions includes adapting at least one rule of the modifiable schema portions in accordance with a functionality of the particular building block.
Clause 44. The technology of each preceding clause alone or in combination, wherein implementing modifications to the modifiable schema portions includes implementing a corresponding modification to modifiable schema portions of another framework element to ensure consistency there between.
Clause 45. The technology of each preceding clause alone or in combination, wherein the non-modifiable schema portions include core rules common to all of the framework elements.
Clause 46. The technology of each preceding clause alone or in combination, wherein implementing the modifications in the modifiable schema portions includes implementing additional modifications on additional framework elements dependent on the particular framework element.
Clause 47. A system for altering a software functionality, the system comprising: at least one processor configured to: maintain a software platform including a plurality of framework elements, each framework element being associated with a schema including rules defining how a functionality of the framework element is implemented, the schema having a modifiable schema portion and a non-modifiable schema portion; receive a first signal indicative of a request to link a particular building block with a particular one of the plurality of framework elements for implementation by the software platform for modifying a functionality thereof, the building block having a specific set of capabilities; analyze the modifiable schema portions and the non-modifiable schema portions of the particular building block and the particular framework element to determine compatibility requirements for linking the particular building block with the particular framework element; when rules of the non-modifiable schema portions of the particular building block and the particular framework element indicate inconsistency with the compatibility requirements, preventing linkage of the particular building block with the particular framework element; and when the rules of the non-modifiable schema portions of the particular building block and the particular framework element indicate consistency with the compatibility requirements, determine if modifications to the modifiable schema portions of the particular building block or the particular framework element are required, implement the modifications to the modifiable schema portions when the modifications are required; and link the particular building block to the particular framework element.
Clause 48. A method for altering a software functionality, the method comprising: maintaining a software platform including a plurality of framework elements, each framework element being associated with an schema including rules defining how a functionality of the framework element is implemented, the schema having a modifiable schema portion and a non-modifiable schema portion; receiving a first signal indicative of a request to link a particular building block with a particular one of the plurality of framework elements for implementation by the software platform for modifying the functionality thereof, the building block having a specific set of capabilities; analyzing the modifiable schema portions and the non-modifiable schema portions of the particular building block and the particular framework element to determine compatibility requirements for linking the particular building block with the particular framework element; when rules of the non-modifiable schema portions of the particular building block and the particular framework element indicate inconsistency with the compatibility requirements, preventing linkage of the particular building block with the particular framework element; and when the rules of the non-modifiable schema portions of the particular building block and the particular framework element indicate consistency with the compatibility requirements, determining if modifications to the modifiable schema portions of the particular building block or the particular framework element are required, implementing the modifications to the modifiable schema portions when the modifications are required, and linking the particular building block to the particular framework element.
Clause 49. A computer readable medium containing instructions that when executed by at least one processor cause the at least one processor to perform operations for automated generation of a software application on a software platform, the operations comprising: receiving a request for a desired functionality for implementation by software application on a software platform, wherein the software platform provides a plurality of available framework elements, each available framework element providing at least one available capability; processing the request to identify a plurality of desired capabilities for fulfilling the desired functionality; generating a mapping between the available capabilities provided by the plurality of available framework elements to the desired capabilities identified for fulfilling the desired functionality; using the mapping to select a subset of the available framework elements for including in the software application, wherein each selected framework element included in the subset provides at least one available capability for fulfilling a portion of the desired functionality; identifying at least one of the desired capabilities that is unfulfillable by the available framework elements provided by the software platform; generating a new framework element capable of providing the at least one of the desired capabilities that is unfulfillable by the available framework elements; constructing a manifest specifying the new framework element and the selected framework elements for including in the software application; determining connectivity instructions for interconnecting the new framework element with the selected framework elements in compliance with a schema of the software platform, wherein the connectivity instructions define a functional workflow between the new framework element and the selected framework elements; including the connectivity instructions in the manifest; and using the manifest to interconnect the selected framework elements with the new framework element to thereby construct the software application capable of providing the desired functionality.
Clause 50. The technology of each preceding clause alone or in combination, wherein the request includes natural language text.
Clause 51. The technology of each preceding clause alone or in combination, wherein the request includes signals received via a Graphical User Interface (GUI).
Clause 52. The technology of each preceding clause alone or in combination, wherein the plurality of available framework elements include building blocks.
Clause 53. The technology of each preceding clause alone or in combination, wherein the plurality of available framework elements include extension points.
Clause 54. The technology of each preceding clause alone or in combination, wherein generating the new framework element includes causing the new framework element to comply with the schema of the software platform.
Clause 55. The technology of each preceding clause alone or in combination, wherein generating the new framework element includes generating executable instructions for implementing the at least one of the desired capabilities that is unfulfillable by the available framework elements.
Clause 56. The technology of each preceding clause alone or in combination, wherein generating the executable instructions for implementing the at least one of the desired capabilities that is unfulfillable by the available framework elements includes performance of at least one of an inference operation or a learning operation.
Clause 57. The technology of each preceding clause alone or in combination, wherein the connectivity instructions define logical connections between the selected framework elements and the new framework element, wherein the logical connections comply with the schema of the software platform.
Clause 58. The technology of each preceding clause alone or in combination, wherein the connectivity instructions define data flows between the selected framework elements and the new framework element, wherein the data flows comply with the schema of the software platform.
Clause 59. The technology of each preceding clause alone or in combination, wherein using the manifest to interconnect the selected framework elements with the new framework element to construct the software application on the software platform causes the software platform to host the software application on one of the plurality of available framework elements.
Clause 60. The technology of each preceding clause alone or in combination, wherein the operations further comprise determining a sequence for interconnecting the new framework element with the selected framework elements to satisfy the desired functionality and comply with the schema of the software platform, and incorporating the sequence into the connectivity instructions, wherein interconnecting the new framework element with the selected framework elements according to a different sequence produces a sub-optimal software application.
Clause 61. The technology of each preceding clause alone or in combination, wherein the sequence is associated with at least one dependency between at least two of the selected framework elements and the new framework element.
Clause 62. The technology of each preceding clause alone or in combination, wherein the operations further comprise running the application within a secure environment of the software platform.
Clause 63. The technology of each preceding clause alone or in combination, wherein the software platform is a SaaS platform, and wherein the operations further comprise running the software application on a server.
Clause 64. The technology of each preceding clause alone or in combination, further comprising providing a Graphical User Interface (GUI) for visualizing the plurality of available framework elements and the new framework element.
Clause 65. The technology of each preceding clause alone or in combination, wherein interconnecting the selected framework elements with the new framework element according to differing connectivity instructions produces a sub-optimal version of the software application.
Clause 66. The technology of each preceding clause alone or in combination, wherein the new framework element includes an AI capability configured to analyze schema of the selected framework elements and determine a data context and data hierarchy for inputs received from the selected framework elements based on the schema, thereby enabling context-aware processing of the inputs.
Clause 67. A system for automated generation of a software application on a software platform, the system comprising at least one processor configured to: receive a request for a desired functionality for implementation by software application on a software platform, wherein the software platform provides a plurality of available framework elements, each available framework element providing at least one available capability; process the request to identify a plurality of desired capabilities for fulfilling the desired functionality; generate a mapping between the available capabilities provided by the plurality of available framework elements to the desired capabilities identified for fulfilling the desired functionality; use the mapping to select a subset of the available framework elements for including in the software application, wherein each selected framework element included in the subset provides at least one available capability for fulfilling a portion of the desired functionality; identify at least one of the desired capabilities that is unfulfillable by the available framework elements provided by the software platform; generate a new framework element capable of providing the at least one of the desired capabilities that is unfulfillable by the available framework elements; construct a manifest specifying the new framework element and the selected framework elements for including in the software application; determine connectivity instructions for interconnecting the new framework element with the selected framework elements in compliance with a schema of the software platform, wherein the connectivity instructions define a functional workflow between the new framework element and the selected framework elements; include the connectivity instructions in the manifest; and use the manifest to interconnect the selected framework elements with the new framework element to thereby construct the software application capable of providing the desired functionality.
Clause 68. A method for automated generation of a software application on a software platform, the method comprising: receiving a request for a desired functionality for implementation by software application on a software platform, wherein the software platform provides a plurality of available framework elements, each available framework element providing at least one available capability; processing the request to identify a plurality of desired capabilities for fulfilling the desired functionality; generating a mapping between the available capabilities provided by the plurality of available framework elements to the desired capabilities identified for fulfilling the desired functionality; using the mapping to select a subset of the available framework elements for including in the software application, wherein each selected framework element included in the subset provides at least one available capability for fulfilling a portion of the desired functionality; identifying at least one of the desired capabilities that is unfulfillable by the available framework elements provided by the software platform; generating a new framework element capable of providing the at least one of the desired capabilities that is unfulfillable by the available framework elements; constructing a manifest specifying the new framework element and the selected framework elements for including in the software application; determining connectivity instructions for interconnecting the new framework element with the selected framework elements in compliance with a schema of the software platform, wherein the connectivity instructions define a functional workflow between the new framework element and the selected framework elements; including the connectivity instructions in the manifest; and using the manifest to interconnect the selected framework elements with the new framework element to thereby construct the software application capable of providing the desired functionality.

Disclosed embodiments may include any one of the following bullet-pointed features alone or in combination with one or more other bullet-pointed features, whether implemented as and/or method, by at least one processor or circuitry, and/or stored as executable instructions on non-transitory computer readable media or computer readable media.
designing a modular software platform with extendable functionality;
accessing a plurality of building blocks, each building block defining a specific set of capabilities for implementation by a software platform for modifying a functionality thereof;
each building block is associated with a specific building block schema defining specific building block connectivity information;
maintaining a first extension point of a plurality of differing extension points available in a software platform;
the first extension point being configured to host at least a first subset of a plurality of building blocks;
the first extension point is associated with a first extension point schema defining first extension point connectivity information;
enabling selection of a first extension point for hosting at least one of a plurality of building blocks;
enabling selection of a first building block for hosting by a first extension point;
linking a first building block to a first extension point;
linking includes using first building block connectivity information and first extension point connectivity information to generate connectivity instructions defining how a first building block is to be linked with a first extension point;
deducing whether additional information is required for implementing connectivity instructions;
implementing connectivity instructions thereby modifying a functionality of a software platform;
a first extension point anchored to a particular location in an architecture of a software platform;
a first extension point anchored to a particular location on a graphical user interface associated with a software platform;
a first extension point exposed to a user interface configured to enable connection of a first building block to a first extension point;
a user interface includes a no-code environment for enabling receiving of a selection of a building block;
a first extension point is unexposed to a user interface;
connectivity instructions resolve first building block connectivity information with first extension point connectivity information;
resolving first building block connectivity information with first extension point connectivity information defines input-output types enabling communication between a first building block and a first extension point;
resolving first building block connectivity information with a first extension point connectivity information defines an implementation of capabilities of a first building block while hosted by a first extension point;
differing iterations of a first building block hosted by a first extension point are associated with differing implementations of capabilities and differing versions of a building block schema of the first building block;
in response to determining a mismatch between a first extension point and a first building block, preventing the linking of the first building block with the first extension point;
a first extension point includes a plurality of connection sites for linking a first building block thereto;
enabling selection of a particular connection site from a plurality of connection sites for linking a first building block to a first extension point;
hosting of a first building block by a first extension point enables generating an additional product atop a software platform;
connectivity instructions are based on a first extension point schema;
a first building block exposes a second extension point associated with a second extension point schema defining second extension point connectivity information and configured to host at least a second subset of a plurality of differing building blocks;
accessing a second extension point to enable alteration of a software platform via a second extension point;
enabling selection of a second building block from a second subset of a plurality of differing building blocks for hosting by a second extension point on a first building block;
a second building block exposes a third extension point associated with a third extension point schema and configured to host at least a third subset of a plurality of differing building blocks;
removal of a third building block is required prior to removal of a second building block;
a building block inherits features from at least one other building block of a plurality of differing building blocks;
verifying that second connectivity instructions, defining how a second building block is to be linked with a second extension point, are compatible with a first extension point schema and a building block schema associated with a first building block;
an AI agent configured to facilitate automated generation of a software product;
an AI agent being operative to receive a requirement specification defining a functionality to be achieved by a SaaS platform;
an AI agent being operative to analyze a plurality of existing building blocks and their respective schemas to determine available capabilities within a software platform;
an AI agent being operative to generate a manifest specifying required building blocks and corresponding connectivity instructions based on a received requirement and a SaaS platform schema;
a manifest defines required interconnections among selected building blocks;
an AI agent being operative to automatically construct a software product by linking selected building blocks in accordance with a generated manifest;
altering a software functionality;
maintaining a software platform including a plurality of framework elements;
each framework element being associated with a schema including rules defining how a functionality of the framework element is implemented;
the schema having a modifiable schema portion and a non-modifiable schema portion;
receiving a first signal indicative of a request to link a particular building block with a particular one of the plurality of framework elements for implementation by the software platform for modifying a functionality thereof;
the particular building block having a specific set of capabilities;
analyzing the modifiable schema portions and the non-modifiable schema portions of the particular building block and the particular framework element to determine compatibility requirements for linking the particular building block with the particular framework element;
when rules of non-modifiable schema portions of the particular building block and a particular framework element indicate inconsistency with compatibility requirements, preventing linkage of a particular building block with a particular framework element;
when rules of non-modifiable schema portions of a particular building block and a particular framework element indicate consistency with compatibility requirements, determining if modifications to modifiable schema portions of a particular building block or a particular framework element are required;
implementing modifications to modifiable schema portions when modifications are required;
linking a particular building block to a particular framework element;
compatibility requirements include prevention of modifications to a non-modifiable schema portions associated with a particular framework element;
linking omits modifications to a non-modifiable schema portion associated with a particular framework element;
at least one of a modifiable schema portion or a non-modifiable schema portion associated with each available framework element defines which building blocks are permitted for hosting;
hosting the particular building block by a particular framework element defines a specific implementation for a particular framework element;
linking a particular building block to a particular framework element extends capabilities associated with a particular framework element;
extending capabilities associated with a particular framework element includes overriding at least one attribute associated with modifiable schema portion associated with a particular framework element;
extending capabilities associated with a particular framework element includes customizing at least one attribute associated with a modifiable schema portion associated with a particular framework element;
extending capabilities associated with a particular framework element includes redefining which building blocks are permitted for hosting;
linking a particular building block to a particular framework element reduces capabilities associated with a particular framework element;
a plurality of framework elements include at least one extension point and at least one additional building block exposing at least one additional extension point;
at least one extension point includes a core extension point having a modifiable core extension point schema portion and a non-modifiable core extension point schema portion;
a particular building block is linked to a particular framework element within a hierarchy;
a core extension point is at a highest level in a hierarchy;
compatibility requirements include implementing an additional modification on a modifiable schema portion associated with at least one additional framework element of a plurality of framework elements;
linking a particular building block to a particular framework element includes implementing an additional modification;
an additional framework element is at a higher level in a hierarchy than a particular framework element when the particular framework element is other than a core extension point;
a particular building block includes a core building block associated with a core building block schema including a modifiable core building block schema portion and a non-modifiable core building block schema portion;
a core building block includes a core building block extension point;
linking a particular building block to a particular framework element includes linking a core building block to a core extension point to form a combined unit.
a combined unit has a combined schema conforming to a modifiable core extension point schema portion, a non-modifiable core extension point schema portion, a modifiable core building block schema portion, and a non-modifiable core building block schema portion;
linking a core building block with a core extension point includes generating connectivity instructions for a combined unit based on a combined schema;
at least one of a plurality of framework elements depends on at least another one of the plurality of framework elements;
implementing modifications to a modifiable schema portions includes adding at least one rule to a modifiable schema portions;
implementing modifications to a modifiable schema portions includes adapting at least one rule of a modifiable schema portions in accordance with a functionality of a particular building block;
implementing modifications to a modifiable schema portions includes implementing a corresponding modification to modifiable schema portions of another framework element to ensure consistency there between;
a non-modifiable schema portions include core rules common to all framework elements;
implementing modifications in a modifiable schema portions includes implementing additional modifications on additional framework elements dependent on a particular framework element;
automated generation of a software application on a software platform;
receiving a request for a desired functionality for implementation by software application on a software platform;
a software platform provides a plurality of available framework elements;
each available framework element providing at least one available capability;
processing a request to identify a plurality of desired capabilities for fulfilling a desired functionality;
generating a mapping between available capabilities provided by a plurality of available framework elements to a desired capabilities identified for fulfilling a desired functionality;
using a mapping to select a subset of available framework elements for including in a software application;
each selected framework element included in a subset provides at least one available capability for fulfilling a portion of a desired functionality;
identifying at least one desired capability that is unfulfillable by available framework elements provided by a software platform;
generating a new framework element capable of providing at least one of desired capabilities that is unfulfillable by an available framework elements;
constructing a manifest specifying a new framework element and a selected framework element for including in a software application;
determining connectivity instructions for interconnecting a new framework element with a selected framework elements in compliance with a schema of a software platform;
connectivity instructions define a functional workflow between a new framework element and a selected framework elements;
including connectivity instructions in a manifest;
using a manifest to interconnect the selected framework elements with a new framework element to thereby construct a software application capable of providing a desired functionality;
a request includes natural language text;
a request includes signals received via a Graphical User Interface (GUI);
a plurality of available framework elements include building blocks;
a plurality of available framework elements include extension points;
generating a new framework element includes causing a new framework element to comply with a schema of a software platform;
generating a new framework element includes generating executable instructions for implementing at least one of the desired capabilities that is unfulfillable by an available framework element;
generating executable instructions for implementing at least one desired capability that is unfulfillable by an available framework elements includes performance of at least one of an inference operation or a learning operation;
connectivity instructions define logical connections between selected framework elements and a new framework element;
logical connections comply with a schema of a software platform;
connectivity instructions define data flows between selected framework elements and a new framework element;
data flows comply with a schema of a software platform;
using a manifest to interconnect selected framework elements with a new framework element to construct a software application on a software platform causes the software platform to host the software application on one of a plurality of available framework elements;
determining a sequence for interconnecting new framework element with selected framework elements to satisfy a desired functionality and comply with a schema of a software platform;
incorporating a sequence into connectivity instructions;
interconnecting a new framework element with selected framework elements according to a different sequence produces a sub-optimal software application;
a sequence is associated with at least one dependency between at least two of selected framework elements and a new framework element;
running an application within a secure environment of a software platform;
a software platform is a SaaS platform;
running a software application on a server;
providing a Graphical User Interface (GUI) for visualizing a plurality of available framework elements and a new framework element;
interconnecting selected framework elements with a new framework element according to differing connectivity instructions produces a sub-optimal version of a software application
a new framework element includes an AI capability configured to analyze schema of selected framework elements and determine a data context and data hierarchy for inputs received from the selected framework elements based on a schema, thereby enabling context-aware processing of inputs.

1. A non-transitory computer readable medium containing instructions that when executed by at least one processor cause the at least one processor to perform operations for designing a modular software platform with extendable functionality, the operations comprising:
accessing a plurality of building blocks, each building block defining a specific set of capabilities for implementation by the software platform for modifying the functionality thereof, and wherein each building block is associated with a specific building block schema defining specific building block connectivity information;
maintaining a first extension point of a plurality of differing extension points available in the software platform, the first extension point being configured to host at least a first subset of the plurality of building blocks, wherein the first extension point is associated with a first extension point schema defining first extension point connectivity information;
enabling selection of the first extension point for hosting at least one of the plurality of building blocks;
enabling selection of a first building block for hosting by the first extension point; and
linking the first building block to the first extension point, wherein linking includes using first building block connectivity information and the first extension point connectivity information to generate connectivity instructions defining how the first building block is to be linked with the first extension point, deducing whether additional information is required for implementing the connectivity instructions, and implementing the connectivity instructions thereby modifying the functionality of the software platform.

2. The computer readable medium of claim 1, wherein the first extension point is anchored to a particular location in an architecture of the software platform.

3. The computer readable medium of claim 1, wherein the first extension point is anchored to a particular location on a graphical user interface associated with the software platform.

4. The computer readable medium of claim 1, wherein the first extension point is exposed to a user interface configured to enable connection of the first building block to the first extension point.

5. The computer readable medium of claim 4, wherein the user interface includes a no-code environment for enabling receiving of the selection of the building block.

6. The computer readable medium of claim 1, wherein the first extension point is unexposed to a user interface.

7. The computer readable medium of claim 1, wherein the connectivity instructions resolve the first building block connectivity information with the first extension point connectivity information.

8. The computer readable medium of claim 7, wherein resolving the first building block connectivity information with the first extension point connectivity information defines input-output types enabling communication between the first building block and the first extension point.

9. The computer readable medium of claim 8, wherein resolving the first building block connectivity information with the first extension point connectivity information defines an implementation of the capabilities of the first building block while hosted by the first extension point.

10. The computer readable medium of claim 1, wherein differing iterations of the first building block hosted by the first extension point are associated with differing implementations of the capabilities and differing versions of the building block schema of the first building block.

11. The computer readable medium of claim 1, further comprising, in response to determining a mismatch between the first extension point and the first building block, preventing the linking of the first building block with the first extension point.

12. The computer readable medium of claim 1, wherein the first extension point includes a plurality of connection sites for linking the first building block thereto, the operations further comprising enabling selection of a particular connection site from the plurality of connection sites for linking the first building block to the first extension point.

13. The computer readable medium of claim 1, wherein hosting of the first building block by the first extension point enables generating an additional product atop the software platform.

14. The computer readable medium of claim 1, wherein the connectivity instructions are based on the first extension point schema.

15. The computer readable medium of claim 1, wherein the first building block exposes a second extension point associated with a second extension point schema defining second extension point connectivity information and configured to host at least a second subset of the plurality of differing building blocks, the operations further comprising accessing the second extension point to enable alteration of the software platform via the second extension point.

16. The computer readable medium of claim 15, wherein the operations further comprise enabling selection of a second building block from the second subset of the plurality of differing building blocks for hosting by the second extension point on the first building block.

17. The computer readable medium of claim 16, wherein the second building block exposes a third extension point associated with a third extension point schema and is configured to host at least a third subset of the plurality of differing building blocks.

18. The computer readable medium of claim 17, wherein removal of the third building block is required prior to removal of the second building block.

19. The computer readable medium of claim 17, wherein the second building block inherits features from at least one other building block of the plurality of differing building blocks.

20. The computer readable medium of claim 16, further comprising verifying that second connectivity instructions defining how the second building block is to be linked with the second extension point are compatible with the first extension point schema and the building block schema associated with the first building block.

21. The computer readable medium of claim 1, further comprising an AI agent configured to facilitate automated generation of a software product, the AI agent being operative to:
receive a requirement specification defining a functionality to be achieved by a SaaS platform;
analyze the plurality of existing building blocks and their respective schemas to determine available capabilities within the software platform;
generate a manifest specifying the required building blocks and corresponding connectivity instructions based on the received requirement and a SaaS platform schema, wherein the manifest defines the required interconnections among the selected building blocks; and
automatically construct the software product by linking the selected building blocks in accordance with the generated manifest.

22. A system for designing a modular software platform with extendable functionality, the system comprising:
at least one processor configured to:
access a plurality of building blocks, each building block defining a specific set of capabilities for implementation by the software platform for modifying the functionality thereof, and wherein each building block is associated with a specific building block schema defining specific building block connectivity information;
maintain a first extension point of a plurality of differing extension points available in the software platform, the first extension point being configured to host at least a first subset of the plurality of building blocks, wherein the first extension point is associated with a first extension point schema defining first extension point connectivity information;
enable selection of the first extension point for hosting at least one of the plurality of building blocks;
enable selection of a first building block for hosting by the first extension point; and
link the first building block to the first extension point, wherein linking includes using first building block connectivity information and the first extension point connectivity information to generate connectivity instructions defining how the first building block is to be linked with the first extension point, deducing whether additional information is required for implementing the connectivity instructions, and implementing the connectivity instructions to thereby modify the functionality of the software platform.

23. A method for designing a modular software platform with extendable functionality, the method comprising:
accessing a plurality of differing building blocks, each building block defining a specific set of capabilities for implementation by the software platform for modifying the functionality thereof, and wherein each building block is associated with a specific building block schema defining specific building block connectivity information;
maintaining a first extension point of a plurality of differing extension points available in the software platform, the first extension point being configured to host at least a first subset of the plurality of building blocks, wherein the first extension point is associated with a first extension point schema defining first extension point connectivity information;
selecting the first extension point for hosting at least one of the plurality of building blocks;
selecting a first building block for hosting by the first extension point; and
linking the first building block to the first extension point, wherein linking includes causing use of first building block connectivity information and the first extension point connectivity information to generate connectivity instructions defining how the first building block is to be hosted by the first extension point, causing deducement of whether additional information is required for implementing the connectivity instructions, and causing implementation of the connectivity instructions to thereby modify the functionality of the software platform.

24-68. (canceled)
